(19) United States
(12) Patent Application Publication
(10) Pub. No.: US 2014/0203039 A1
(43) Pub. Date: Jul. 24, 2014

(54) SYSTEMS AND METHODS FOR DISPENSING ONE OR MORE LIQUIDS FROM A PORTABLE SELF-CONTAINED APPARATUS ("Industrial Flair")

(71) Applicant: Dispensing Technologies B.V., (unknown)

(72) Inventors: Wilhelmus Johannes Joseph Maas, Someren (NL); Petrus Lambertus Wilhelmus, Someren (NL); Aaron S. Haleva, Oakhurst, NJ (US)

(73) Assignee: Dispensing Technologies B.V.

(21) Appl. No.: 14/226,613

(22) Filed: Mar. 26, 2014

Related U.S. Application Data
(63) Continuation-in-part of application No. PCT/US2012/057401, filed on Sep. 26, 2012.
(60) Provisional application No. 61/626,453, filed on Sep. 26, 2011.
(60) Provisional application No. 61/899,753, filed on Nov. 4, 2013.

(51) Int. Cl. B05C 17/00; B29D 22/00

(52) U.S. Cl. CPC B05C 17/002; B29D 22/003
USPC 222/52; 29/428; 156/73.5; 264/512; 222/135

(57) ABSTRACT

Systems and methods to dispense various liquids, foams and sprays, of various viscosities, such as, for example, paints and stains, from a self-contained wearable apparatus are presented. These devices use an inner container/outer container technology. A device can be provided that is portable and self-contained, can be worn by a user, and can utilize pre-filled containers of the product to be dispensed, thus obviating use of a separate paint container. Novel performs for the manufacture and blowing of multi-layer bottles are also presented, including an outside layer, and two or more inside layers. The outer layer and the two or more inner containers may each be separately injection molded, or the outer container and one of the inner containers may be 2K molded, thus saving significant manufacturing time and cost.

### CROSS REFERENCE TO RELATED APPLICATIONS

This application is a continuation-in-part to the PCT application filed on Sep. 26, 2012, which published as WO 2013/049260 on Apr. 4, 2013, and which itself claims the benefit of U.S. Provisional Patent Application Ser. No. 61/626,453, filed on Sep. 26, 2011. This application also claims the benefit of U.S. Provisional Patent Application No. 61/899,753, filed Nov. 4, 2013 (the “Barrier Layers Provisional”). Each of these prior applications is hereby incorporated herein by this reference.

### TECHNICAL FIELD

The present invention relates to dispensing technologies, and in particular to systems and methods for the efficient and convenient dispensing of one or more liquids, or varying viscosities, that are applied over significant periods of time, such as paint, stain, lubricants, adhesives, mortars, and the like, from a portable self contained system.

### BACKGROUND OF THE INVENTION

Conventional systems for the dispensing of paints, lubricants, and similar liquids, construction preparations such as silicone or caulk, adhesives and glues, or even beverages, for example, such as beer and carbonated sodas, are often cumbersome. This is especially so when pressure is used to dispense the liquid in some form. For example, conventional paint and stain dispensers require a source of the liquid to be dispensed—often a paint can or a bucket filled with the paint, a tube to draw up the paint, and an air brush to spray it. A user must be tethered to the bucket, which is generally placed on the ground, or sometimes on a ladder shelf, at a location that is more or less nearby. When air is used to pressurize a paint sprayer, or other liquid dispensing system, a source of pressure, usually a fixed compressor, is also required. Similarly, conventional carbonated beverage dispensing systems require an external carbonator, CO2 regulators, syrup pumps, tubing, clamps, crimping tools and the like, as well as standard CO2 tanks and syrup. All of this requires a significant fixed installation space, and is somewhat cumbersome.

What is needed in the art is a portable, ergonomic and self contained system for dispensing of various liquids using pressure that solves the problems of the conventional approach.

### SUMMARY OF THE INVENTION

Systems and methods to dispense various liquids, foams and sprays, of various viscosities, such as, for example, paints, stains, lubricants adhesives and beverages, from a self-contained wearable apparatus are presented. Such exemplary devices can incorporate the “bag within a bag” or inner container/outer container Flair® technology developed and provided by Dispensing Technologies, B.V. of Helmond, The Netherlands. An exemplary dispensing device can be provided that is portable and self-contained, can be worn by a user, and can utilize pre-filled containers of the product to be dispensed, thus improving upon conventional systems that require a separate paint container to which a user is effectively tethered. Novel activation mechanisms can be used that allow the system to intelligently sense when a user desires to turn the device on or off. These mechanisms incorporate fail-safe sensors that lock out the on/off switch if a user's hand is not sensed as actually holding the paint brush. Various types of Flair® bottles can be used with such systems, including specialized Flair bottles to dispense more than one liquid at a time, and various nozzles, brushes, rollers and other dispensing devices can be used, thus allowing multiple liquids, sprays, foams, paints, stains, foodstuffs and beverages to be conveniently dispensed using such exemplary systems. Various novel performs for the manufacture and blowing of multi-layer Flair® bottles are also presented.

Novel performs for the manufacture and blowing of multi-layer bottles are also presented, including an outside layer, and two or more inside layers. The outer layer and the two or more inner containers may each be separately injection molded, or the outer container and one of the inner containers may be 2K molded, thus saving significant manufacturing time and cost.

### BRIEF DESCRIPTION OF THE DRAWINGS

It is noted that the patent or application file may contain at least one drawing executed in color. If that is the case, copies of this patent or patent application publication with color drawing(s) will be provided by the U.S. Patent and Trademark Office upon request and payment of the necessary fee.

FIG. 1 illustrates general aspects of an exemplary standard system for dispensing paint according to exemplary embodiments of the present invention;

FIG. 2 illustrates the system of FIG. 1 with the power pack turned on, and thus the Flair® container pressurized, according to exemplary embodiments of the present invention;

FIG. 3A depicts the system of FIG. 1 with the activation zone being touched by a user, thus opening a valve and dispensing the paint according to an exemplary embodiment of the present invention;

FIG. 3B depicts a variation of FIG. 3A where an electronically activated paint roller is used in place of a paint brush;

FIG. 4 depicts the exemplary system of FIG. 3A where paint flow has been stopped by a user having ceased to touch a brush activation zone;

FIG. 5A depicts an exemplary system as shown in FIG. 2 where an exemplary Piston-Flair® container is used according to an exemplary embodiment of the present invention;

FIG. 5B depicts an exemplary system where multiple exemplary Piston-Flair® containers are used according to an exemplary embodiment of the present invention;

FIG. 5C depicts an exemplary system as shown in FIG. 5B where multiple standard Flair® containers are used according to an exemplary embodiment of the present invention;

FIG. 6 depicts an exemplary system such as is shown in FIG. 3B where a Multi-Layer Flair® container is used according to an exemplary embodiment of the present invention;

FIG. 7 depicts details of an exemplary power pack module according to an exemplary embodiment of the present invention;

FIG. 7A depicts electronic details of an exemplary power pack module according to an exemplary embodiment of the present invention;

FIG. 8 depicts details of a power pack pressure switch and other internal structures according to an exemplary embodiment of the present invention;

FIG. 9 depicts various display sequences of an exemplary power pack LED indicator system and its respective exemplary meanings according to an exemplary embodiment of the present invention;

FIG. 10 depicts exemplary dimensions and form factor of the exemplary power pack of FIGS. 7-9;

FIG. 11 depicts details of an exemplary portable container holder assembly according to an exemplary embodiment of the present invention;

FIG. 11A exemplary pinch valve features according to exemplary embodiments of the present invention;

FIG. 12 depicts details of an exemplary container holder emergency and rest button system according to an exemplary embodiment of the present invention;

FIG. 13 depicts a first step in opening the exemplary container holder according to an exemplary embodiment of the present invention;

FIG. 14 depicts a second step in opening the exemplary container holder according to an exemplary embodiment of the present invention;

FIG. 15 depicts exemplary dimensional details of an exemplary container holder according to an exemplary embodiment of the present invention;

FIG. 16 depicts exemplary container closures according to exemplary embodiments of the present invention;

FIG. 17 depicts an exemplary tube used to conduct paint from a container to a paint brush according to exemplary embodiments of the present invention;

FIGS. 18-20 depict structural details and functionality of an electric brush holder according to exemplary embodiments of the present invention;

FIG. 21 depict electrical details of a capacitive handle according to exemplary embodiments of the present invention;

FIG. 22 depicts an exemplary capacitive handle wiring arrangement according to exemplary embodiments of the present invention;

FIG. 23 depicts exemplary brush head interfaces according to exemplary embodiments of the present invention;

FIGS. 24-29 depict various stages in assembly of an exemplary paint brush and tube according to exemplary embodiments of the present invention;

FIGS. 30-31 depict details of exemplary standard Flair® bottles and caps for use according to exemplary embodiments of the present invention;

FIG. 32 depicts exemplary packaging options according to various exemplary embodiments of the present invention.

FIG. 33 depicts generating a liquid-air mix with a standard Flair® system such as shown in FIG. 1 using air from a Flair® gap according to an exemplary embodiment of the present invention;

FIG. 34 depicts generating a liquid-air mix with a standard Flair® system using air from a separate line from the power pack according to an exemplary embodiment of the present invention;

FIG. 35 depicts generating a liquid-air mix with a Piston Flair® system using air from a separate line from the power pack according to an exemplary embodiment of the present invention;

FIG. 36 depicts generating a multi-liquid mix using a Multi-Layer Flair® system according to an exemplary embodiment of the present invention;

FIG. 37 depicts generating a multi-liquid/air mix with a Multi-Layer Flair® system using air from a Flair® gap according to a first exemplary embodiment of the present invention;

FIG. 38 depicts generating a multi-liquid/air mix with a Multi-Layer Flair® system using air from a separate line from the power pack according to an exemplary embodiment of the present invention;

FIG. 39 depicts various exemplary tube configurations according to exemplary embodiments of the present invention;

FIG. 40 depicts an exemplary beverage dispensing application according to exemplary embodiments of the present invention;

FIG. 41 depicts the exemplary beverage dispensing application of FIG. 39 as used in an exemplary tavern or bar according to exemplary embodiments of the present invention;

FIGS. 42-50 depict an exemplary harness system that can be used with various exemplary embodiments of the present invention to deliver paint, silicone or other liquids;

FIG. 51 depicts an exemplary preform for an exemplary Multi Layer Flair® bottle according to exemplary embodiments of the present invention;

FIG. 52 depicts cross sections of the exemplary Multi-Layer Flair® preform of FIG. 51 as assembled according to exemplary embodiments of the present invention;

FIG. 53 depicts the exemplary Multi-Layer Flair® preform of FIG. 51 as prepared for blow molding and after blowing according to exemplary embodiments of the present invention;

FIG. 54 depicts the exemplary Multi-Layer Flair® preform of FIG. 53 before and after pushing in the (interior) third layer according to exemplary embodiments of the present invention;

FIG. 55 depicts exemplary techniques for filling the exemplary Multi-Layer Flair® preform of FIG. 54 (after pushing in the third layer) according to exemplary embodiments of the present invention;

FIG. 55A depicts an alternate exemplary technique for filling the exemplary Multi-Layer Flair® preform of FIG. 54 according to exemplary embodiments of the present invention;

FIG. 56 depicts the exemplary Multi-Layer Flair® preform of FIG. 55 dispensing two liquids according to exemplary embodiments of the present invention;

FIG. 57 depicts an alternate preform for an exemplary Multi Layer Flair® bottle according to exemplary embodiments of the present invention;

FIG. 58 depicts cross sections of the exemplary Multi Layer Flair® perform of FIG. 57 as assembled according to exemplary embodiments of the present invention;

FIG. 59 depicts an alternate Multi-Layer Flair® perform where pairs of layers are 2K injection molded to save manufacturing time and cost;

FIG. 60 depicts cross sections of the exemplary Multi-Layer Flair® preform of FIG. 59 as assembled using only one welding step according to exemplary embodiments of the present invention;

FIG. 61 depicts cross sections of the exemplary Multi-Layer Flair® preform of FIG. 51 with exemplary integrated barrier layers in one or more of the multiple preform layers according to exemplary embodiments of the present invention;

FIG. 61A depicts examples of barrier layers for the exemplary Multi-Layer Flair® preform of FIG. 61;

FIG. 61B depicts examples of a 2C preform having a co-injected barrier layer, where barrier layers can be co-injected with the inside layer, outside layer, or all layers;

FIG. 61C illustrates examples of a 2C PP/PP, or 2C PE/PP, preform with and without co-injected barrier layers, and use of an anti-bonding agent;

FIG. 62 depicts a magnified cross section of the exemplary Multi-Layer Flair® preform of FIG. 61 with exemplary integrated barrier layers in all of the multiple preform layers according to exemplary embodiments of the present invention;

FIGS. 63-64 depict an exemplary preform assembled from three single injection molded components according to exemplary embodiments of the present invention, the inside layer having a hollow pin to receive the single protruding pin of the third layer for welding;

FIGS. 65-66 depict an exemplary preform assembled from a 2K injection molded component and one single injection component part according to exemplary embodiments of the present invention, the inside layer of the 2K preform having a cavity to receive a single protruding pin of the third layer for welding;

FIGS. 67-68 depict an alternate exemplary preform assembled from a 2K injection molded component and one single injection molded component according to exemplary embodiments of the present invention;

FIGS. 69-70 depict an exemplary preform assembled from four single injection molded components according to exemplary embodiments of the present invention, the welding of the layers done by spin welding on a double protruding pin;

FIG. 71 shows an exemplary four layer Multi-Layer Flair® bottle with four compartments (holding three liquids) according to exemplary embodiments of the present invention;

FIGS. 72-73 show an alternate exemplary four layer preform assembled from one 2K injection molded component and two single injection molded components according to exemplary embodiments of the present invention; where the welding of the layers is done by spin welding on a double protruding pin;

FIG. 74 depicts an alternate integrated bottle container and power pack, wearable on a user's back, according to exemplary embodiments of the present invention; and

FIG. 75 depicts exemplary personal izations and customizations of an exemplary brush handle according to exemplary embodiments of the present invention.

### DETAILED DESCRIPTION OF THE INVENTION

In exemplary embodiments of the present invention, systems and methods to efficiently dispense paint, stain, adhesives, caulks, silicone, etc., and the like, including foodstuffs, condiments, beverages and other comestibles, are presented. Unlike conventional systems, such as air-compressor driven spray painting devices, or complex carbonated beverage setups, condiment hand pumps, systems according to the present invention are self-contained, and also portable. In fact, they can be effectively worn by a user, or carried, as in the manner of a hand-held vacuum. They can also incorporate novel activation mechanisms that allow the system to intelligently sense when a user desires to turn on and to turn off the device and operate valving accordingly. Finally, they can incorporate fail-safe sensors that lock out the on/off switch if a user's hand is not sensed as actually holding the paint brush. Such exemplary devices incorporate various embodiments and types of the “bag within a bag” or inner container/outer container Flair® technology developed and provided by Dispensing Technologies, B.V. of Helmond, The Netherlands.

It is noted that Flair® technology generally involves bag in a bag, or bag in a bottle devices that are integrally molded from one or more performs. A displacing medium can be introduced between the outer container and an inner container so as to pressurize the inner container, thus facilitating the emptying the contents of the inner container without said contents ever coming in contact with the displacing medium or the outside atmosphere. Flair® technology also includes, for example, valves, nozzles, pumps and other parts and ancillary equipment used in connection with such bag in bag, bag in bottle, or inner container/outer container technologies. As noted, the present invention is directed to various uses of Flair® technology as applied to the dispensing of paint, stain and the like, such as can be used in the construction industry, or by individuals doing home and/or building repair and maintenance. Using essentially identical principles, the present invention is also directed to various uses of Flair® technology as applied to the dispensing of beverages and foodstuffs, as well as sprays, stains, paints, adhesives, caulks, lubricants, foams and the like, using one or multiple liquid components, and in the case of sprays and foams, an air component as well. A beneficial feature of systems and methods according to the present invention is both the portability and self-contained aspects, as noted above. These features can, for example, un-tether a user from a roller-pan, paint bucket, carbonated beverage and syrup sources, or the like, and allow such user to ambulate, climb, descend, etc. as he or she sees fit or efficient, all the while carrying the liquid source, source of air pressure or other displacing medium and a fully automated yet precisely controlled user activated and controlled delivery system with him or her.

Details of the various exemplary devices are next described in connection with the various figures. Although many of the illustrative figures use paint as an exemplary liquid being dispensed, it is understood that a wide variety of liquids and the like can just as well be dispensed using such exemplary systems and techniques.

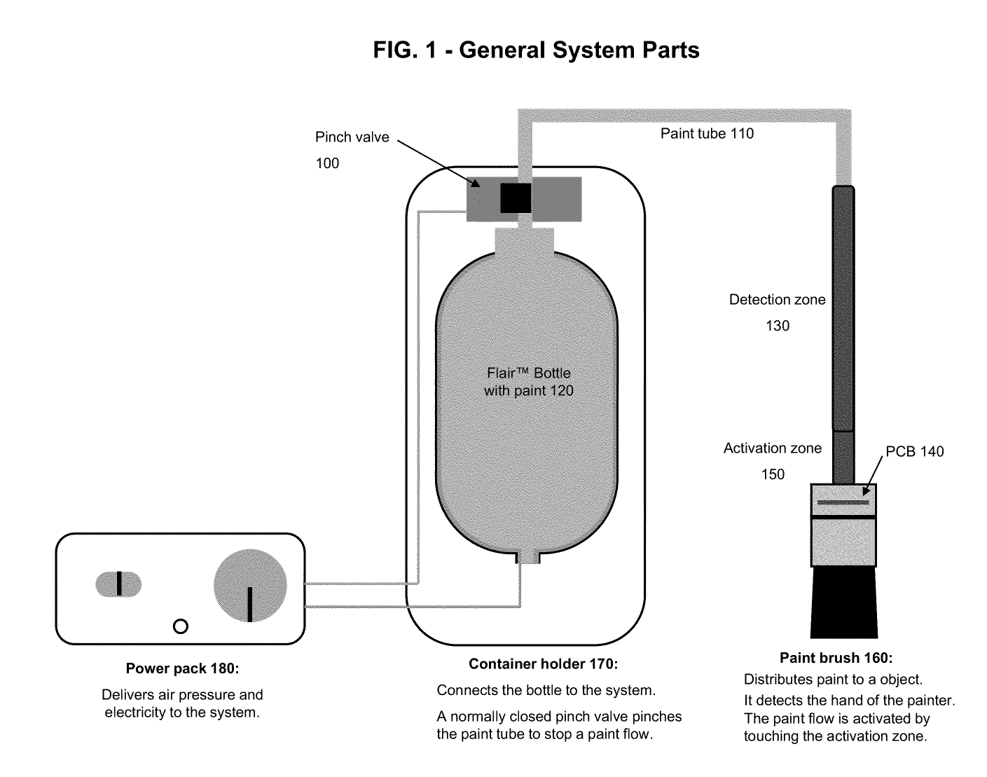

As shown in FIG. 1, in exemplary embodiments of the present invention an exemplary paint dispensing system can contain, for example, a power pack 180, a container holder 170, a Flair® type bottle 120 filled with paint, a pinch valve 100, a paint tube 110, and, at the end of the paint tube—an active handle assembly, including, for example, a detection zone 130, an activation zone 150, and a paint brush 160 comprising or connected to a novel printed circuit board (“PCB”) 140.

In exemplary embodiments of the present invention power pack 180 delivers air pressure and electric power to the system, container holder 170 contains and connects a (pre-filled) Flair® type bottle with paint 120 to the system, and comprises pinch valve 100, normally closed, that prevents paint flow through the paint conduit tube 110 unless a user causes such valve to open. Paint brush 160 distributes paint to an exemplary object or surface, and an exemplary brush holder can, for example, detect the presence of a user's hand on a detection zone 130. If such a presence is detected, then—and only then—activation zone 150 will respond to a user's touch to open pinch valve 100 and thus activate paint flow. The container holder 170 can, for example, be worn on a user's back, allowing a completely self-contained system with full portability.

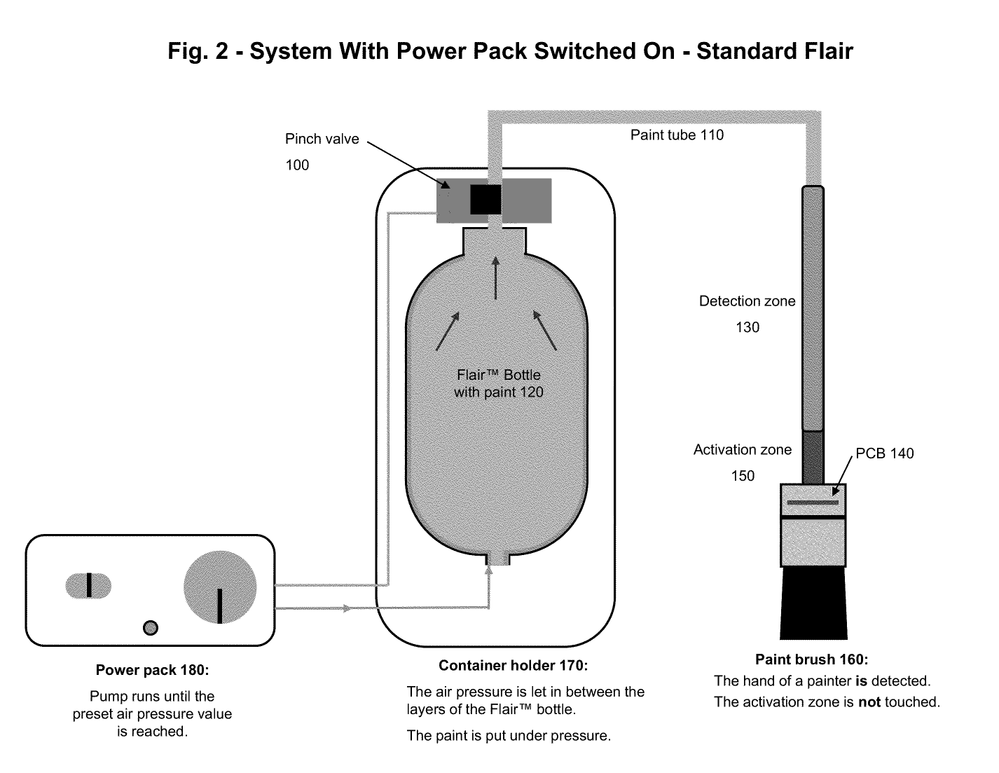

FIG. 2 illustrates the system of FIG. 1 with power pack 180 turned on (note the green indicator light at the bottom of power pack 180). Thus, the pump contained in such power pack will run until the Flair® container is pressurized to a certain preset value. As a result of such pressurization, air or other pressurization medium has been let in between the two layers of the Flair® type container, and the paint or stain, for example, in the inner bottle is now pressurized. Here also a user's hand has been detected on detection zone 130, and thus it is shown in green, but the user has not yet pressed or touched activation zone 150, so at this point pinch valve 100 remains closed, and no paint can yet flow, and thus paint brush 160 has no paint flowing out of it.

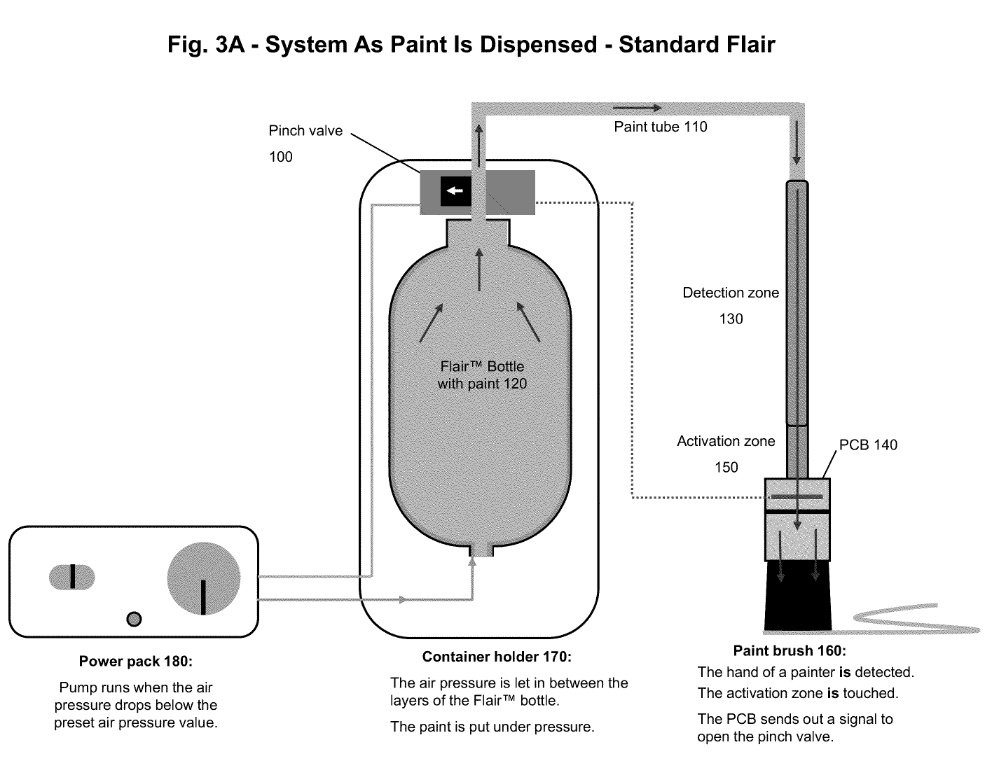

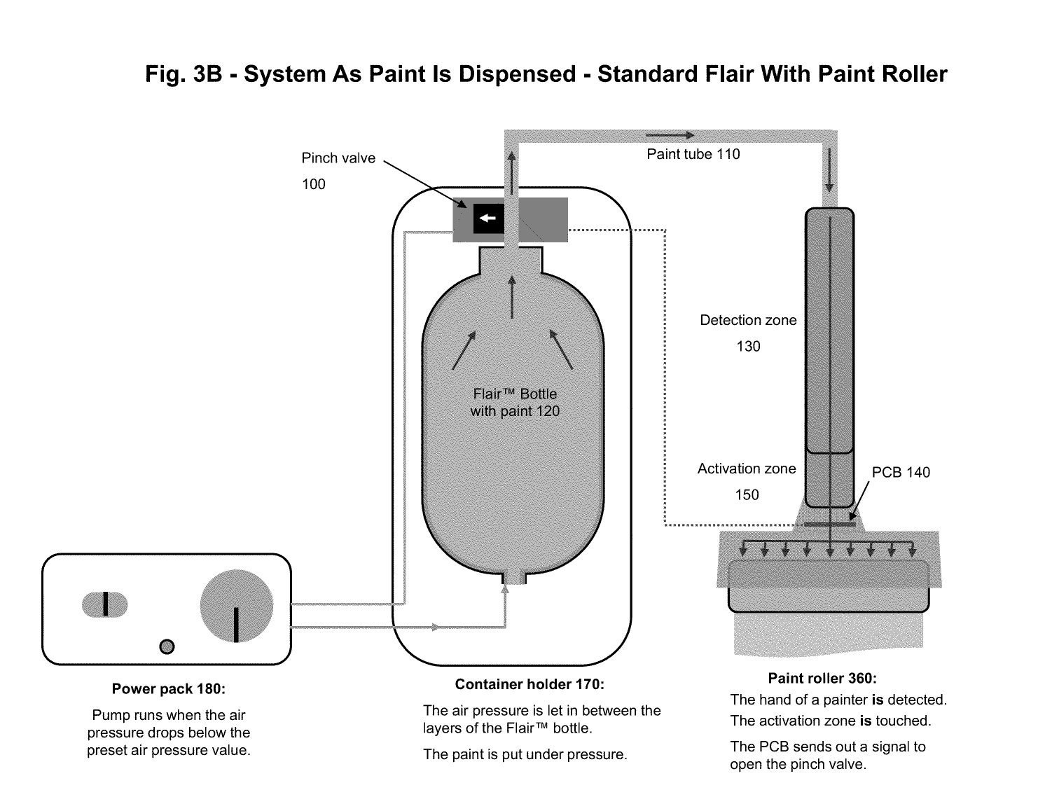

FIGS. 3A and 3B depict the exemplary system of FIGS. 1-2 with both detection zone 130, and now activation zone 150 being touched by a user. This causes PCB 140 to send a signal to open pinch valve 100, as shown, allowing paint to flow in paint tube 110, and thus allow paint to be dispensed from paint brush 160, as shown. The pinch valve can thus be spring loaded to the closed position, and energy must be expended to open it. Alternatively, different approaches can be used that do not require an ongoing signal to be sent, and energy to be continually expended, to open a valve regulating the paint flow out of the container.

As shown in FIG. 3, pump 180 will run only as needed, from a point in time when the air pressure drops below the preset air pressure value, until said pressure once again reaches the preset value. In this way the Flair® system maintains the proper pressure acting on the inner container such that the paint or other liquid will dispense. It is noted that the channel over which the signal is sent from PCB 140 to pinch valve 100, shown in FIG. 3 by the green dotted line, can be a hard wired, wireless, hydraulic, or any other signal transmission means as may be known. FIG. 3A depicts a standard system as shown in FIG. 2 using a paint brush, and FIG. 3B depicts a variation of FIG. 3A where a novel electrically controlled paint roller is used in place of a paint brush, all else being equal.

It is noted that for paint dispensing systems, different volumes for the Flair® bottle are appropriate depending upon which ultimate delivery or dispensing device is used. For example, for paint delivered via a paintbrush, one uses smaller volumes, around 1 liter. With rollers, as shown in FIG. 3B, more paint is used per unit time, and thus bigger bottles should be used, such as, for example, 1 to 5 liters. For dispensing silicone or the like, for buildings or floors, one needs even larger bottles. However, if the bottle is used in an embodiment where the container holder is worn on the back, the total weight may be regulated by local law. For example, in Europe a worn container may not be more than 15 kg. For greater weight than that, one requires a trolley or similar device that can carry the container holder and the Flair® bottle inside it. Thus, by replacing caulking tubes and the like with a silicone, caulk, etc. dispensing device according to the present invention, a worker need not carry 50 tubes of caulk with him, or lift it up on the scaffolding with him or her. Thus, exemplary systems according to the present invention save packaging/waste, time and cost.

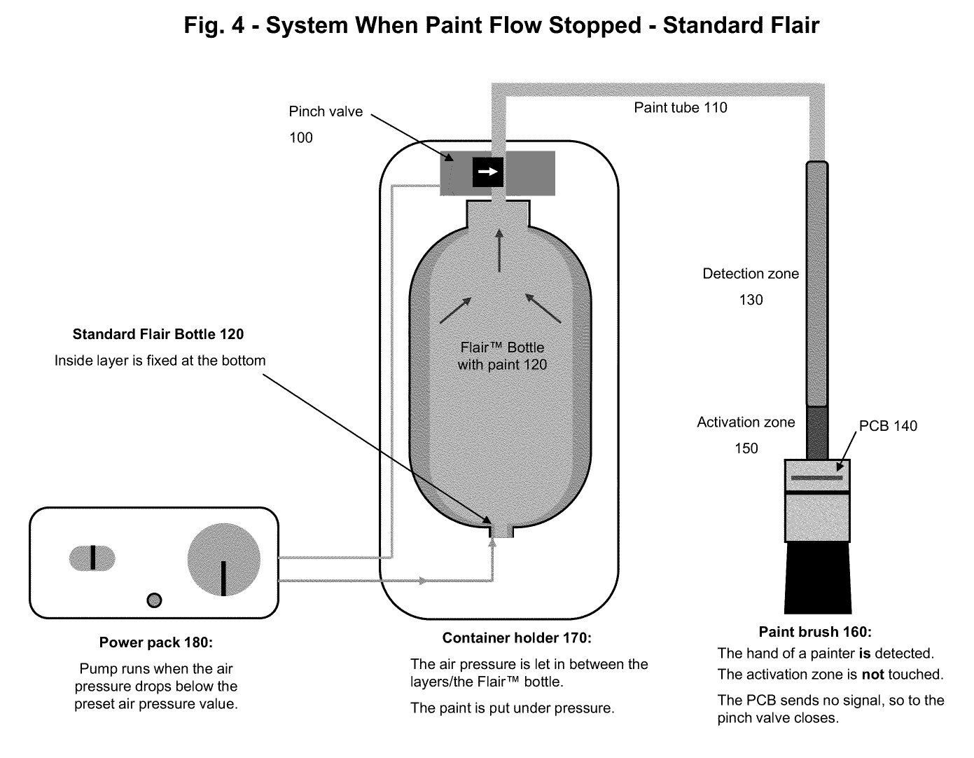

FIG. 4 depicts the system of FIGS. 3A and B where paint flow has been stopped by a user now having released activation zone 150 (thus activation zone 150 now shown in red). This causes PCB 140 to stop sending a signal to pinch valve 100 to open, and pinch valve 100 thus closes, stopping the flow of the paint through paint tube 110 and out of paint brush 160, the default setting for pinch valve 100 being closed unless a signal to open it is received and perpetuated. It is noted that such an exemplary embodiment requires energy to continually send the “open pinch valve” signal (essentially the “user is touching the activation zone” signal). This is a useful safety measure. However, in alternate exemplary embodiments, a toggle type switch can be used, which goes on with one touch and off with a subsequent touch. As can be seen in FIG. 4, the volume of the inner Flair® bottle with paint 120 has shrunk, given that a certain volume of paint has been dispensed. As the paint is dispensed, given the Flair® technology, the pressure between the inner container and outer container is maintained, and thus the inner container shrinks, and no air bubbles or occlusions can ever develop within it. As shown at power pack 180, in order to maintain the preset pressure value in the Flair® container, the pump runs whenever air pressure drops below a preset value. The blue line shows schematically the air line running from the pump to the Flair® container. Also, as shown, power pack 180 supplies power to pinch valve 100 as well (green line).

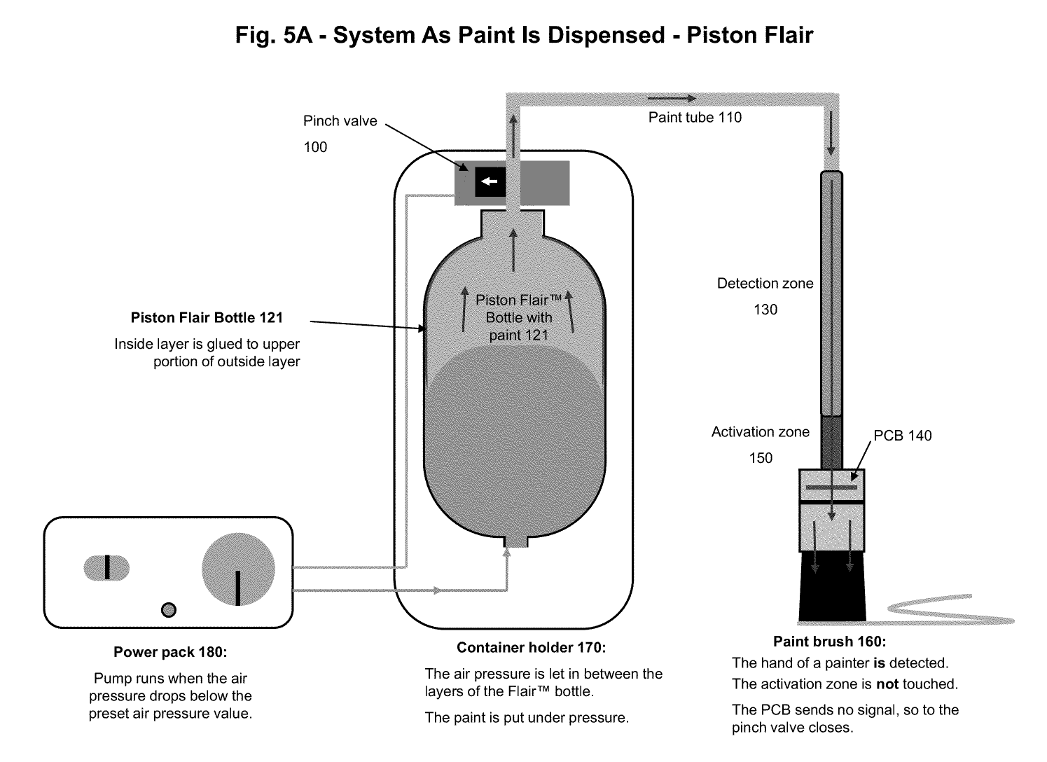

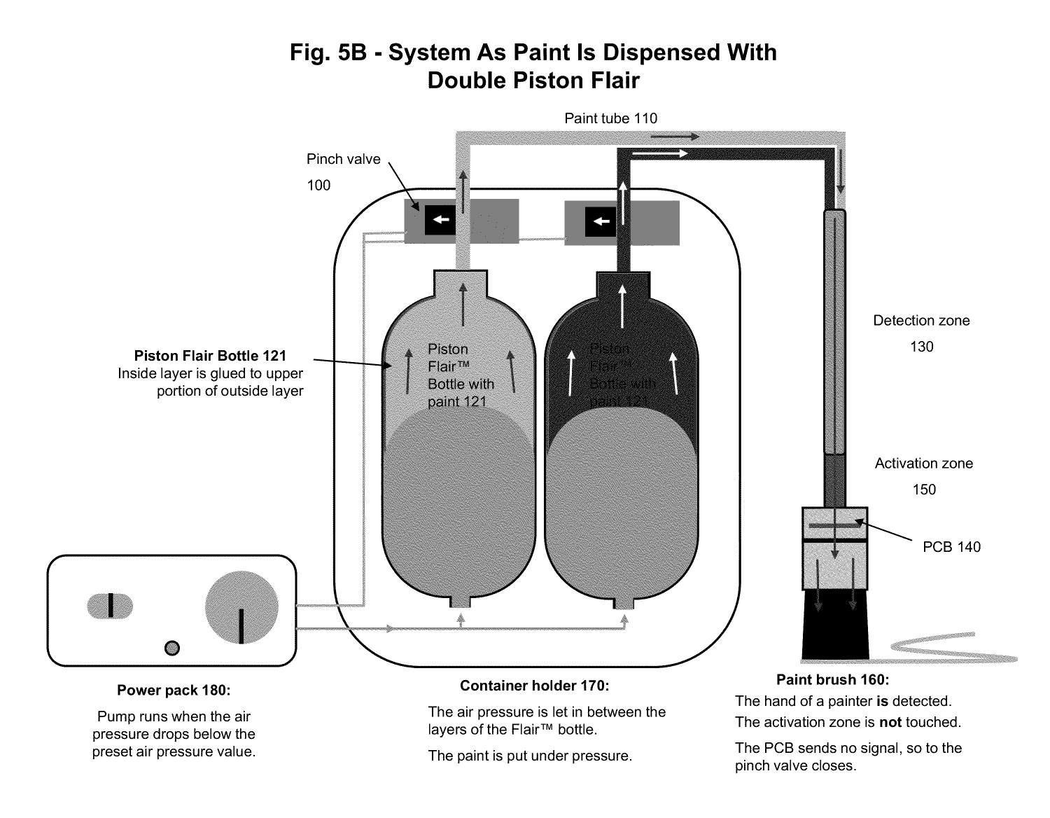

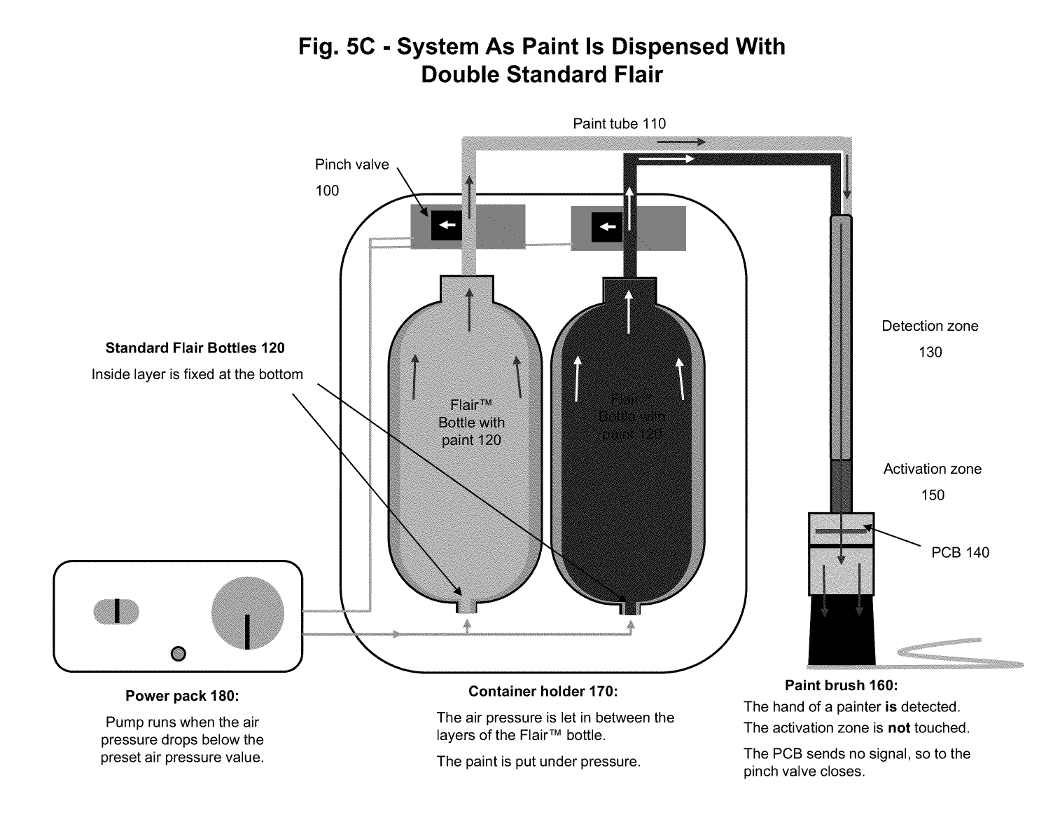

FIGS. 5A-5B depict systems essentially identical to that of FIG. 4 except that here a different type of Flair® Bottle is used to hold the liquid being dispensed. The Flair® Bottle depicted in FIGS. 5A and 5B is a “Piston Flair” type bottle 121. The unique characteristics of a Piston Flair® Bottle are that the inner container is partially glued to a portion of the inner surface of the outer container, such that the bottom, unglued portion of the inner container folds under itself as its contents are dispensed. Piston Flair® technology is described in detail in U.S. Published patent application Ser. No. 12/903,845, published as U.S. Published Patent Application No. 2011/0024450, under common assignment herewith, and the reader is referred thereto for additional details. FIG. 5B depicts an exemplary system where multiple Piston Flair bottles are used in parallel. Extending this approach, one can mix more than 2 bottles as well. Thus, 3, 4, 5, or even more bottles can be used in a combined parallel system. Using electronically controlled valving, a user can thus mix different liquids as needed or desired in precisely defined mixtures. For example, for color mixing one can open, e.g., Valve 1 for 1 second, Valve 7 for 13 seconds, etc., etc., where each Flair® bottle holds a primary or specialized component color in an exemplary color scheme. In such exemplary embodiments, the valve controlling the flow of the liquid can, for example, be provided at the bottle holder, as shown, or, for example, for thin liquids, requiring small valves, at the dispensing end, i.e., at the nozzle, brush or roller. FIG. 5C depicts using two standard Flair bottles 120 in a similar tandem set-up. In general, one uses a standard Flair bottle, which has a lower cost, for lower volume (under 8 Liters, for example), thinner, less viscous liquids. On the other hand, for larger volumes of liquid, and/or for highly viscous liquids, Piston Flair® bottles, which generally have a higher cost, can be used. Piston Flair® bottles concentrate the pressure along one direction (from the bottom of the bottle upwards), and along one 2D area, and can thus exert a greater force on the inner Flair® container at a given pressure.

What can be gleaned from the various examples of FIGS. 3, 4 and 5 is that in exemplary embodiments of the present invention various types of Flair® Bottles can be used as a container 120 and various types of liquid deposition or dispensing devices can also be used such as, for example, paint brushes, paint rollers, nozzles, etc., and even beverage dispensers and the like, as described in greater detail below.

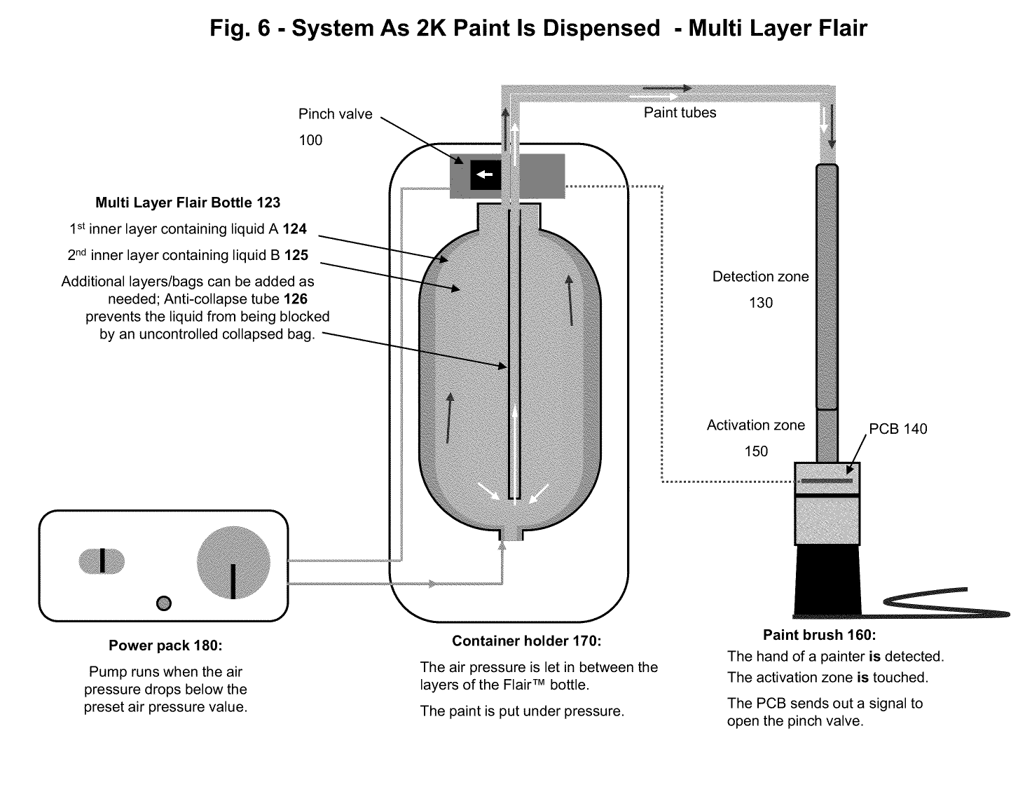

FIG. 6 shows yet another exemplary dispensing system, similar to that of FIG. 3, namely a paint dispensing system using a Multi-Layer Flair® Bottle 163. A Multi-Layer Flair® Bottle operates under the same principle as the standard Flair® bottle 120 as shown in FIG. 4 except that the Flair® concept is extended to multiple nested inner containers, each having a separate liquid. With reference to FIG. 6, the Multi Layer Flair® Bottle 163 has an outer layer shown in black outline, and an air gap, or displacing medium gap, shown in blue between the outer layer and the first inner container. The first inner container 161 contains a Liquid A, shown in violet. Wholly within the first inner layer is a second inner container 162 with Liquid B shown in yellow. In fact, additional layers/bags can be added as needed and various numbers of multiple layers can be used in Multi-Layer Flair Bottle 163. Finally, in the very center of the Multi Layer Flair Bottle 163 is anti-collapse tube 164 (shown in black) which prevents the liquids from being blocked by an uncontrolled collapsed bag. In other words, if one of the bags crimps in its middle there may be liquid at the bottom of the container which cannot be pushed out through the opening at the top due to such crimping. Anti-collapse tube 164 prevents that and maintains the various layers of the Multi-Layer Flair Bottle in un-collapsed configurations.

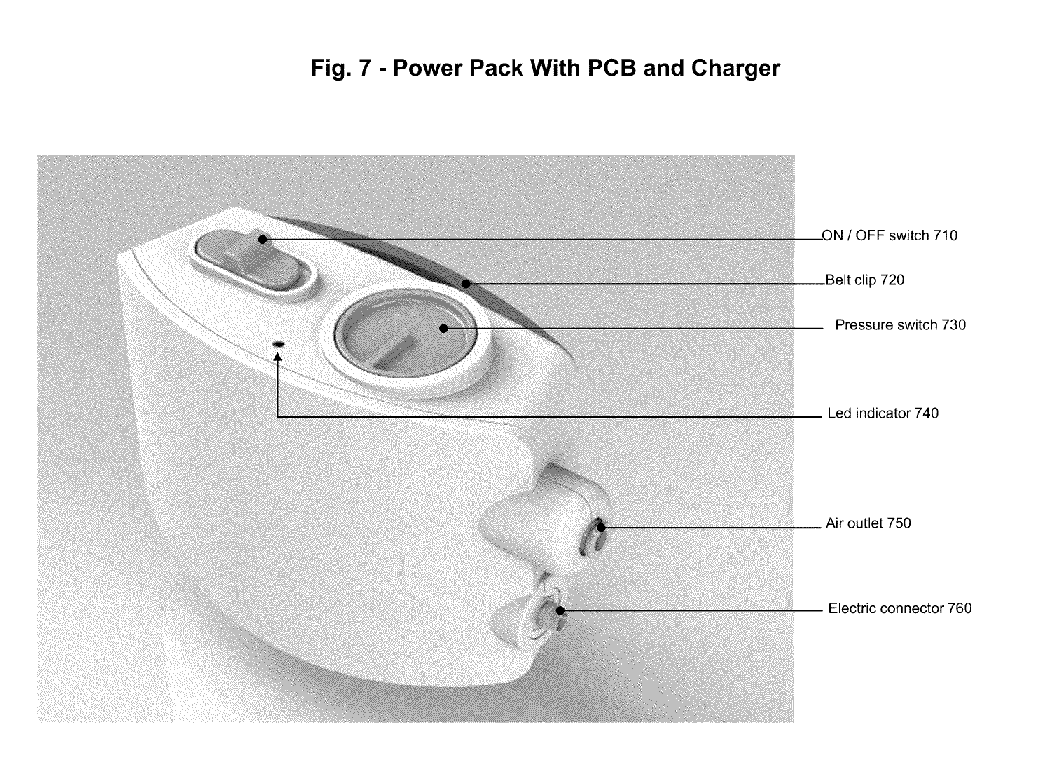

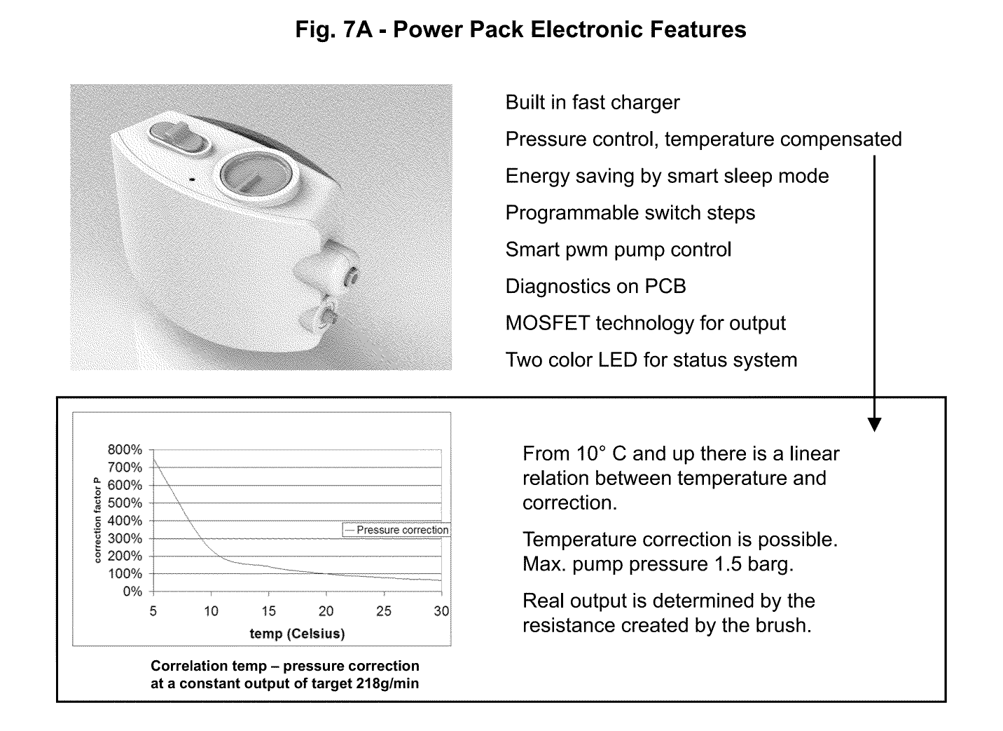

FIG. 7 provides details and features of an exemplary power pack module according to an exemplary embodiment of the present invention. There is an ON/OFF switch 710 to turn on the device. The power pack can be attached to a user's belt via belt clip 720. Pressure switch 730 allows a user to set a preset pressure value for the system, as described above. LED indicator 740 displays a light signal when the pump is on. Finally, there are shown air outlet 750 which runs to the Flair® container and supplies it with the pressurization medium (e.g., air), and electric connector 760 which powers pinch valve 100, as shown in FIGS. 1-6).

FIG. 7A depicts various electronic features of an exemplary power pack according to exemplary embodiments for present inventions. Such features can include, for example, a built-in fast charger, pressure control which is temperature compensated, as shown in the lower panel of FIG. 7A, energy savings via a smart sleep mode (e.g., sleeps after 5 minutes of inaction), programmable switch steps (e.g., 1-5 pressures, or 1-7 pressures available, set by a user), smart PWM pump control, diagnostics provided on the printed circuit board, the use of MOSFET technology for the output, and a two-color LED as a systemic front/signaling system. As shown in the lower panel of FIG. 7A, from a temperature of approximately 10 degrees centigrade and greater, there is a linear relationship between temperature and pressure correction. Thus, in this temperature range temperature correction is possible and the maximum pressure is 1.5 barg. The real output is determined by the resistance created by the brush or roller as shown in FIG. 3. Temperature compensated pressurization allows for the use of higher pressures at lower temperatures, and vice versa, which obviates the need for extra solvents and thinners, for example, in paint, and always matches the system pressure used for the Flair® container to the then prevailing temperature. By avoiding solvents, more actual paint can be provided in every Flair® container, thus further optimizing paint delivery.

Additionally, it may often be useful to heat the liquid to be dispensed, so as to keep the temperature of the liquid somewhat above ambient temperature, thus requiring less pressure to dispense it. Such a heating element can, for example, be provided in the container holder, or along the conduit tube(s), or for example, within the nozzle, as may be most appropriate in given design contexts.

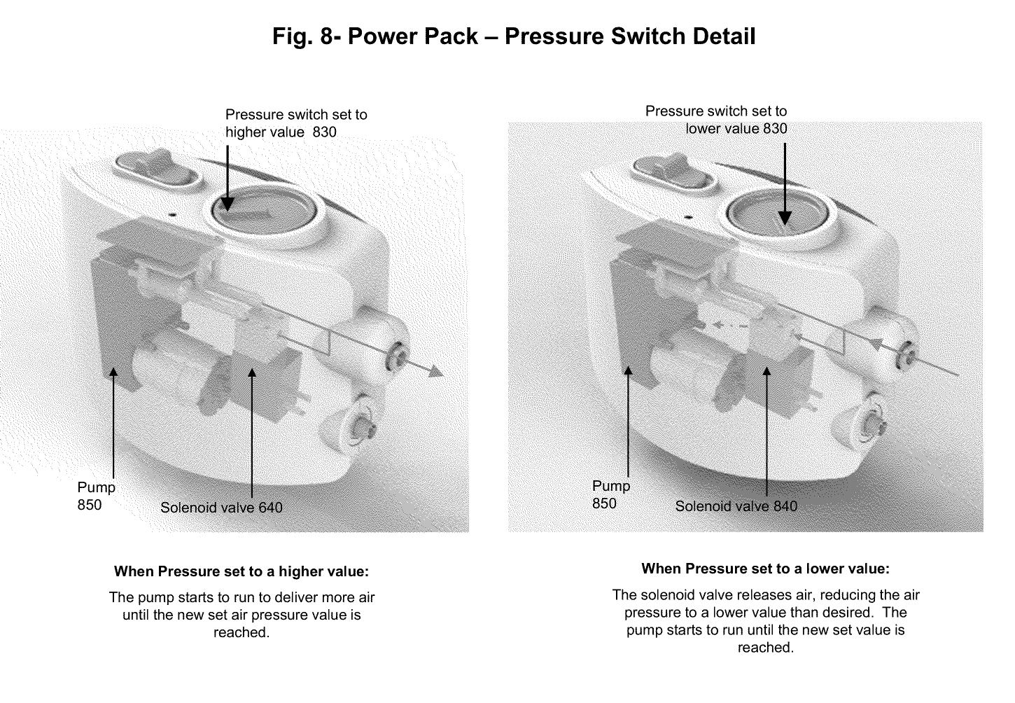

FIG. 8 depicts details of pressure switch 830 and interactions of pump 850 and solenoid valve 840 therewith according to an exemplary embodiment of the present invention. As shown in FIG. 8, when pressure switch 830 is set to a higher value, pump 850 starts to run to deliver more air until the new set air pressure value is reached. Similarly, when pressure switch 830 is set to a lower value, solenoid valve 840 releases air, reducing the air pressure to a lower value than desired, and pump 850 starts to run until the new set value is reached.

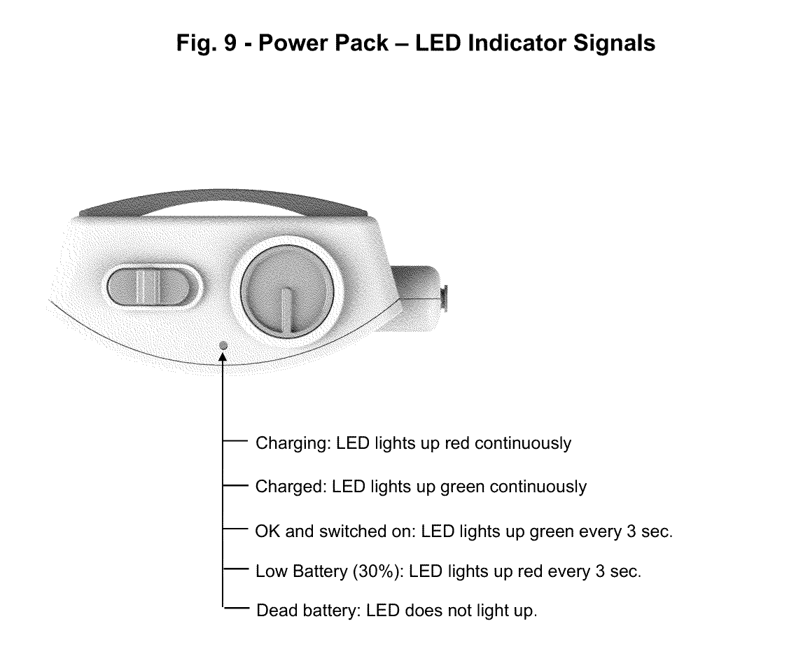

FIG. 9 depicts various display sequences of an exemplary power pack LED indicator and their respective exemplary meanings according to an exemplary embodiment of the present invention. These can include, for example:

Charging: LED lights up red continuously

Charged: LED lights up green continuously

OK and switched on: LED lights up green every 3 sec;

Low Battery (30%): LED lights up red every 3 sec; and

Dead battery: LED lights up red every 1 sec.

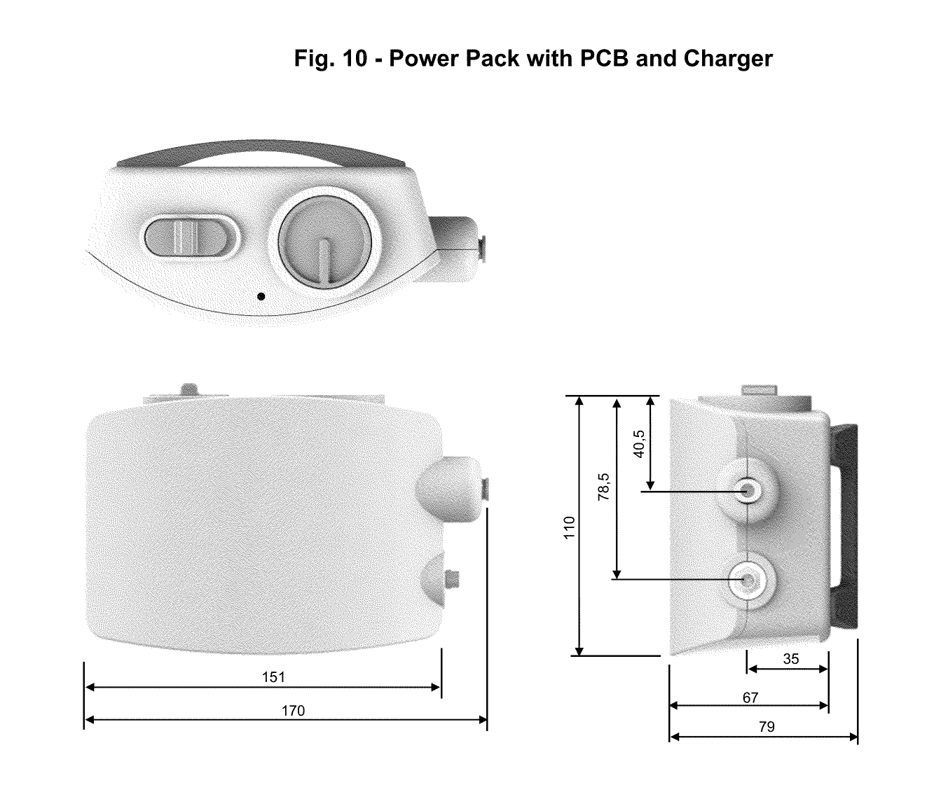

FIG. 10 depicts exemplary dimensions and form factor of the exemplary power pack of FIGS. 7-9, and FIG. 11 depicts exemplary dimensions and form factor of an exemplary container holder assembly according to an exemplary embodiment of the present invention. With reference thereto there is provided an opening for paint tube 1110, an electric connector 1120, pinch valve 1130, belt clip 1140 and door clip 1150.

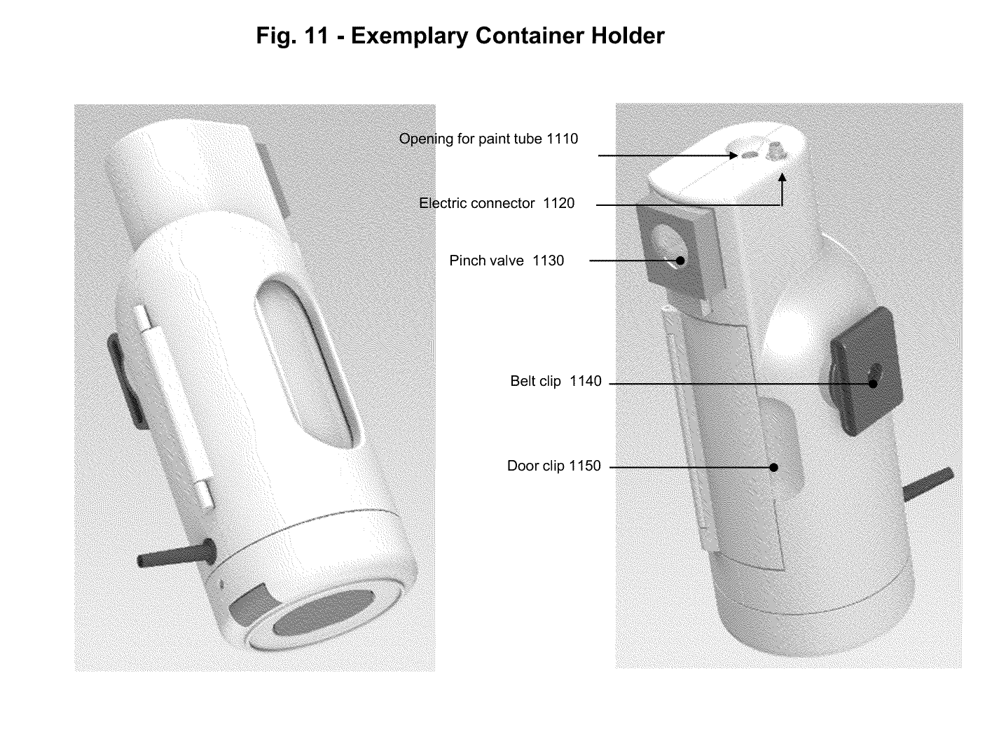

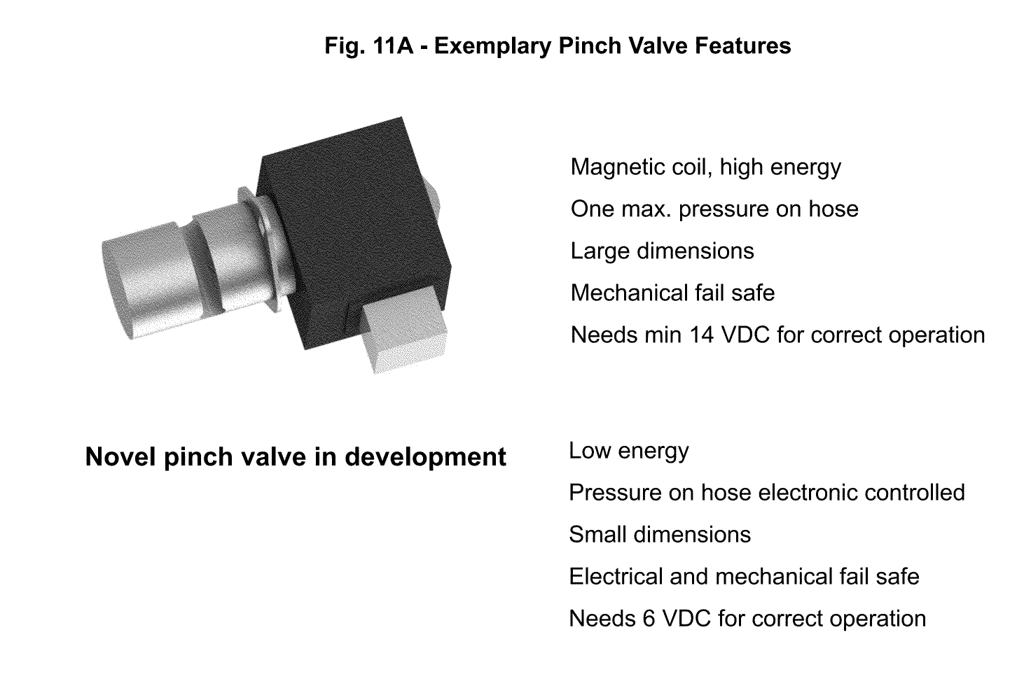

FIG. 11A depicts exemplary pinch valve features according to exemplary embodiment of the present invention. Once again, with reference to FIGS. 2 and 3 pinch valve 100 can be, for example, the basic valve which allows paint or other dispensed liquid to flow from the Flair® container 120 out through the paint tube or conduit 110. With reference to FIG. 11A an exemplary pinch valve can have various functionalities. In a first exemplary embodiment it can have a magnetic coil using high energy. There is one maximum pressure on the hose, it can have large dimensions, a mechanical fail safe, and can, for example, operate on 14 volts DC. In an alternate exemplary embodiment of such valve now in development, an exemplary pinch valve can operate on low energy, can have the pressure on the hose electronically controlled, can have small dimensions, can have both electrical and mechanical fail safe features, and can operate on 6 volts DC.

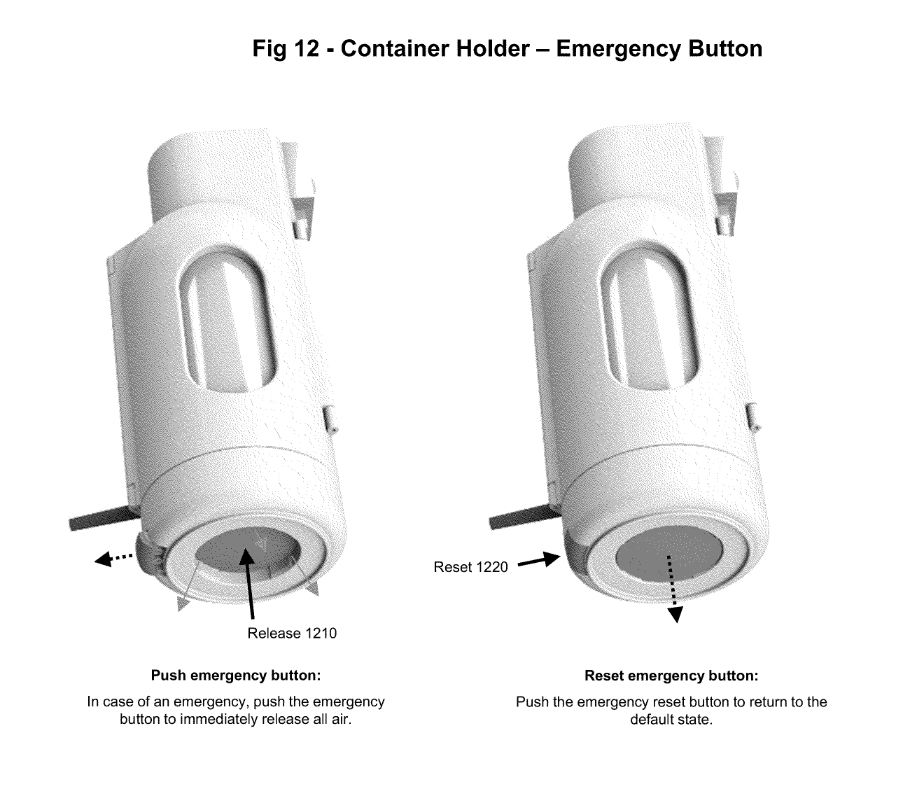

FIG. 12 depicts details of an exemplary container holder emergency button according to an exemplary embodiment of the present invention. As shown, in case of an emergency, a user or other person can push the emergency button 1210 to immediately release all air form between the Flair® layers. This stops any liquid from being dispensed, as there is no pressure on the inner container. When the emergency has passed, pushing the reset button 1220 returns the container holder to the default pressurized state.

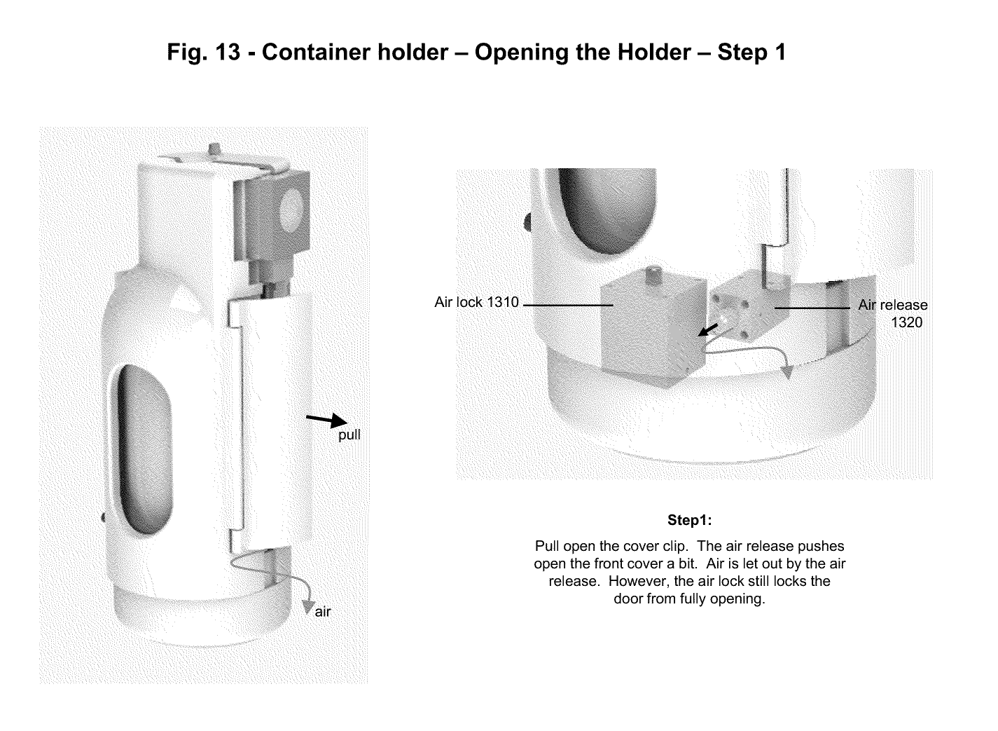

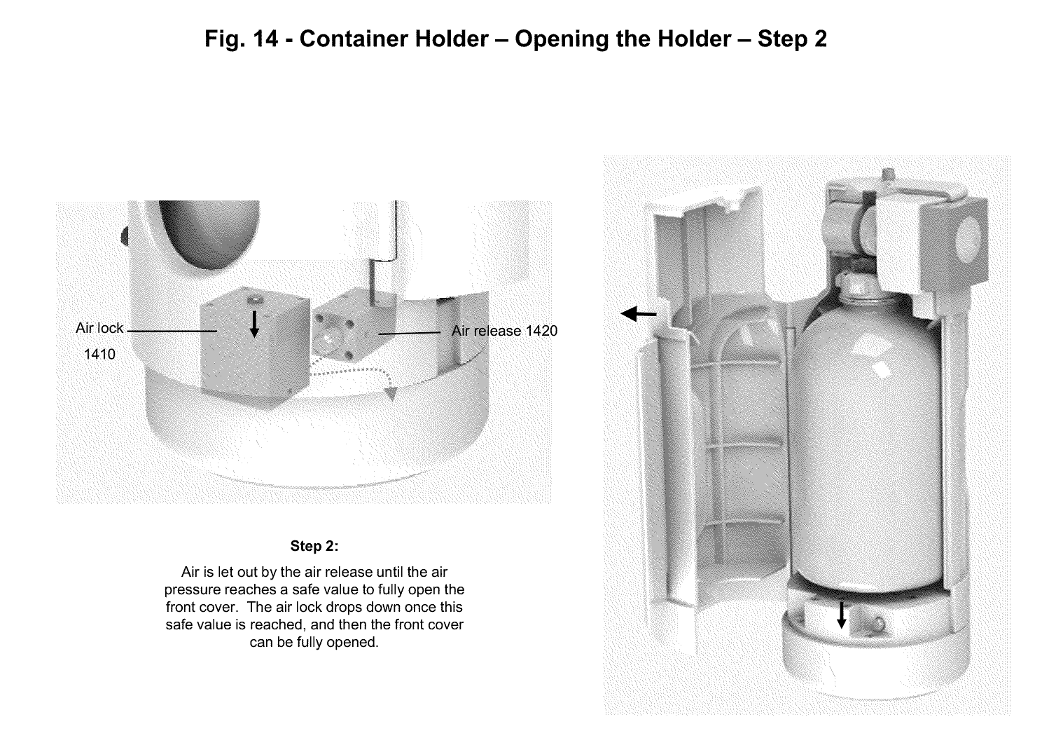

FIGS. 13-14 depict various steps in opening the exemplary container holder according to an exemplary embodiment of the present invention. In a first step, as shown in FIG. 13, one pulls open the cover clip. The air release 1320 pushes open the front cover a bit, and air is let out by the air release. However, the air lock 1310 still locks the door from fully opening. As shown in FIG. 14, in a second step air is let off by the air release 1420 until the air pressure reaches a safe value at which one can fully open the front cover. The air lock 1410 then drops down (shown in the right panel in a dropped down state) when this safe value is reached. The front cover can then be fully opened, granting access to the Flair® bottle.

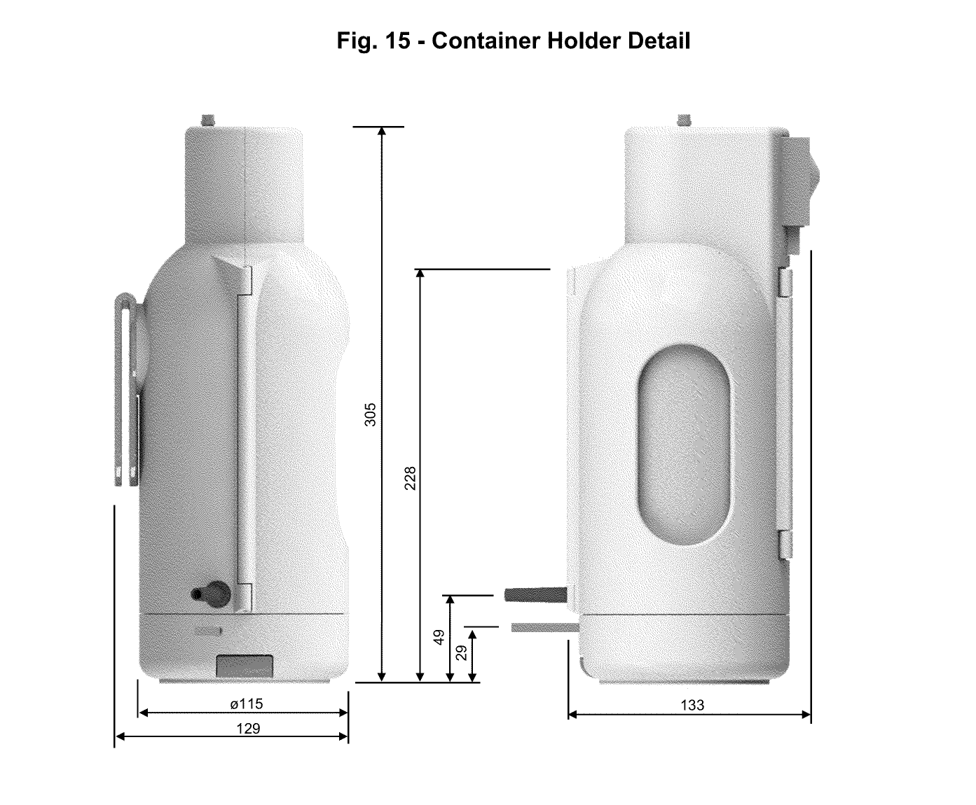

FIG. 15 depicts exemplary dimensional detail of a container holder according to an exemplary embodiment of the present invention. The device is portable, and moreover wearable by a user.

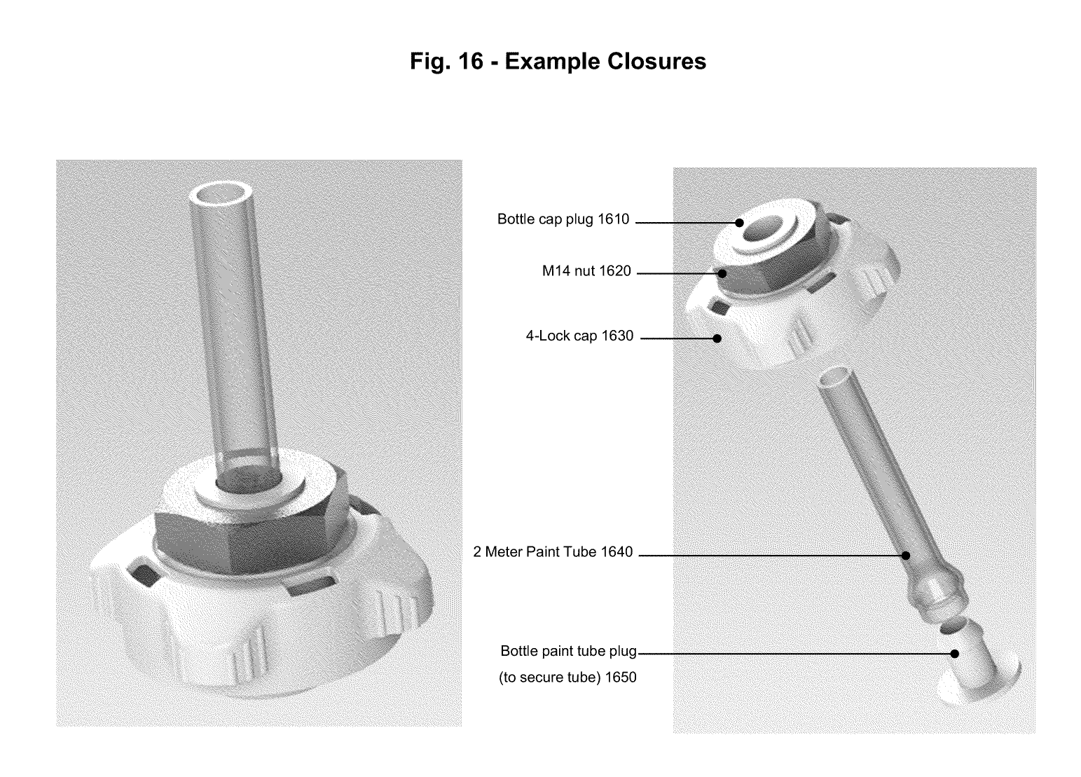

FIG. 16 depicts exemplary closures according to exemplary embodiments of the present invention, and their interoperation with the conduit tube 1640. Shown is bottle cap plug 1610, M14 nut 1620, and 4-Lock cap 1630. A 4-Lock cap can easily be automatically be closed or opened, such as in manufacture and/or filling servicing, inasmuch as a machine can grab it from any angle, and manipulate it with a small turn. This obviates the need for careful registration of the bottle and cap in one position. Inserted through the hole at the center of these pieces is an exemplary 2 meter paint tube 1640, whose lower end is attached to the actual Flair® bottle, and secured by bottle paint tube plug 1650.

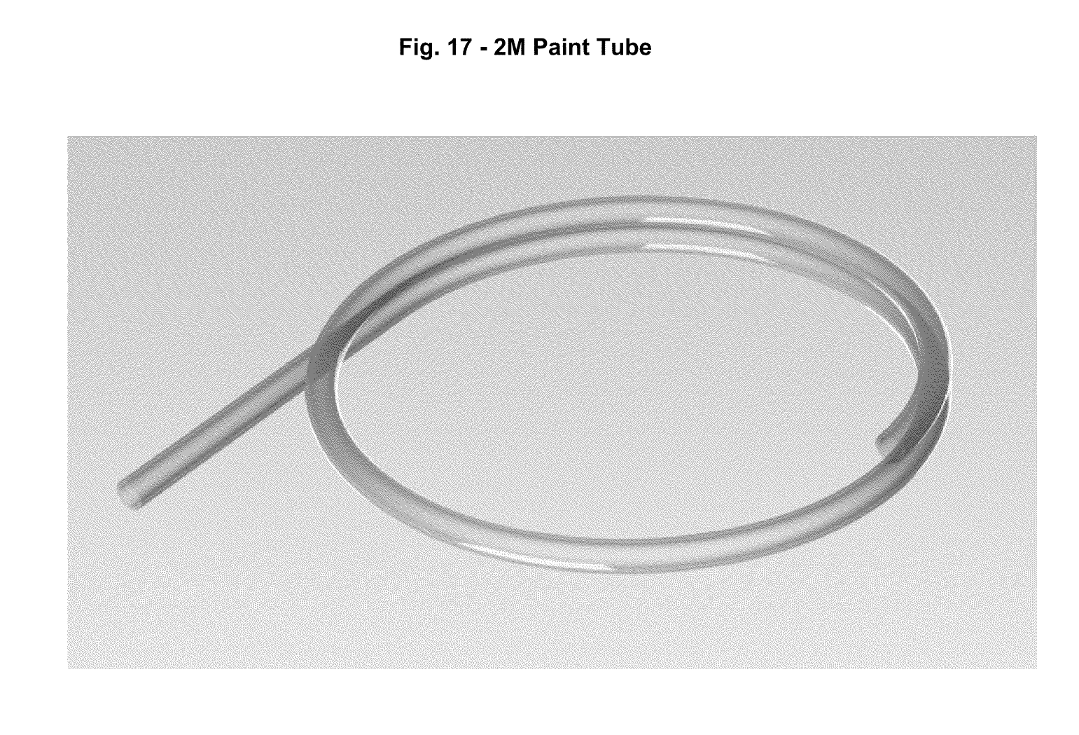

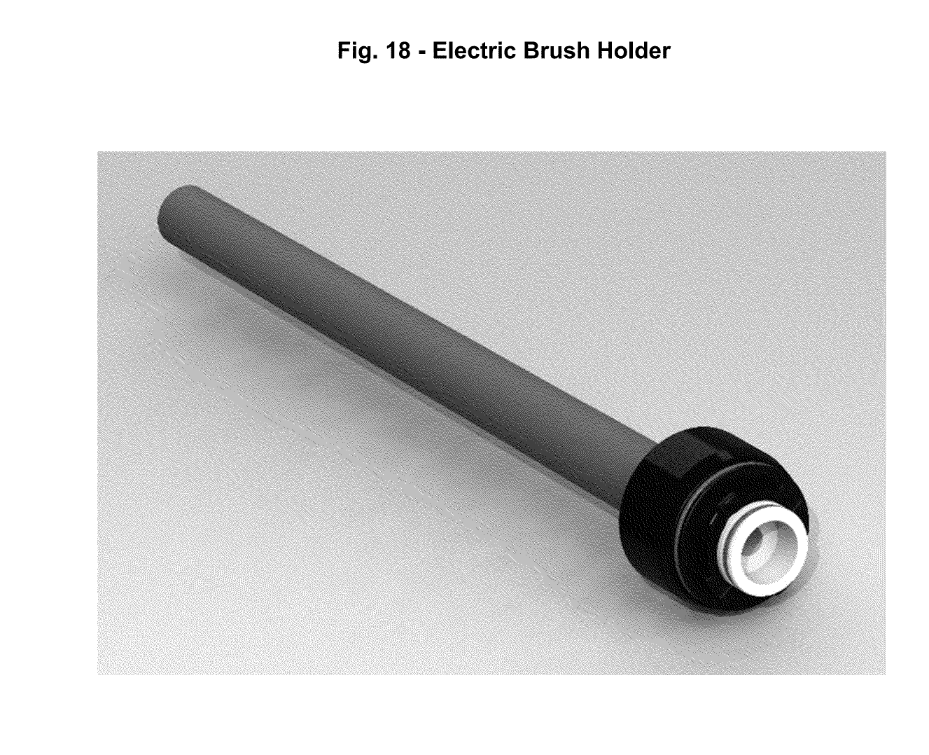

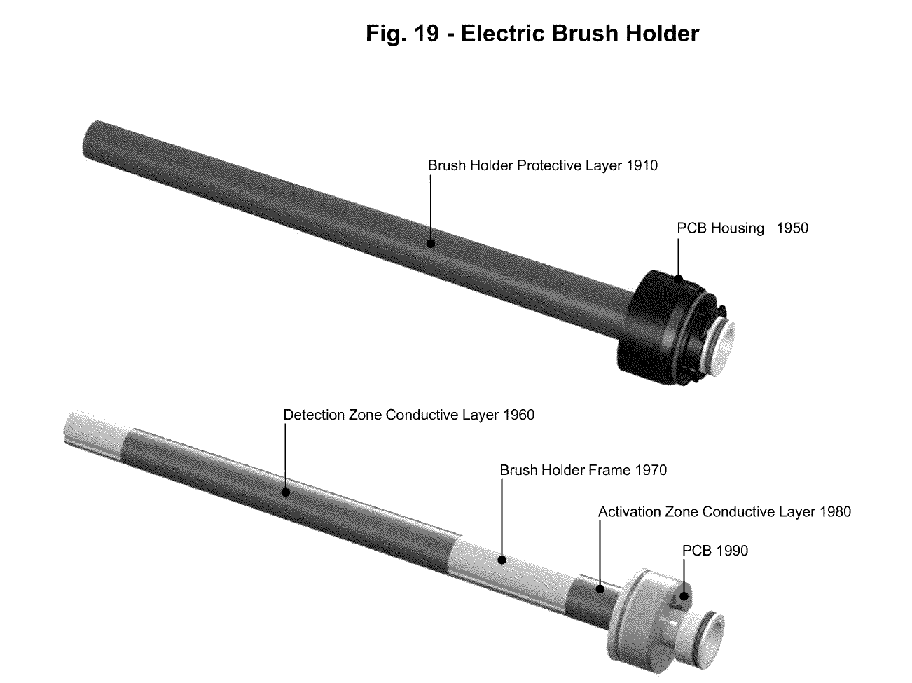

FIG. 17 depicts an exemplary tube used to conduct paint form the container holder to the paint brush according to exemplary embodiments of the present invention, and FIGS. 18-19 depict structural details and functionality of a novel electric brush holder according to exemplary embodiments of the present invention. With reference to FIG. 19, the brush holder is provided with a protective layer 1910 and aPCB housing 1950. Inside or underneath these outer structures is provided a Detection Zone Conductive Layer 1960, a non-conducting Brush Holder Frame 1970, and an Activation Zone Conductive Layer 1980. The detection zone and the activation zone send signals to PCB 1990, which can be interpreted to recognize when both of them are being touched by a user.

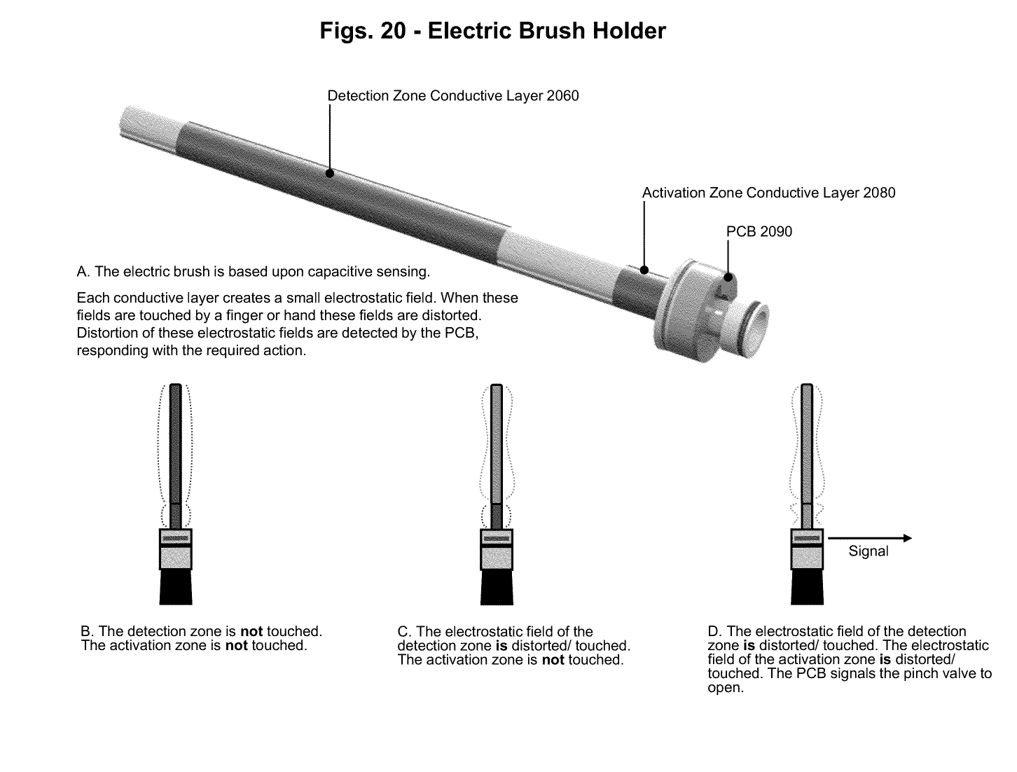

FIG. 20 illustrate various stages or configurations of the exemplary electric brush holder of FIG. 19. As shown in FIG. 20A, the electric brush is based upon capacitive sensing. Thus, each of the two conductive layers 2060 and 2080 creates a small electrostatic field. When these fields are touched by, for example, a human finger or hand these fields are distorted. Distortion of these electrostatic fields is detected by the PCB, which can respond with the required action. FIG. 20B shows the situation where neither the detection zone nor the activation zone is touched. FIG. 20 C shows where the electrostatic field of the detection zone is distorted/touched, but the activation zone is not touched. Finally as shown in FIG. 20D, the electrostatic fields of both the detection zone and the activation zone is distorted/touched. Here the PCB recognizes this, and signals the pinch valve, or other valving system as may be used, to open.

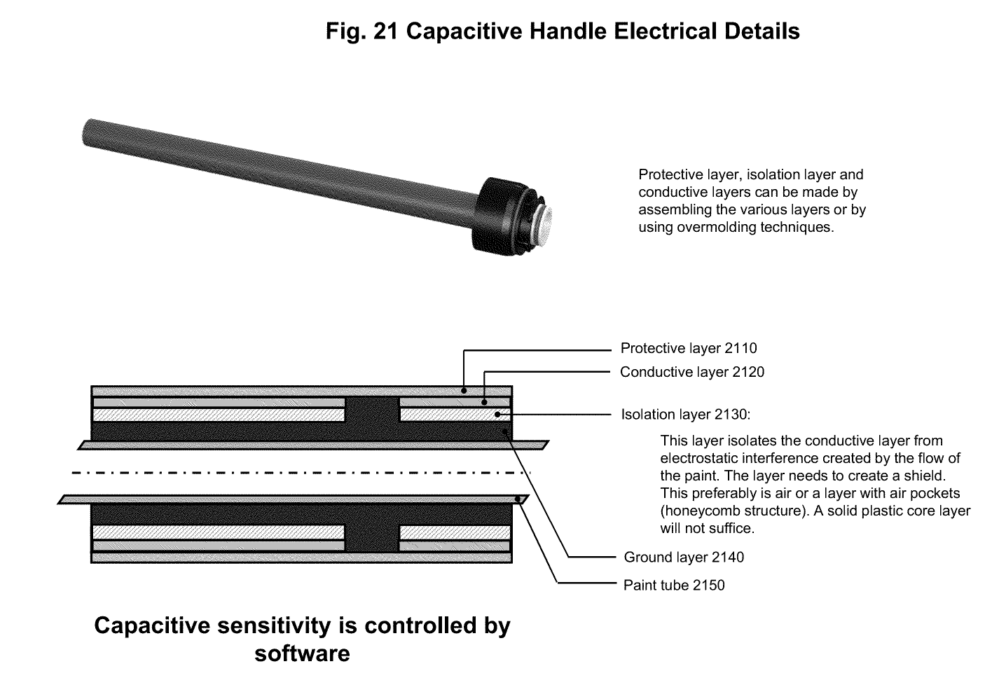

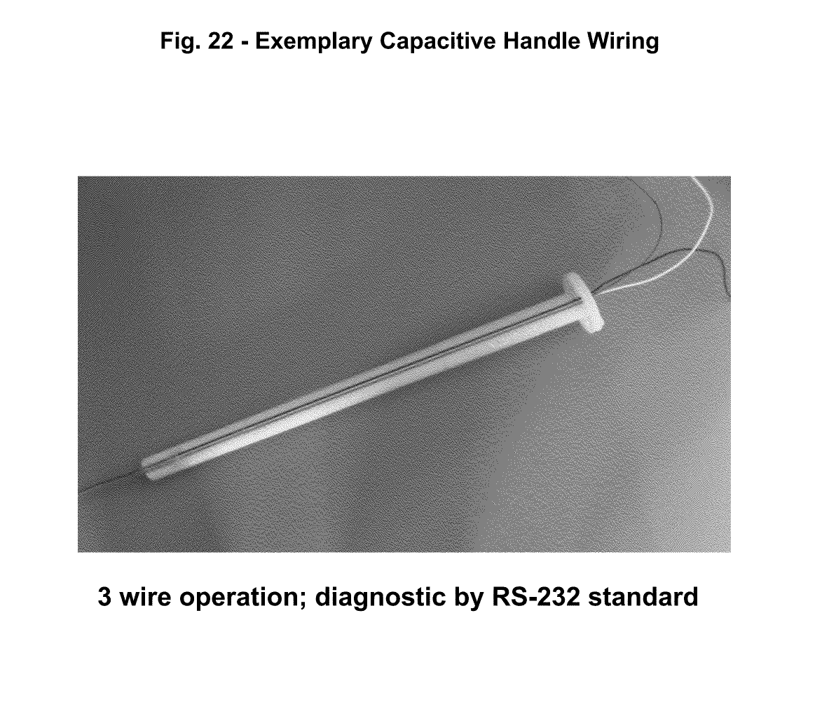

FIG. 21 depict further electrical details of an exemplary capacitive handle according to exemplary embodiments of the present invention. With reference thereto, on the top panel a perspective view of an exemplary capacitive handle is shown. It is noted that the protective layer, the isolation layer and the conductive layer can be made by assembling the various layers or, for example, by using over molding techniques. As shown in the bottom panel of FIG. 21, the capacitive sensitivity can, for example, be controlled by software. As shown in the bottom panel, there is a protective layer 2110; interior to that is a conductive layer 2120 and still interior to that is an isolation layer 2130. The isolation layer isolates the conductive layer from any electrostatic interference created by the flow of paint or liquid within the handle. The layer needs to create a shield, and such a shield preferably can be, for example, air or a layer with built-in air pockets such as, for example, a honeycomb structure. It is noted that a solid plastic core layer is generally not a good choice for such an insulation layer. Interior to the isolation layer 2130 can be, for example, a ground layer 2140, and interior to the ground layer 2140 can be paint tube 2050 carrying paint or some other liquid to be dispensed using the exemplary system. As shown in FIG. 22, the capacitive handle can use three wires and be capable of RS-232 standard diagnostics.

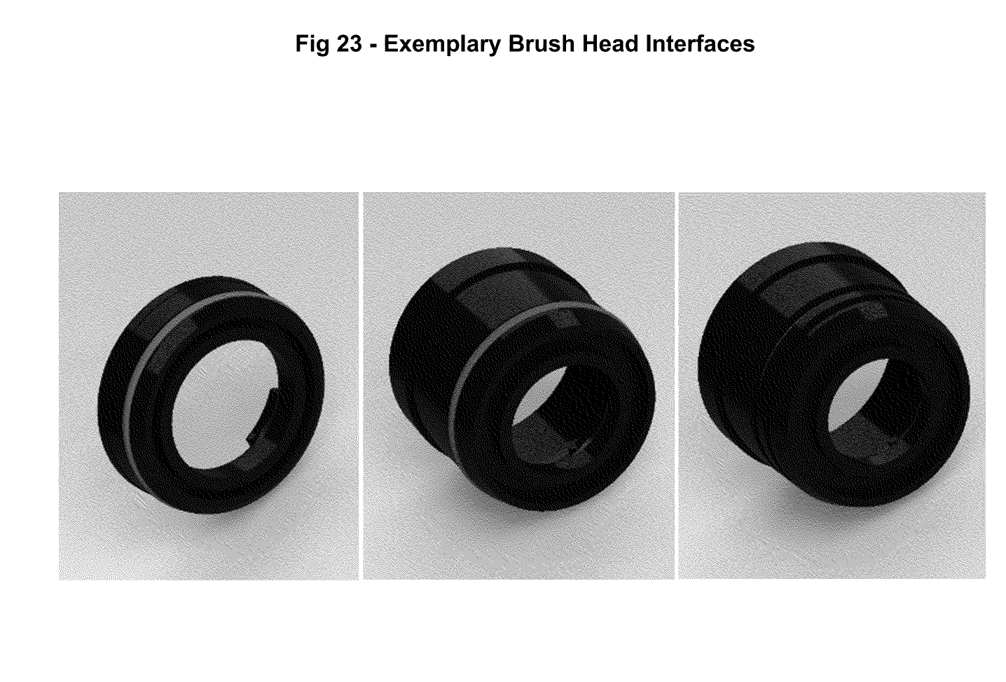

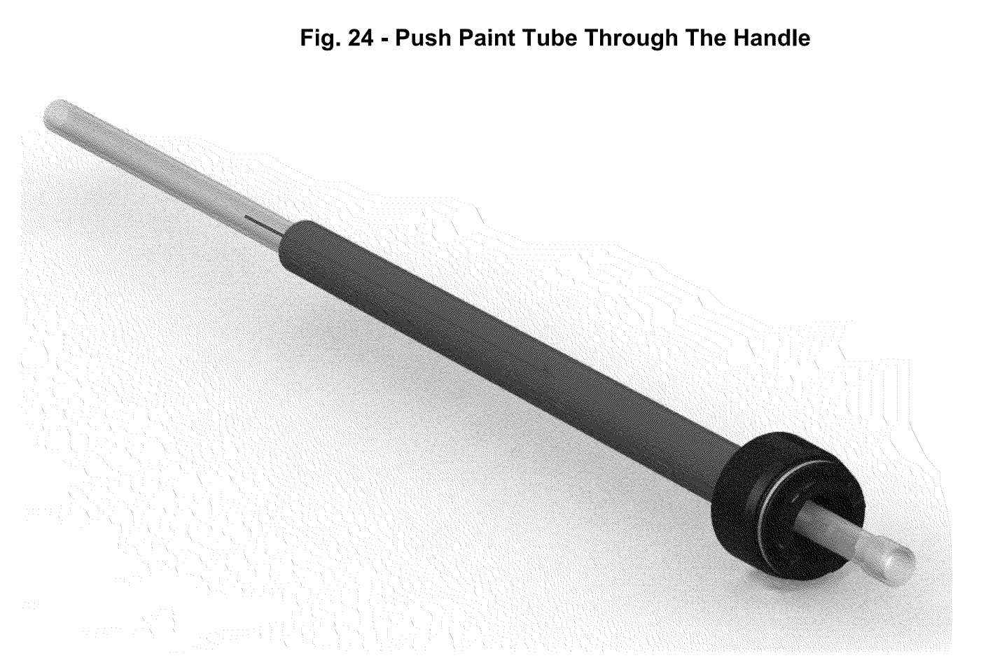

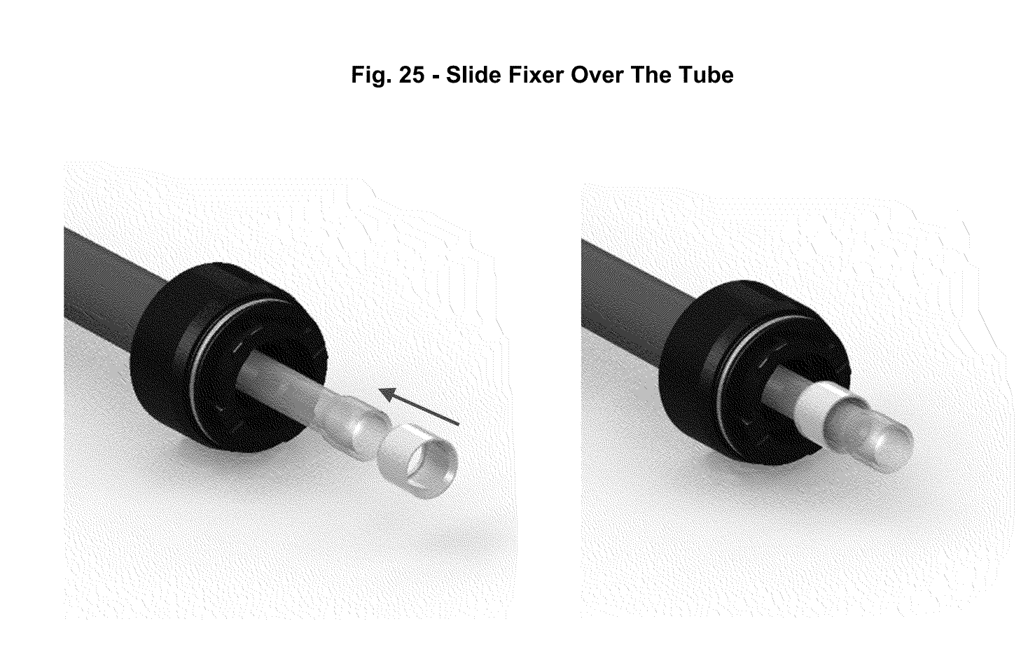

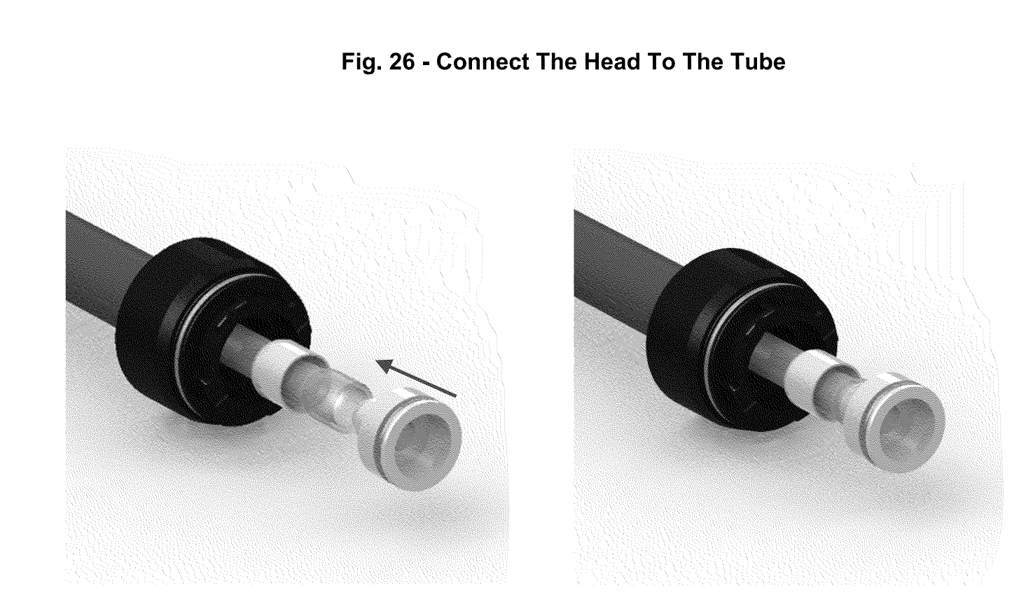

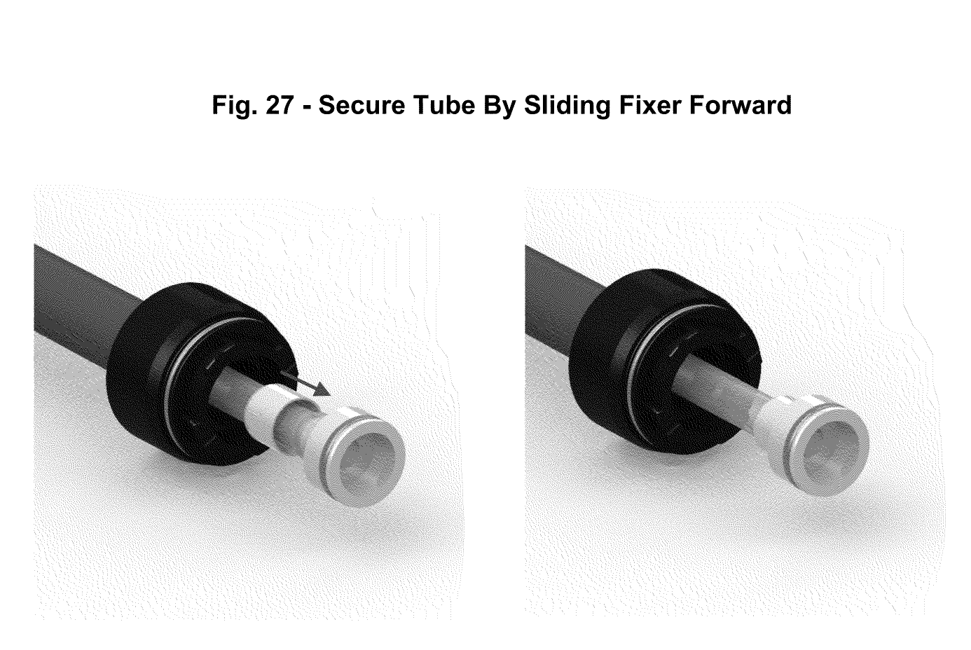

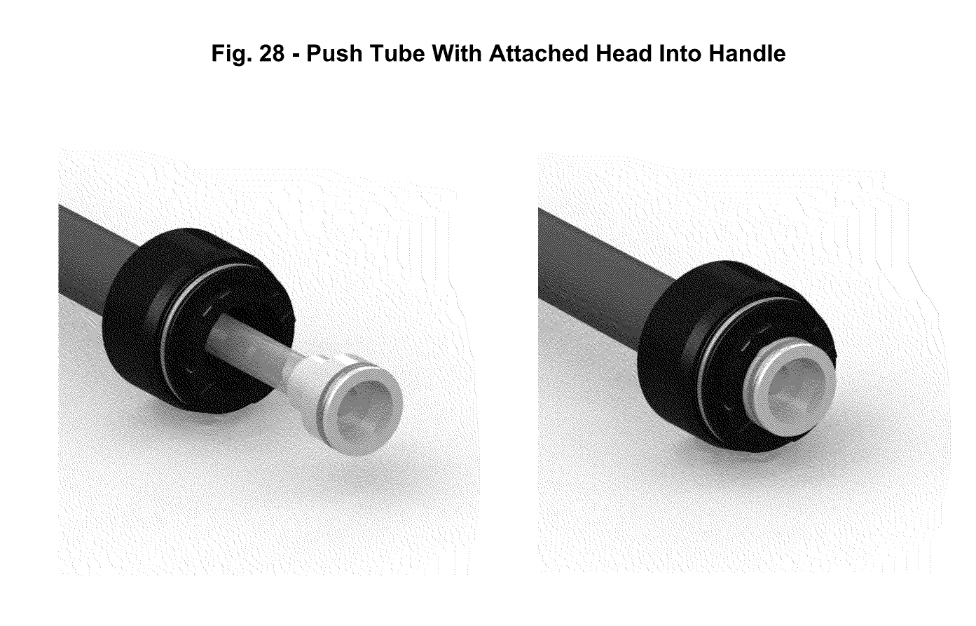

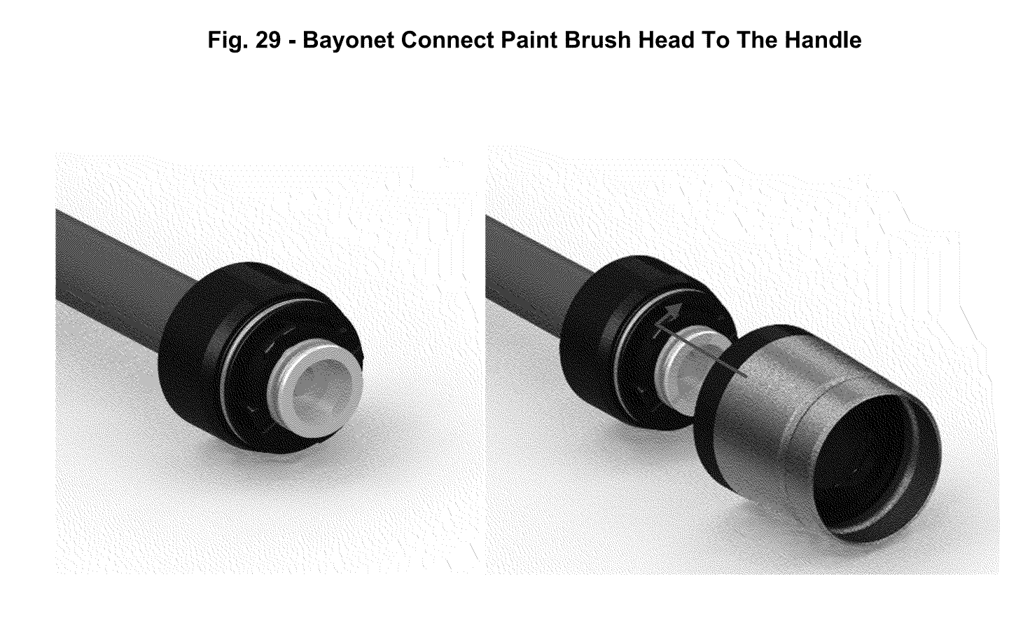

FIG. 23 depicts exemplary brush head interfaces according to exemplary embodiments of the present invention, and FIGS. 24-29 depict various stages in assembly of a paint brush and tube according to exemplary embodiments of the present invention. With reference thereto, FIG. 24 illustrates pushing a paint tube through a capacitive handle as shown in FIGS. 19-21. Then, as shown in FIG. 25, a fixer can be slid over the paint tube, and as shown in FIG. 26, a head can be affixed to the tube, and the fixer can then be slid forward to secure the tube in the head as shown in FIG. 27. FIG. 28 shows the tube with now affixed head pushed back into the capacitive handle, and finally a paint brush head can be connected, for example in a bayonet or other connection, to the handle with tube and tube head assembly, as shown in FIG. 29.

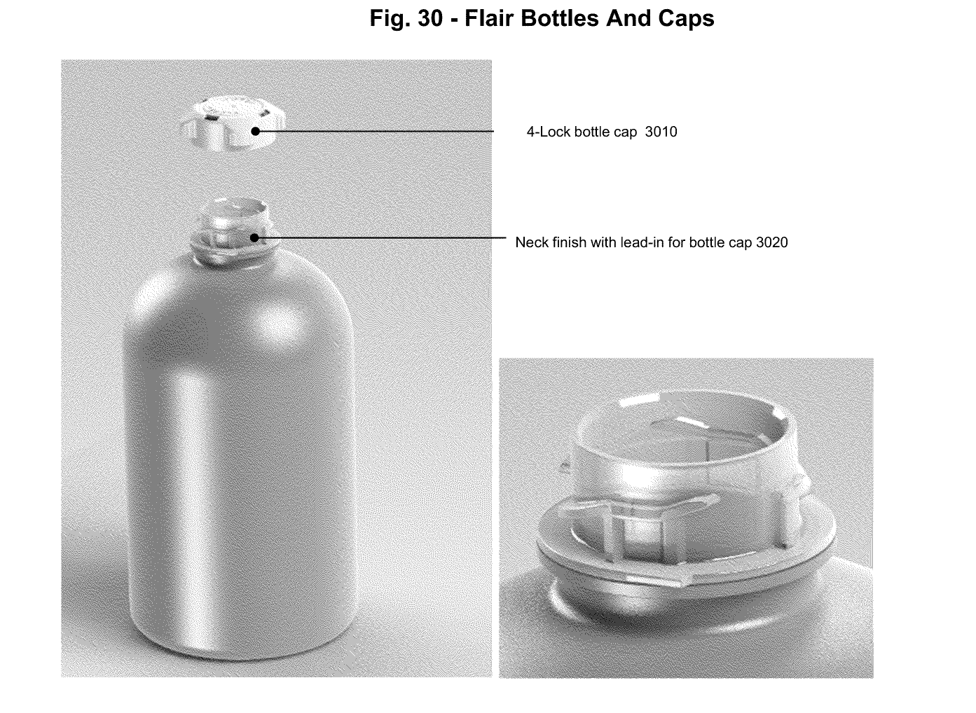

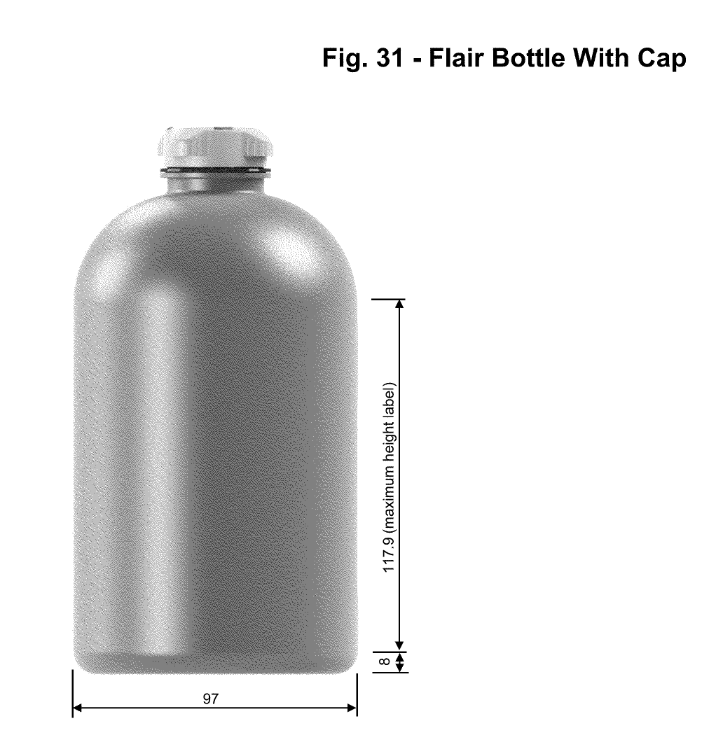

FIGS. 30-31 depict exemplary Flair® bottles and caps for use according to exemplary embodiments of the present invention. With reference to FIG. 30, the 4-lock bottle cap 3010 described above (FIG. 16) mates with the bottle's finished neck 3020, which is provided with four lead-ins and locks, as shown. FIG. 31 depicts exemplary dimensions that can be used for an exemplary Flair bottle in exemplary embodiments of the present invention, but as noted above, this all depends upon the size of Flair® bottle desired for a given application, dispensed liquid and context.

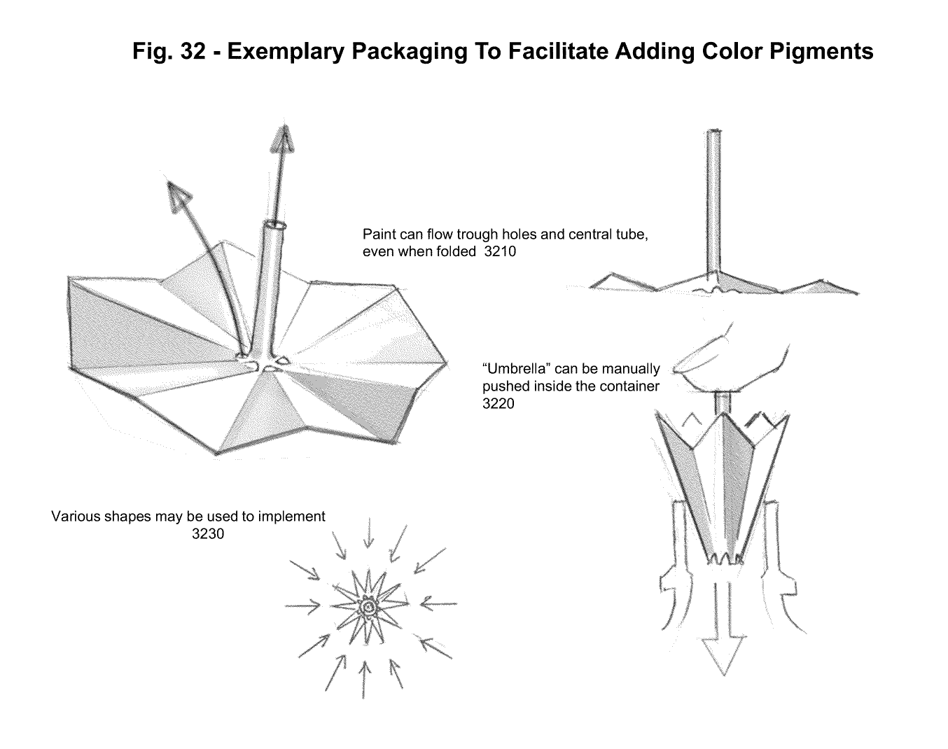

FIG. 32 illustrates various exemplary packaging options. These options address the technical problem that conventional paint color filling machines require a wider neck.

Therefore, in exemplary embodiments of the present invention, using the exemplary devices of FIG. 32 paint or pigment dispensed form a standard paint color machine, such as found in hardware stores and paint sellers, can fall on an “umbrella” type structure, and after depositing the color or pigment on the umbrella all of the colorant can be manually pushed into the bottle by pushing the umbrella into the bottle 3220, and thus mix in the paint. The tube in the “umbrella” can be used to press the umbrella into the bottle. It is noted that various shapes of the “umbrella” structure can be used 3230, as long as a wider surface is provided that can be folded and pushed through the exemplary bottle neck. The tube can be separate from the umbrella, and at the end of pigmentization of the bottle, it can also be pushed into the bottle so as to capture the pigment remaining inside it as well.

### Exemplary Liquid/Air Mixtures

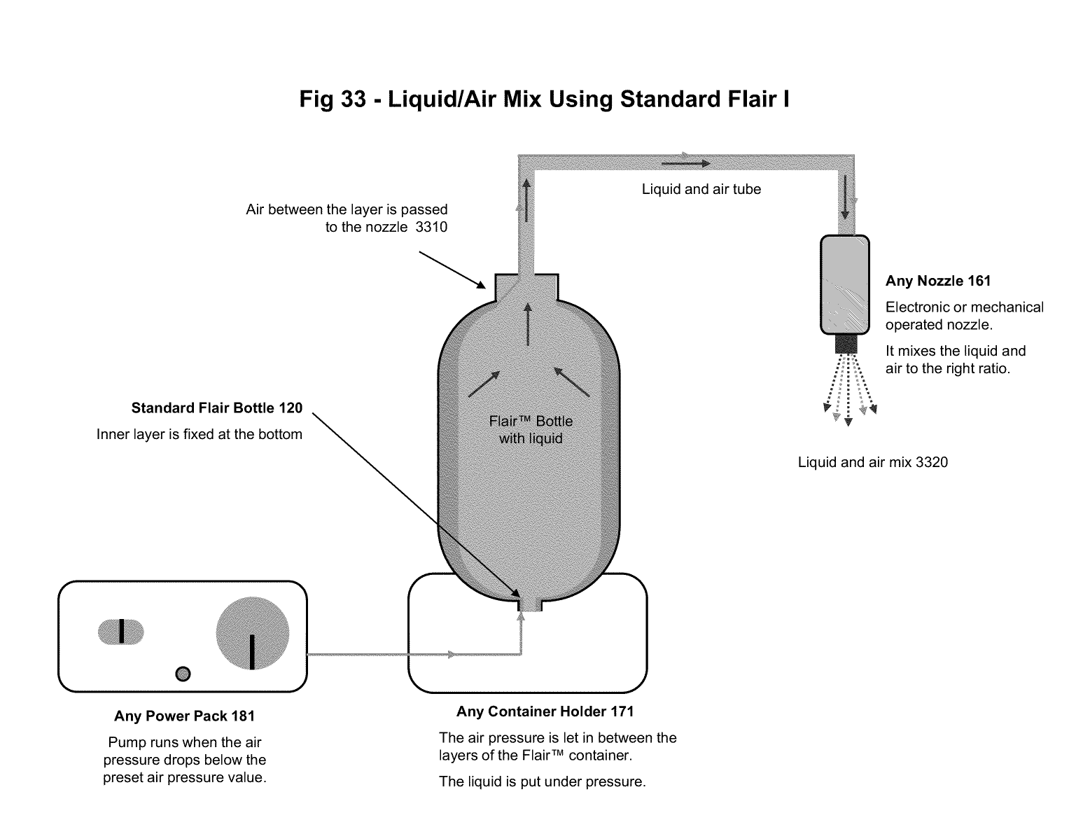

Next described are various alternate exemplary embodiments according to various exemplary embodiments of present invention with reference to FIGS. 33-41. FIG. 33 illustrates a liquid/air mix generated using a standard Flair® system. With reference thereto, a standard Flair® Bottle 120 can be used with a liquid inside to be dispensed. The liquid is indicated in violet and there is a single Flair® inner container. Between the inner container and the outer container is a displacement medium, for example, air, shown in blue. As in standard Flair® systems, the inner container is fixed to the outer container at the bottom, as described, for example, in United States Published Patent Application No. 2011/0036451 (“Liquid Dispensing Flair®”). This prevents crimping of the inner container and also allows the displacing medium to uniformly push against the inner container from the gap between the inner container and the outer container. As shown in FIG. 33, any container holder 171 can be used that connects a pressure source, such as delivered by any type of power pack 181, to the gap between the layers of the Flair® container. Additionally, there can be an air conduit between the top of the space between the inner container and the outer container where air between the layers can be passed to any type of nozzle being used 161, as shown at 3310. Thus, in such an embodiment the conduit tube from the Flair® bottle 120 to the nozzle 161 is actually a dual tube, one for liquid and one for air, and at the nozzle 161 the liquid and air can be mixed into a spray or foam. This can be done using, for example, various technologies shown in U.S. Provisional Patent Applications No. 61/456,648, filed on Nov. 10, 2010 (“Metered Dose Dispensing Flair®”), and No. 61/518,677, filed on May 9, 2011 (“Flair® Fresh”). The nozzle 161 can be any type of electronically or mechanically operated nozzle and such a nozzle can be designed to mix the liquid and air 3320 to the desired ratio for a spray, for a foam, as a function of liquid viscosity and air pressure, etc., all as provided in said patent applications, under common assignment herewith.

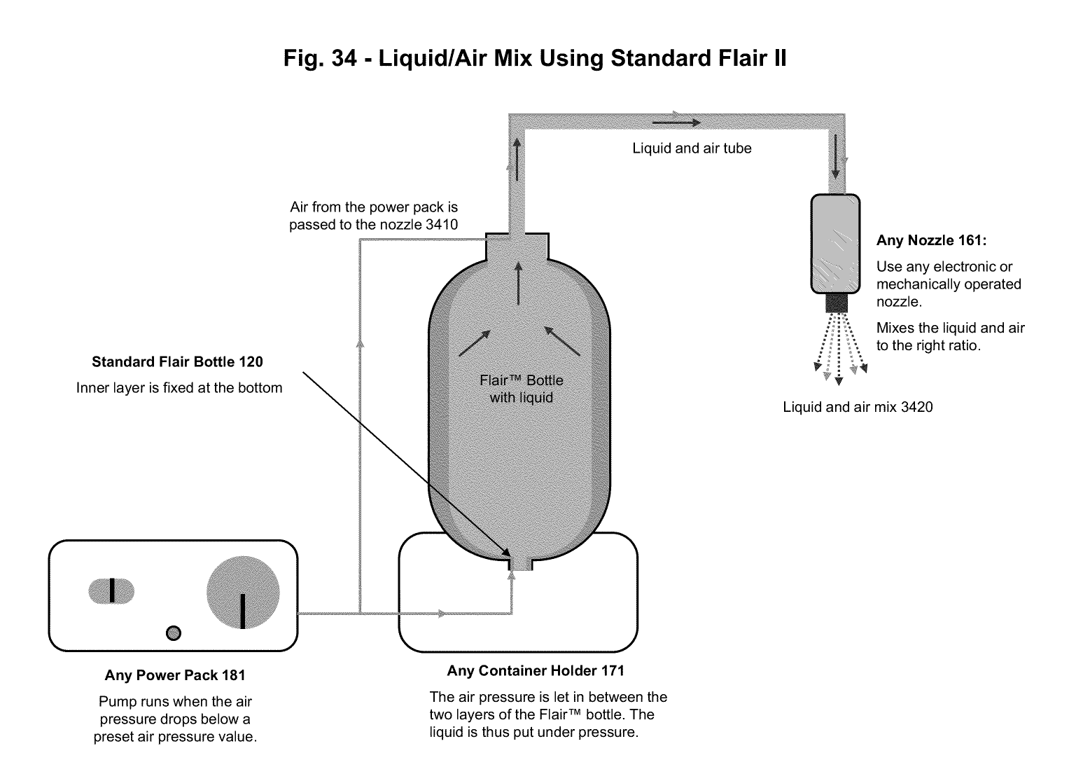

FIG. 34 shows a variation of the system as shown in FIG. 33 where everything is essentially the same as in FIG. 33 except that instead of drawing the air to be used to mix with the liquid 3420 at the nozzle 161 from the gap between the inner container and the outer container, here instead a separate air line is run from the power pack 181 to the nozzle 161 as shown at 3410. Once again, we have a standard Flair® system where there is one inner layer, one outer layer and the two are connected at the bottom of the Flair bottle, as described above. The remaining functionalities of the system of FIG. 34 are essentially the same as those of that of FIG. 33. Whether one uses a separate air line as in FIG. 34, or taps into the inter-layer space of the Flair® bottle layers as shown in FIG. 33, is in general a design choice. A separate line creates another hose to be careful of, while tapping into the inter-layer space requires running the air line through the Flair® bottle cap, which makes said cap more complex.

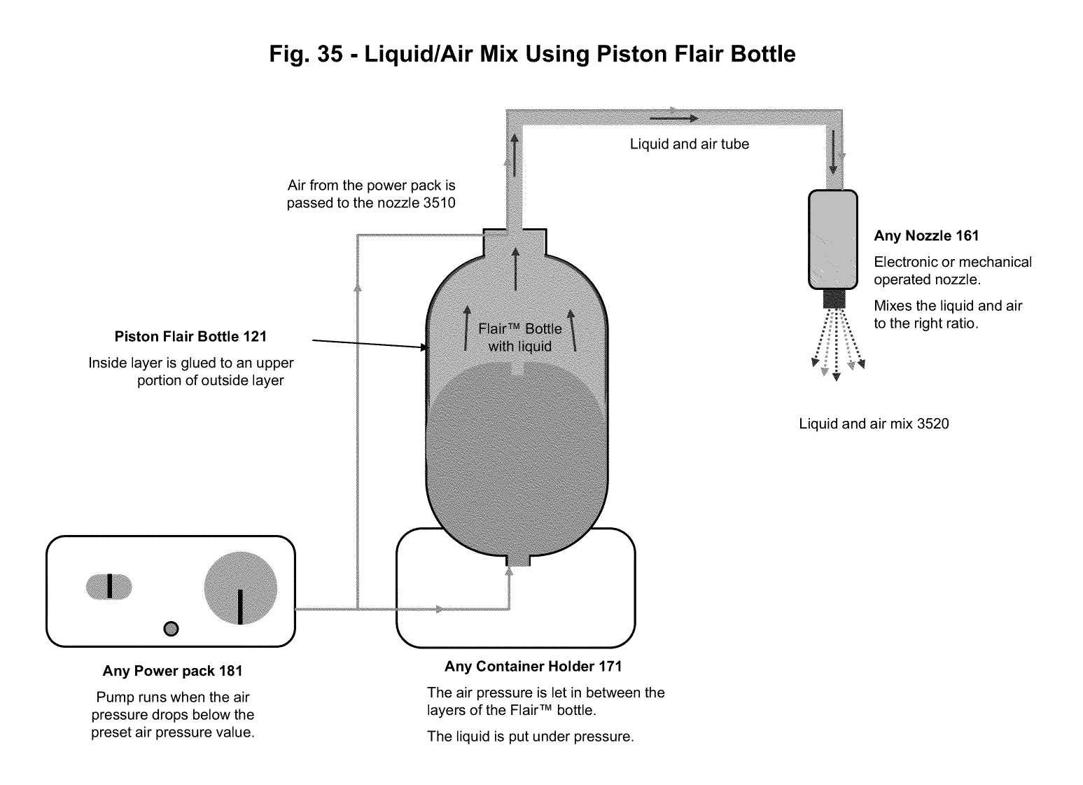

FIG. 35 shows a variation to the system of FIG. 34 where everything is the same except for the fact that instead of a conventional Flair® container, a Piston Flair® container 121 is used. Here the inner container is not connected at the bottom to the outer container, as in standard Flair®, but rather the inner container is partially glued or adhered to the upper portion of the outer container. As a result, the freely moving bottom of the inner container, moves similarly to a piston and ultimately folds on itself, squeezing the last bit of the liquid (shown in violet) outside the top of the Flair® container. Besides the Piston Flair® functionality, the operation of the system shown in FIG. 35 is the same as that shown in FIG. 34.

### Use of Multi-Layer Flair® to Dispense Multiple Products

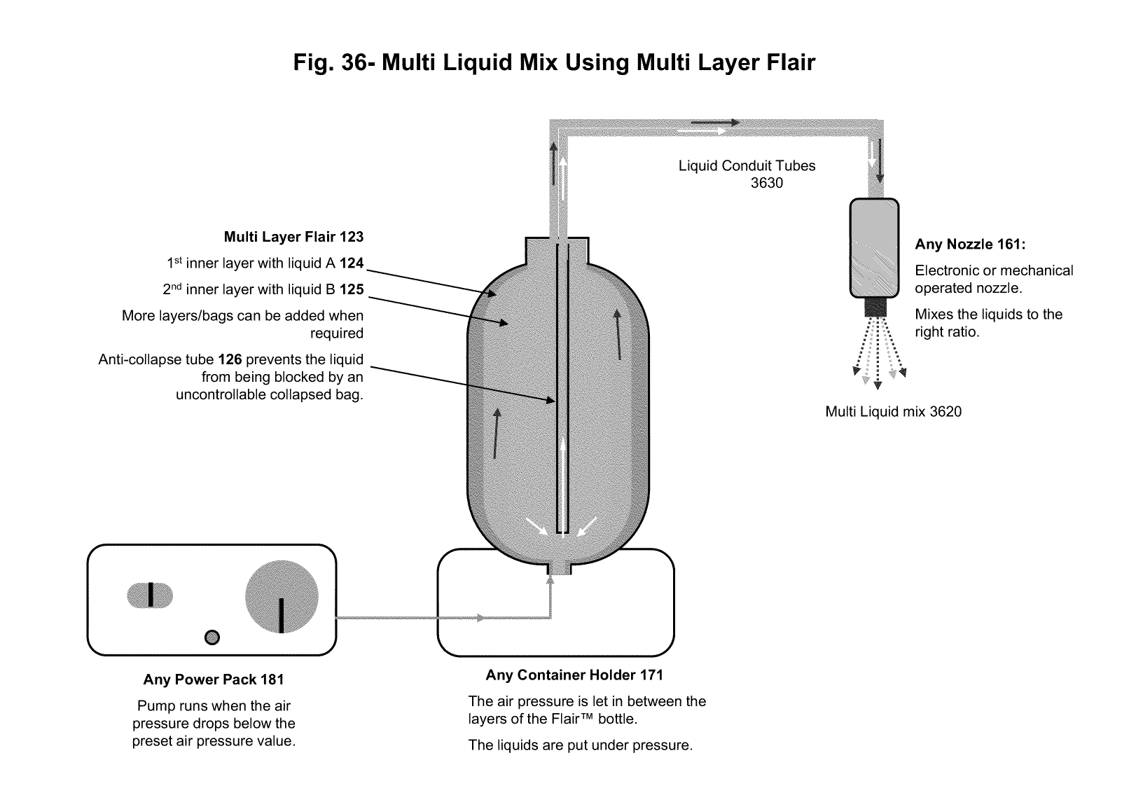

FIG. 36 shows yet an additional variation according to exemplary embodiments of the present invention where a Multi-Layer Flair® bottle is used as the source of the products to be dispensed. Multi Layer Flair®, also known as Multi Liquid Flair®, involves a nesting of Flair® containers, as noted above. Instead of having just one inner container, there is an outer container and multiple inner containers provided within it. As shown in FIG. 36, for example, there are two inner containers, but the Multi Layer Flair® concept can easily be extended to even more than two layers, including three or more. With reference to FIG. 36, a Multi Layer Flair® Container 123 contains a first inner layer with Liquid A (shown in violet) 124, a second inner layer with Liquid B (shown in yellow) 125 and then an anti-collapse tube 126 which prevents the liquid from being blocked by an uncontrollable collapsed bag, as described above. The first inner layer with Liquid A 124 is shown in violet, and the second inner layer with Liquid B 125 shown in yellow is nested wholly within it. The second inner layer 125 is therefore coaxial with and wholly contained inside first inner layer 124. As the pressure supplied by power pack 181 is raised to the preset value, pressurizing the liquids in the Multi Layer Flair® Container, pressure is passed from the gap between the outer container and the first inner container to the liquid in the first inner container and that pressure is passed, in turn, to the second inner container with Liquid B. This results in both Liquid A and Liquid B being pushed out of Flair® Container 123, through the liquid conduit tubes 3630 and into a nozzle 161. At the nozzle 161, which can be electronically, mechanically, or electromechanically operated, the two liquids are mixed in a desired ratio, resulting in a multi-liquid mix 3620. This can be used for various types of paints or stain applications, as well as innumerable instances where two liquids, such as, for example, components of a glue or components of certain kind of solvent, or lubricant, or even a beverage, condiment or foodstuff, for example, need to be mixed at dispensing time, but not before, into a proper ratio.

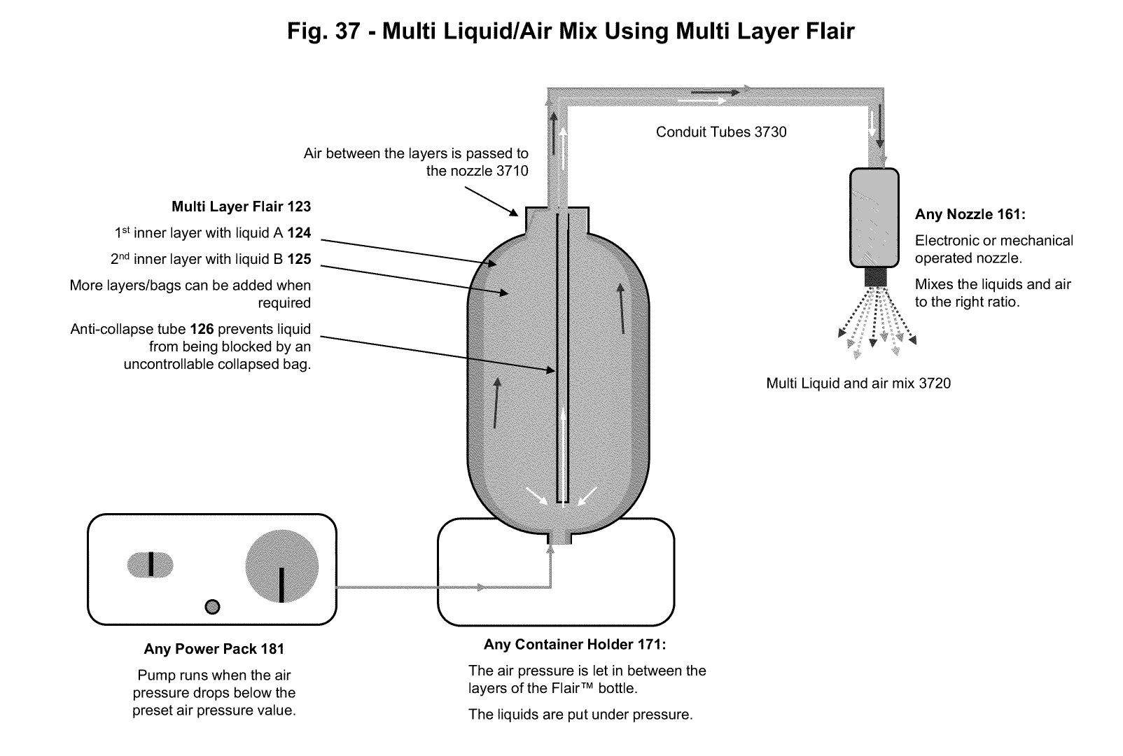

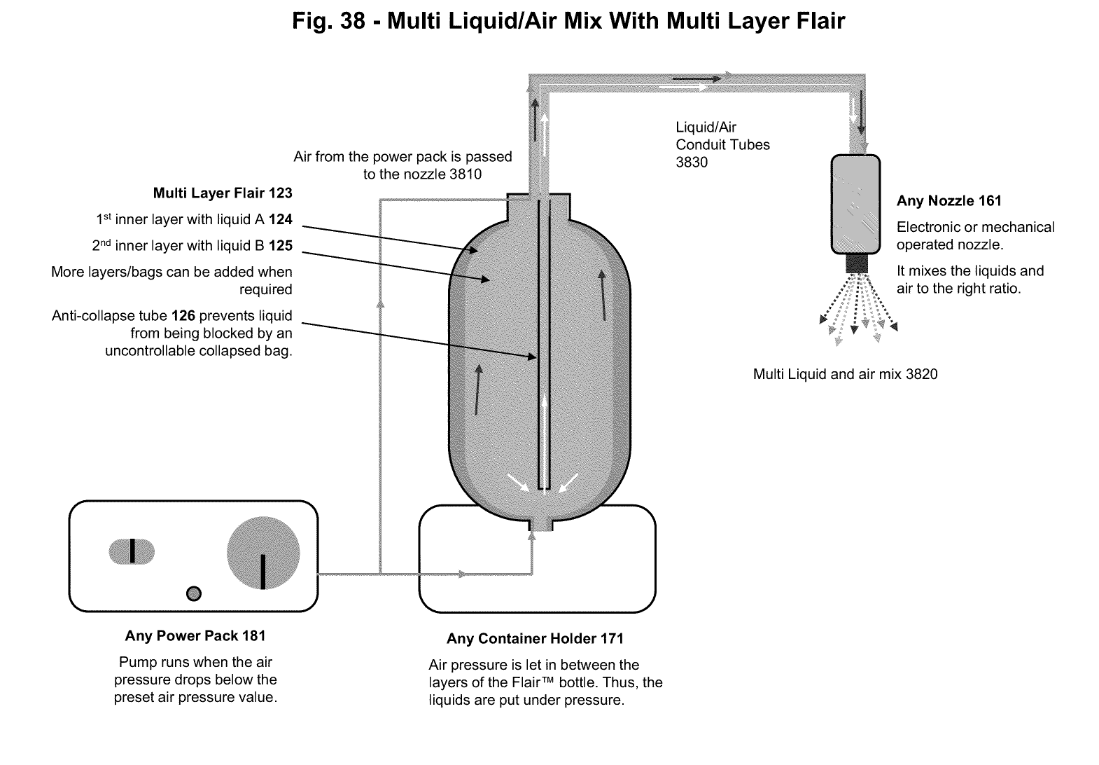

FIG. 37 depicts an exemplary system that combines the Multi-Layer functionalities of FIG. 36 with the liquid/air mix techniques shown in FIGS. 34 and 35. With reference to FIG. 37 there is the Multi Layer Flair® Bottle 123 with the first inner layer 124 with liquid A, the second inner layer 125 with Liquid B, and the anti-collapse tube 126. Here the air is supplied by any power pack 181 through any container holder 171 and such container holder 171 holds the Multi Layer Flair® Bottle 123. The air present in the gap between the first inner container 124 and the outer container of the Multi Layer Flair® Bottle can be used to pass to nozzle 161, via passage 3710. Thus, exiting the Multi Layer Flair® Bottle 123 are three conduit tubes 3730, being the tubes for the two liquids shown (and this will be for more than two liquids if more than two layers are used) and a displacement medium or gas conduit tube, in this case air, all connected to a nozzle 161, and mixed to create a multi liquid and air mix 3720, such as a multi liquid foam, or spray, or the like. Similarly, FIG. 38 depicts the exact same system except that here (as in FIGS. 34-35) the source of the air which is sent to the nozzle is not a by-pass conduit 3710 as shown in FIG. 37 but a separate air line 3810 running from power pack 181 as shown in FIG. 34 and FIG. 35. Here as well, three sub-conduits 3830 are sent to nozzle 161 which mixes the multiple liquid layers and the air into a desired mix at dispensing time.

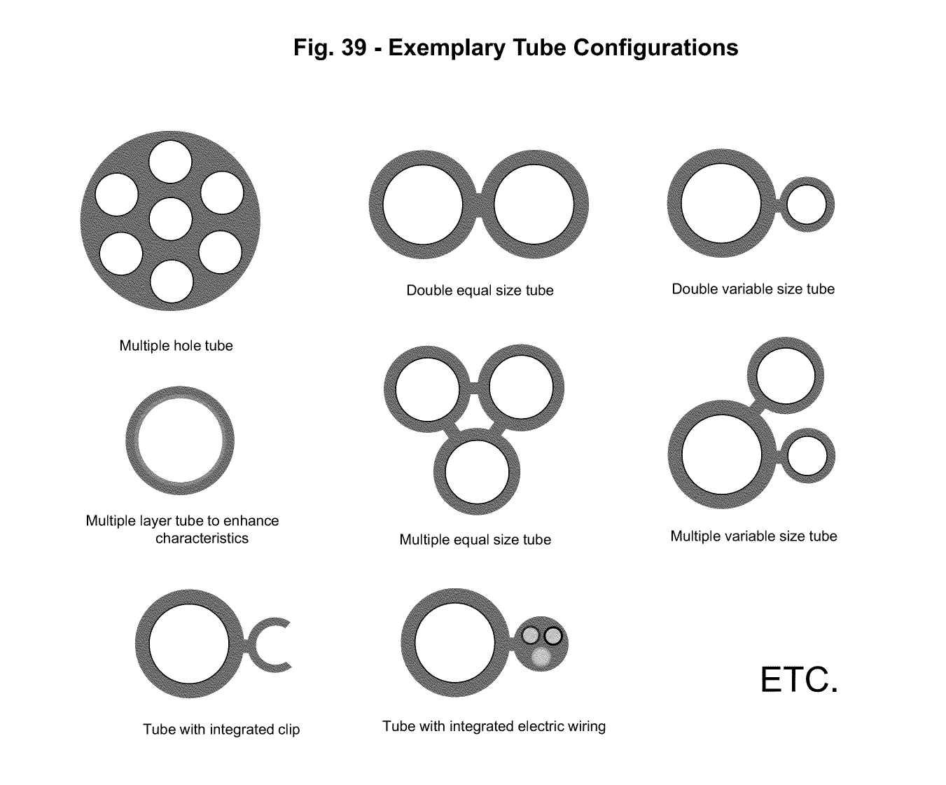

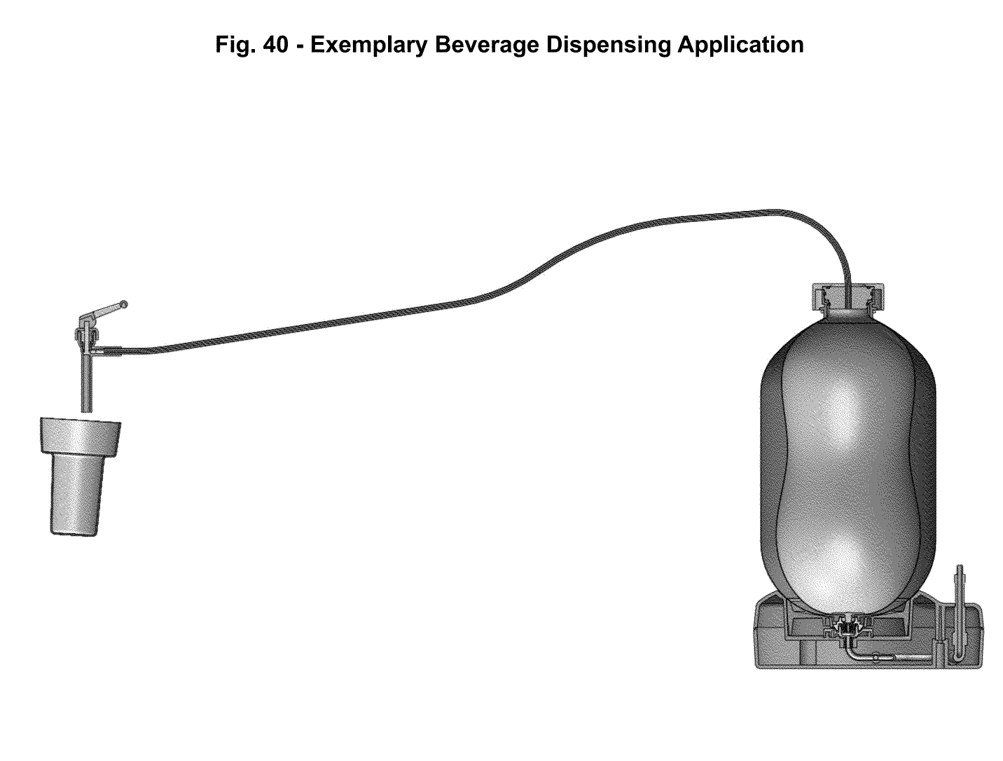

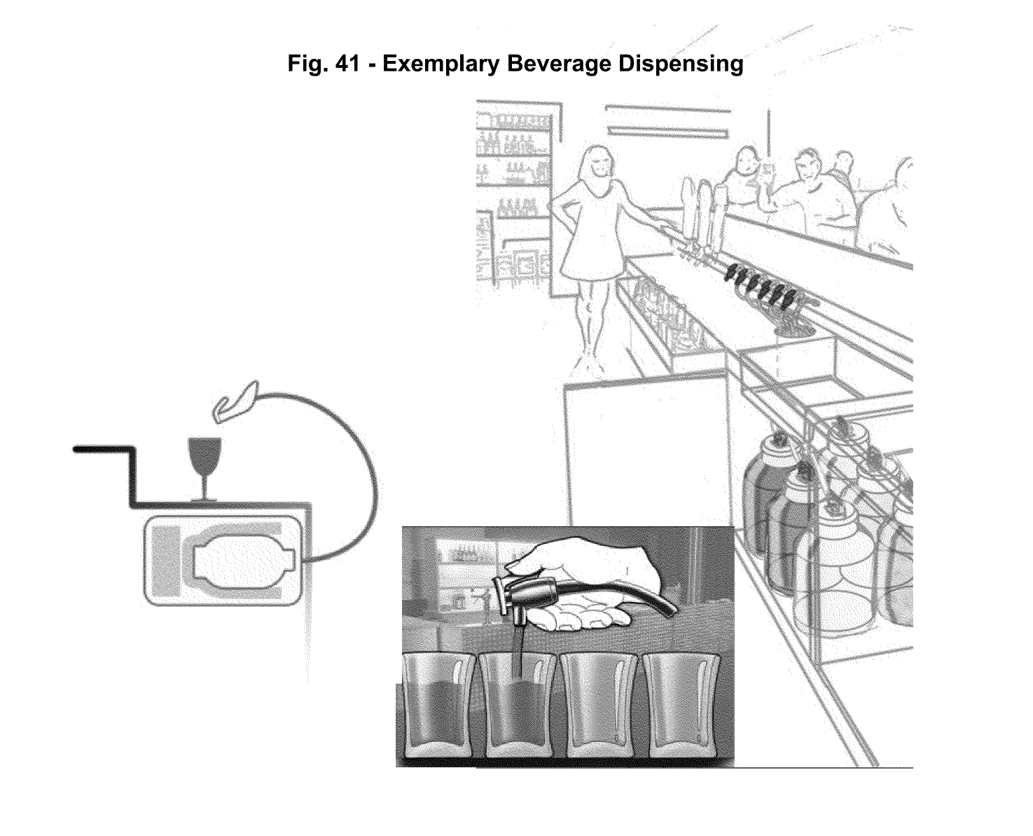

FIG. 39 shows various exemplary tube configurations which can be used in single tube, double tube or multiple tube applications. Also shown are tubes with integrated electric wiring which can be used to connect, for example, the nozzle or paint brush or like with the pinch valve in a hard wired connection, as described above. It is particularly noted that the multiple hole tube shown in the upper left image of FIG. 38 can be used in exemplary beverage dispensing application illustrated in FIGS. 40 and 41. It can be used to slow down the flow of a liquid. The center right image has a barrier inside it, which can be an oxygen barrier, a light barrier, or a solvent barrier when dispensing an active or aromatic liquid.

With reference to the multiple hole tube, it is noted that this is a system very similar to that described in U.S. Provisional Patent Application No. 61/456,933 (Multiple Canal Beverage Tubes) is depicted. In such a beverage dispensing application, a standard Flair® Container as shown in the example of FIG. 40 can be used. Such a container can be very similar to that shown in FIG. 3A, and can be filled with a beverage, such as for example, beer. The beverage can be dispensed by means of a container holder which is connected to an air source. For example, the air source can be a pump which is manually operated by human hand or foot, or can be a Power pack such as shown, for example, in the various exemplary embodiments described above. The beer is sent through a multiple hole tube such as shown in the upper left panel of FIG. 39 for the reasons described in said Multiple Canal Beverage Tubes patent application, including, for example, slowing down the flow of a higher temperature beverage so as to maintain laminar flow and better control.

Finally, a system as shown in FIG. 41 can be exactly the same type of system as shown in FIGS. 2-4 except that instead of dispensing paint we now dispense beverages. Accordingly, the nozzle shown schematically would not be a nozzle at all but it would be a capacitively controlled handle adapted to beverage dispensing. Thus, as shown in FIG. 41, a set of small, convenient, self contained dispensing devices can be used, with pre-filled bottles having various beverages, e.g., beers and sodas, and such a set of dispensing devices can replace the cumbersome carbonated beverage systems now in use.

### Exemplary Harness System and Dispensing Gun

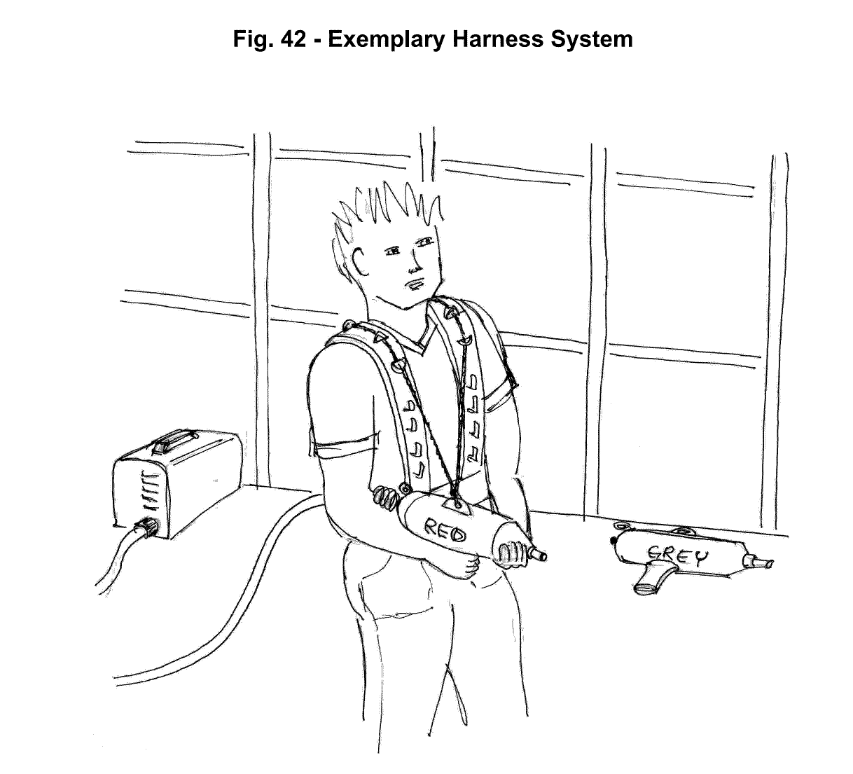

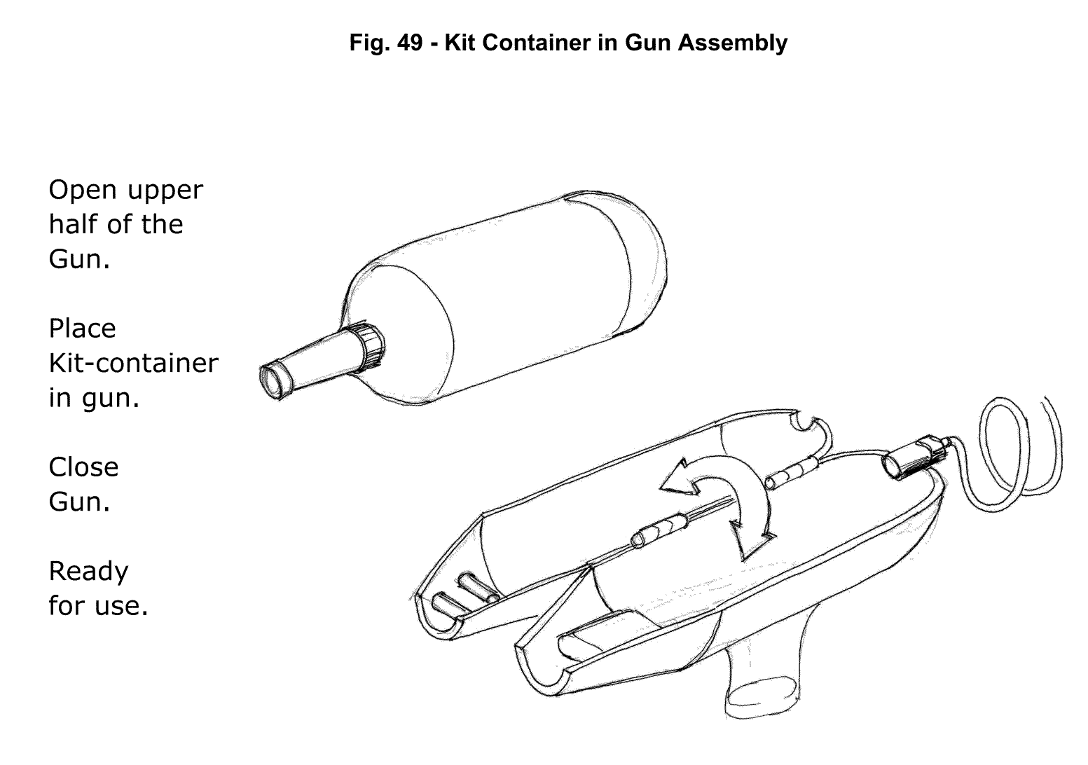

FIGS. 42-50 illustrate an alternate exemplary embodiment of the present invention using a harness system to assist in supporting the weight of an exemplary “dispensing gun.” The exemplary harness system can be used with such “dispensing gun” or, for example, with various alternate exemplary embodiments of the present invention, as next described.

With reference to FIG. 42, a variant to the Paint Flair® system described and illustrated above is shown. Here, the pump section of the power pack is separated from the liquid delivery system and placed on the floor in more or less in a stationary position. Connecting the power pack to the liquid delivery system is a long tube similar to those that carry compressed air at construction job sites. The compressed air tube inputs to a gun, as shown a paint gun, and the gun contains a Flair® bottle with a prefilled color of paint, as described above. The gun is, as before, supported mostly by the shoulders, torso and legs of a user, except that here the Flair® bottle is not worn, but is held in the gun, the weight of which is supported by a harness. As can be seen in the background of the illustration, there is another gun which has a cartridge in it of grey colored paint and the individual is holding a red paint cartridge.

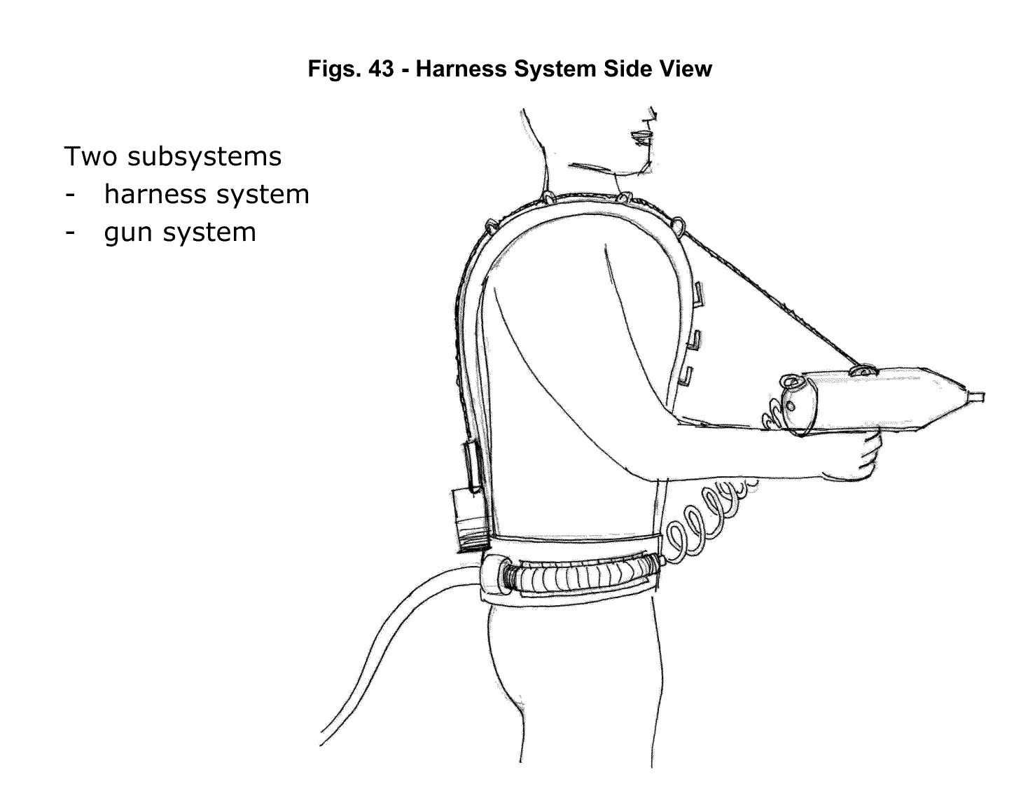

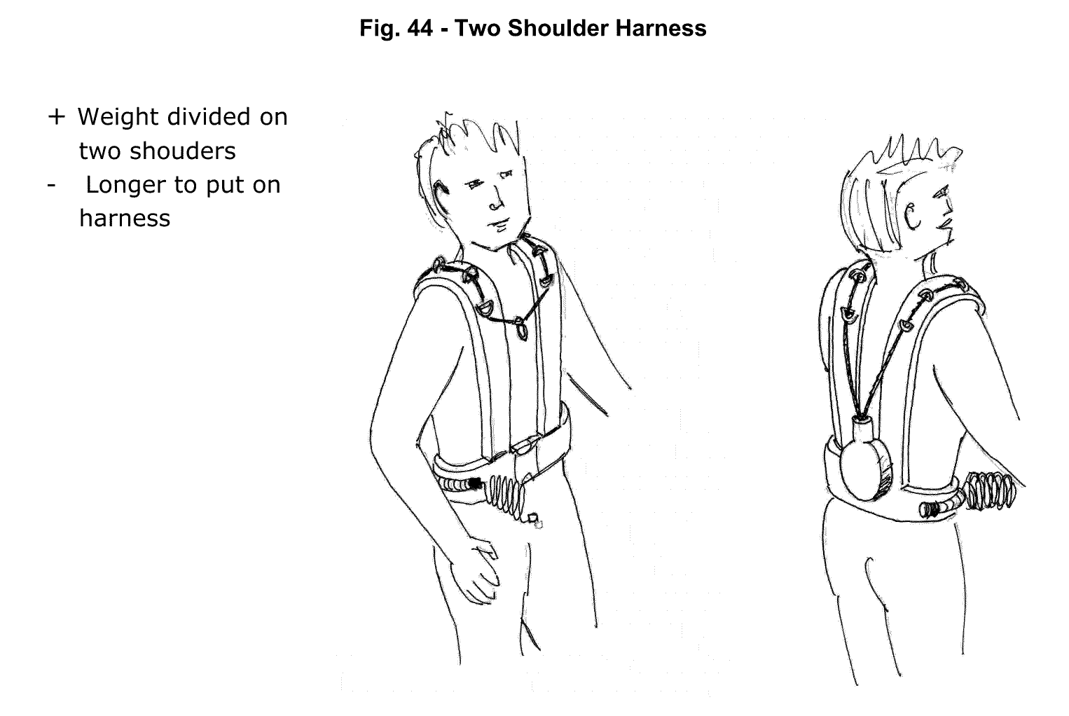

FIGS. 43 and 44 illustrate side and prospective views of two alternate versions of the exemplary harness system of FIG. 42. FIG. 43 presents a side view of the harness system which essentially has two subsystems. The harness system itself, which is used to support the weight of the gun, and the gun system which is used to dispense the liquid. As can be seen the tube or hose connecting the stationary (or moveable on wheels) pump to the gun and at first connects to a slot on the waist band, or waist belt, of the harness and then it is sized down to a small coiled flexible tube which inputs to the back of the gun itself.

FIG. 44 shows an exemplary two shoulder harness version. The benefits of the two-shoulder harness are that the weight is divided on both shoulders of a user, and the cost or negative of this is that it takes slightly longer to put on the harness. As shown in the right panel of FIG. 44, at the back of the harness is a spring loaded cord holder or reel which pulls on the gun and supports it at whatever height the user decides to hold it.

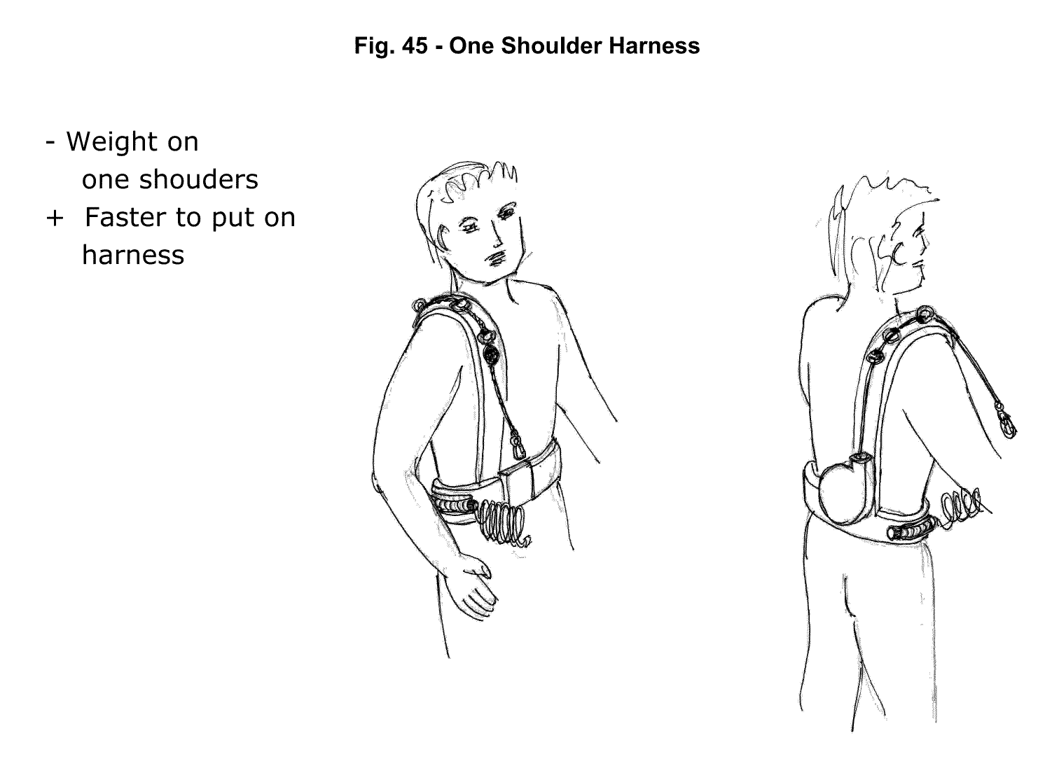

Similarly, FIG. 45 shows a one shoulder harness version of the exemplary harness of FIG. 43. Here the weight is only on one shoulder which may be a slight negative to some users; however, the positive feature is that it is faster to put on and remove the harness. The reel as shown on the right panel, and the connection to the stationary pump, are the same.

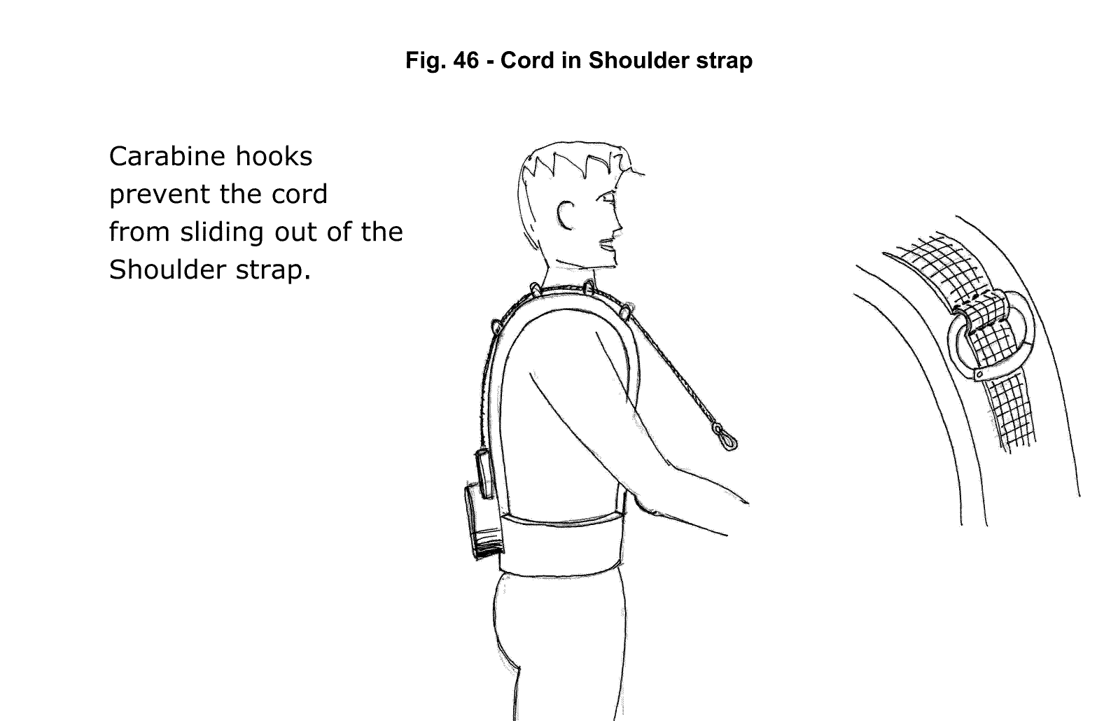

FIG. 46 shows details of how the reel cord is held in the shoulder strap by virtue of carabine hooks. These prevent the cord from sliding out of the shoulder strap, for example.

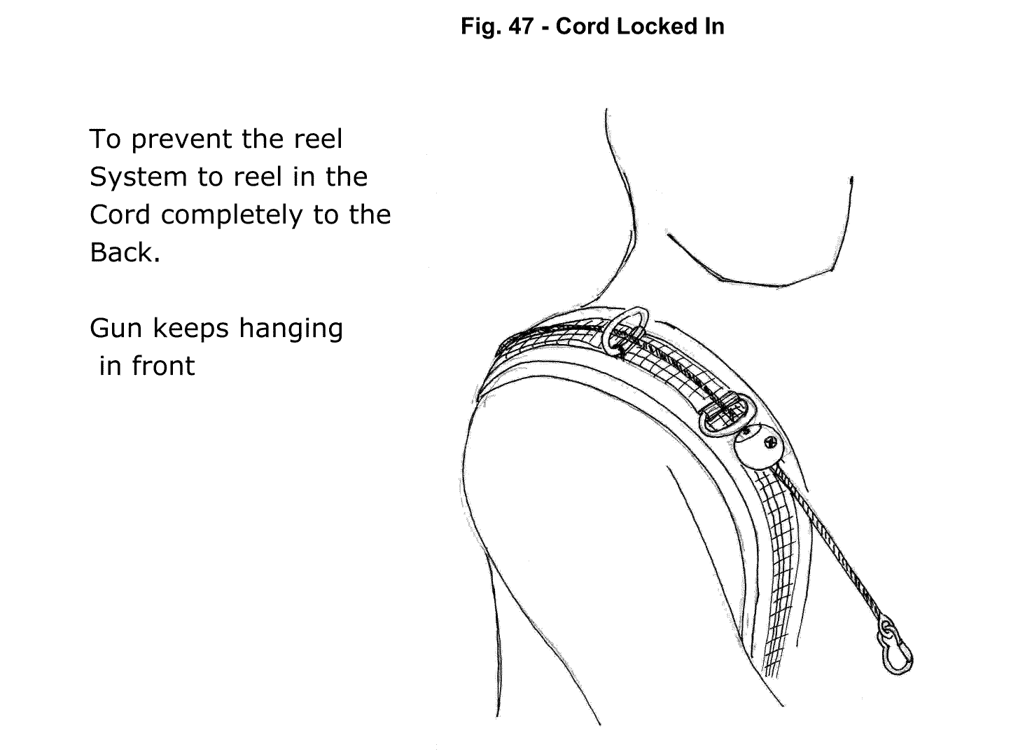

FIG. 47 shows a locking device at the forward edge of the cord some distance from the hook by which it hooks into the gun and this stopping cord and the locking mechanism is done to prevent the reel system from completely and fully reeling the cord to the back of the user. This keeps the gun hanging from the front of a user.

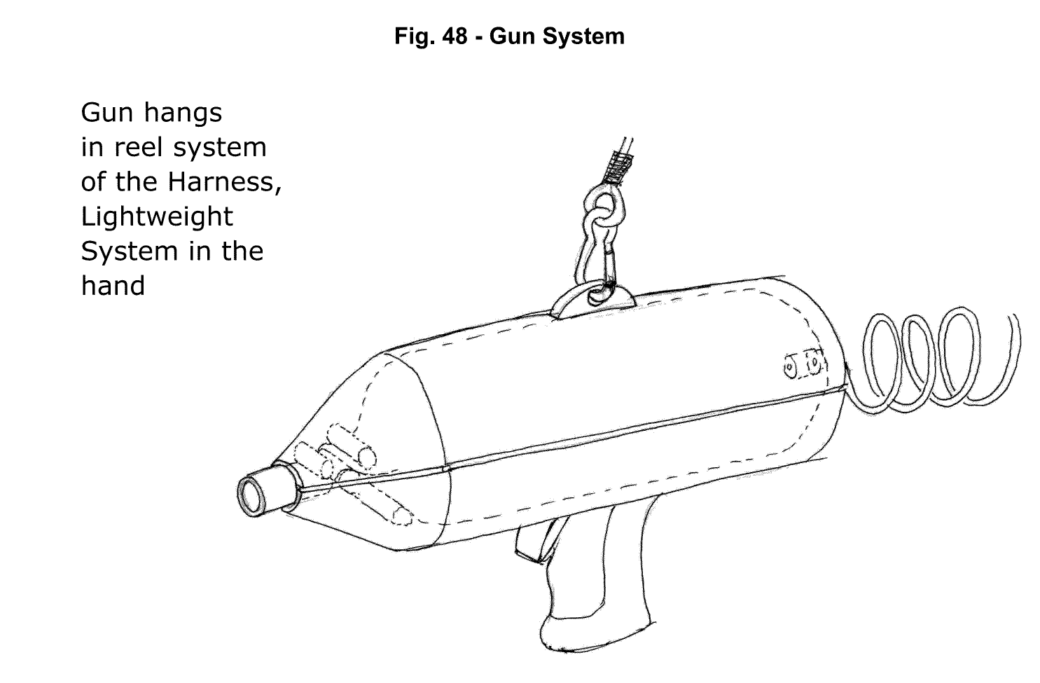

FIGS. 48-50 provide details of the liquid delivery gun system. As mentioned this is similar to the Flair® bottle or Flair® container held in a container holder as describe and illustrated above except for the fact that the gun system of FIGS. 42 to 50, and in particular FIGS. 48 to 50, provides the bottle with the liquid to be dispensed to be held by the user's hands, albeit supported by his body, and the Flair® bottle is maintained in essentially a horizontal position. As shown in FIG. 48, the gun hangs in the reel system of the harness, therefore the effective weight of the gun in the user's hand is considerably lighter.

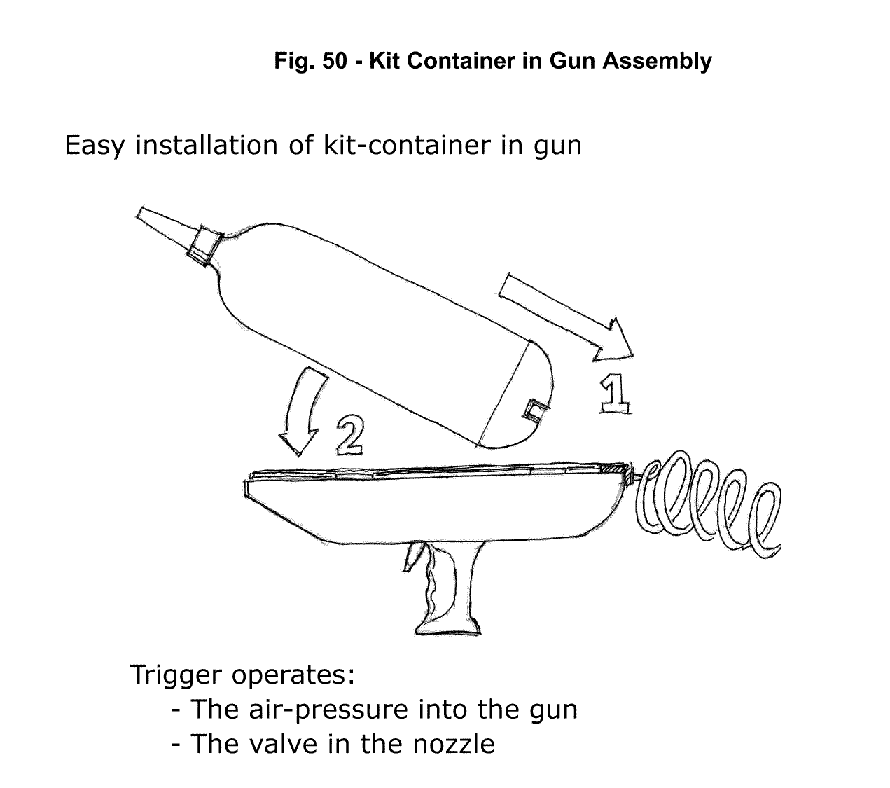

FIG. 48 illustrates placing a Flair® container in the gun assembly. This can be accomplished by opening the gun, which has a top half and a bottom half that are hinged. The user opens the upper half of the gun, places the Flair® bottle into the gun and closes the dispensing gun, thus making it ready for use. It is noted that at the back of the gun, there is an air pressure or displacing medium input which mates with a similar valve on the bottom of the Flair® container as shown in FIG. 50.

With reference to FIG. 50, the easy installation of the Flair® container in the gun as shown in the two steps are (i) the valve which mates with the air pressure inlet at the back of the gun is first slid over that inlet, and then (ii) the entire bottle is swiveled downward such that the nozzle fits in the nozzle holder at the distal portion of the gun. It is noted that an exemplary trigger operates to do two things. First, it allows air pressure into the back of the Flair® bottle which allows the liquid to be dispensed, and also controls the valve in the nozzle.

It is noted in general, that as here in FIG. 50, a valve can be provided either at the top of a Flair® bottle, as shown in the FIGS. 1-38, or at the nozzle or dispensing end, as shown here and in FIGS. 40-41. Either possibility can be used as appropriate in given contexts.

### Exemplary Suction Device—Dispensing a Liquid in Reverse

In alternate exemplary embodiments of the present invention, instead of dispensing a liquid, a Flair® type bottle with the pressure and pump operating in reverse can be used to suck up a liquid, such as for example, in clean up and disposal of bio-contaminated, or other contaminated or waste liquids.

In such exemplary embodiments, a given liquid is already contaminated, and needs to be collected in a clean way, where the liquid is isolated or separated from the outside environment. Such a system is similar to a dispensing system. In fact, both are essentially the same: a Flair® bottle with a nozzle connected via a flexible hose. With this nozzle you can reach every point on a surface or location, when desired, with the right amount of content on the right place, or its opposite, sucking up the content as desired.

For suction uses the Flair® container isolates the contaminated liquid once it is in the container, and it can easily be discarded thereafter. In such suction embodiments, a vacuum nozzle is used instead of the regular nozzles described above. For suction a flow is needed. One starts with the bag completely inside, and a little bit of overpressure between the Flair® layers. The bag collapses completely inside the Flair® container. Then you bring under pressure between the layers and suck the inner container against the inside of the outer container. A small valve can then be provided in the front of the nozzle as well. Additionally, it is necessary to suck back all drops from inside the conduit tube if the liquid is contaminated or a biohazard. It is not desired to have bacteria, mold or fungus, for example, growing in the 2M or other conduit tube. Also we do not want to have to take apart and clean after every use. For this reason a second valve can be provided in the front. Additionally, one can make the nozzle empty by using air pressure and thus clean the conduit or tube with air, to keep the liquid being suctioned only in the Flair® container.

### Exemplary Preforms for Multi-Layer Flair® Bottle

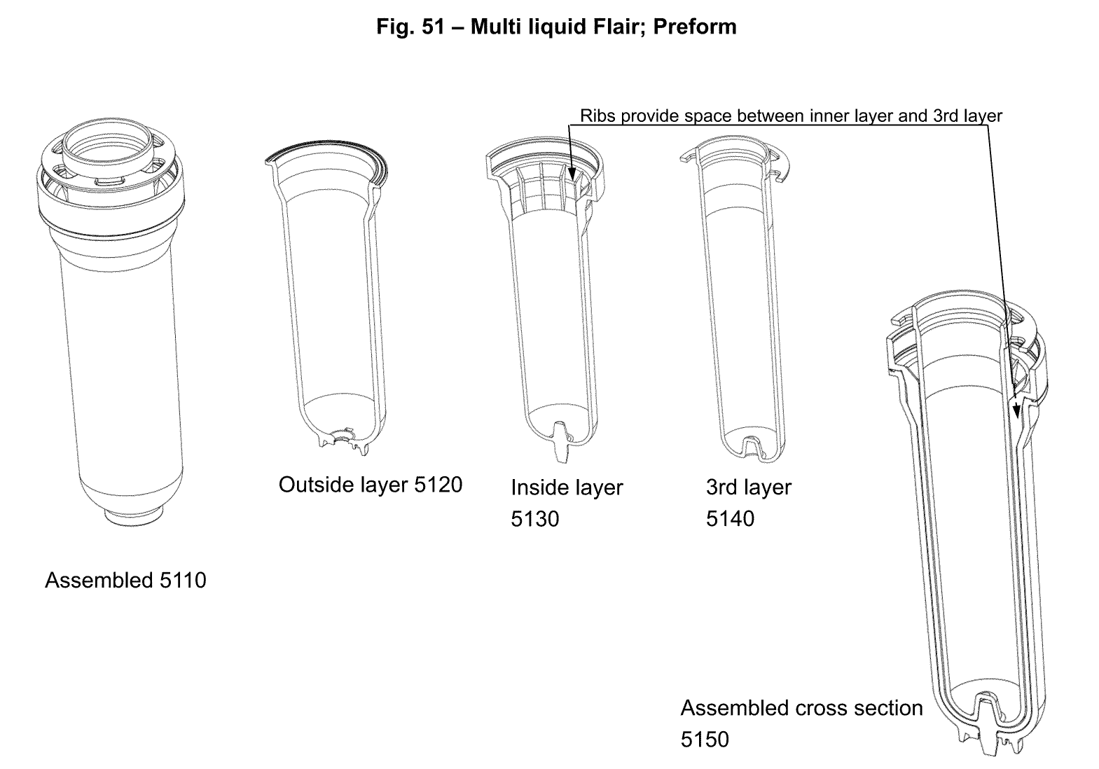

As noted above, in exemplary embodiments of the present invention two or more liquids may be dispensed from the same device. This technology is based upon a novel Multi-Layer Flair© bottle, as shown in FIGS. 36-38. FIGS. 51-62, next described, illustrate various exemplary performs, as well as methods of assembly, for the Multi Layer Flair© bottle described above, which may, for example, be used to dispense two or more separate liquids, or separate components of a compound liquid, according to exemplary embodiments of the present invention. For example, there are many liquids that combine to produce a final paint, glue or adhesive, polish, lubricant or the like, for example. It is often required, or greatly preferred, that these components not be mixed until just before use. This may be due to the chemical interaction between them, or to prevent exposure of one component to atmospheric air, because the combined product degrades or changes in some way when stored, or offgasses and must be used in a ventilated environment, or various other reasons.

FIG. 51 shows exemplary views of the component layers of such a preform. There is shown it as fully assembled 5110, an outside layer 5120, an inside layer 5130, and a third layer 5140. Inside layer 5130 has a doubly protruding pin at its bottom, for attachment to each of the outside layer and the inside layer, as shown in the assembled cross section 5150. It is noted that in a two liquid multi-layer system, the second liquid is provided inside the third layer bag, made from third layer 5140, and the first liquid is provided between the outer surface of the third layer bag and the inner surface of the inside bag, made from inside layer 5130. Returning to FIG. 51, perform view 5150 depicts a diametral vertical cross section of assembled view 5110. It is noted that the third layer is initially molded so as to fit within the second or inside layer 5130, as described below. Various alternate attachment schemes may be used besides the two-pin option of inside layer 5130, such as, for example, a pin extending downwards only from the inside layer 5130, and another pin extending downwards form third layer 5140, which may fit inside the pin of inside layer 5130, for example.

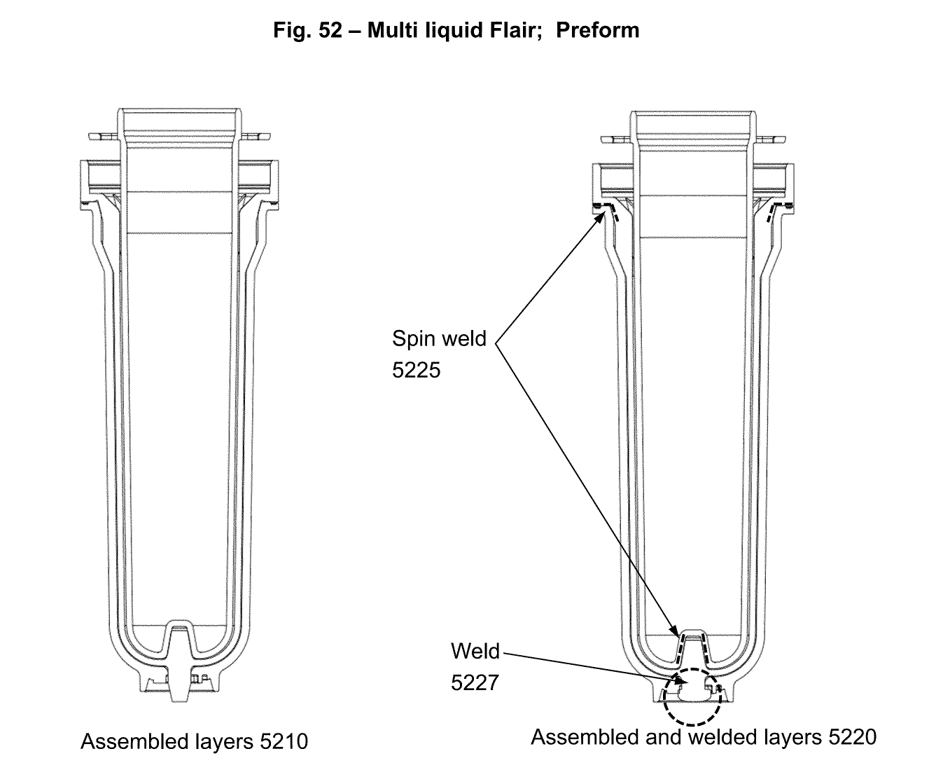

FIG. 52 depicts cross sections of the exemplary Multi Layer Flair perform of FIG. 51 as fully assembled, but before being blown to its final bottle shape, according to exemplary embodiments of the present invention. 5210 shows such assembled layers, and 5220 depicts exemplary welding techniques, where a weld 5227, for example, a mechanical compression fit type, may be used at the junction of the outside and inside layers at the bottom, and where spin welds 5225 may be used to attach both the outside and inside layers at the top (top spin weld), as well as an invagination in the bottom of the third layer to top pin protruding from the inside layer, as shown (bottom spin weld).

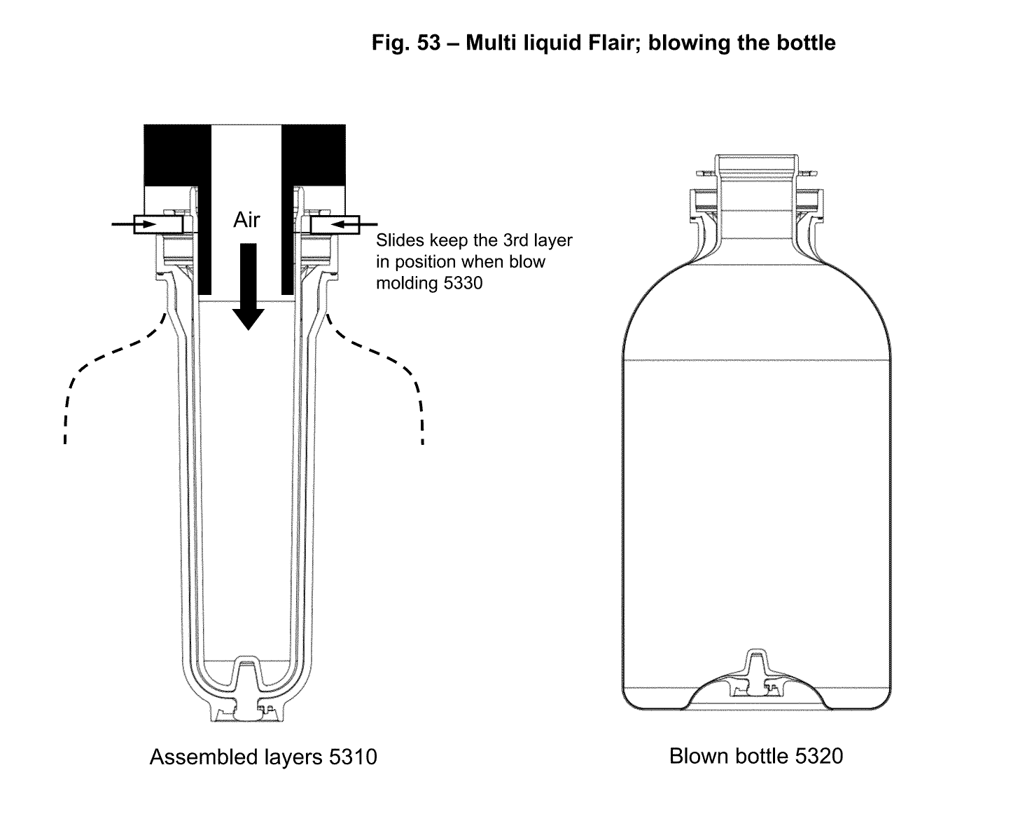

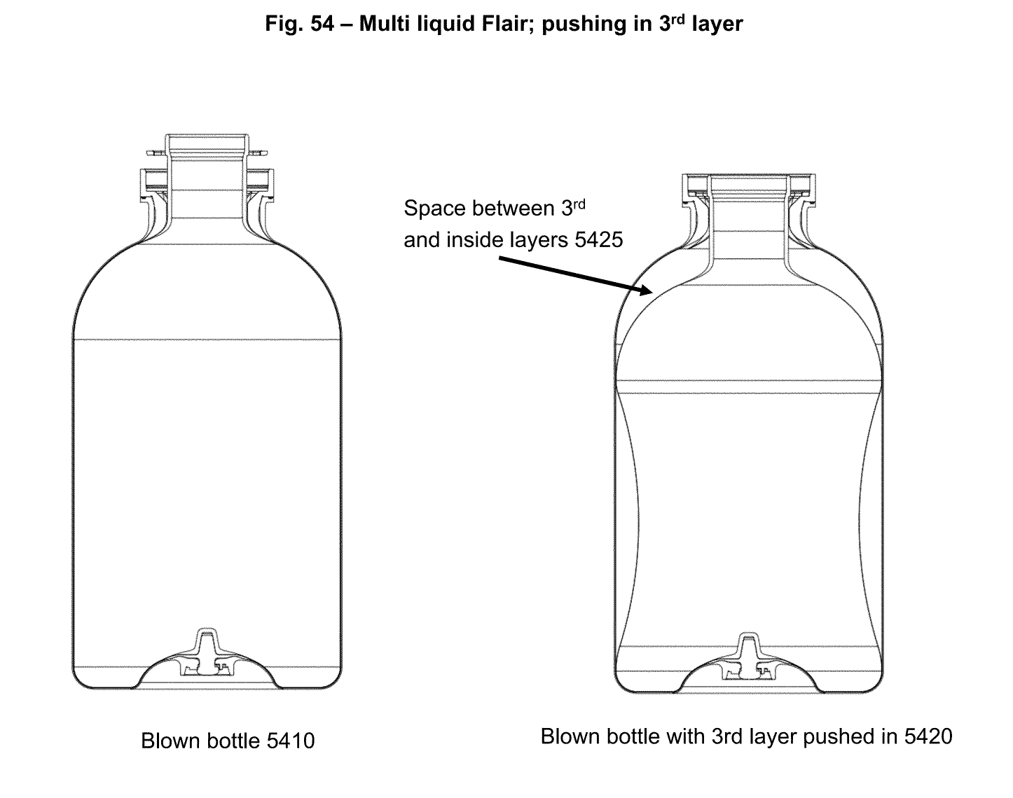

FIG. 53 depicts the exemplary Multi Layer Flair perform of FIG. 51 both as prepared for blow molding 5310, and as it looks after blowing 5320, according to exemplary embodiments of the present invention. As shown at 5330, slides keep the third layer in position (top portion elevated) when blow molding This insures that the third layer does not fall downwards during the blowing process. This is important as shown in FIG. 54.

FIG. 54 depicts the exemplary Multi-Layer Flair perform of FIG. 53 as blown to form a bottle, in each of before 5410, and after 5420, pushing down the (interior) third layer according to exemplary embodiments of the present invention. In exemplary embodiments of the present invention, forming the third layer so as to protrude vertically, maintaining its height during blowing, and then, after blowing, pushing the third layer (now a full container) down as shown at 5420 in this fashion creates a 100% sure opening in the neck. Because the neck is stiff and the bottle thus goes from stiffer to more flexible as one moves downwards along it, there is a risk that the stiff part of the bottle in the neck will block the opening if left in a position as shown in 5410. Therefore, by pressing the third layer container downwards after blowing, one can obtain an unblocked opening with essentially 100% certainty. The pushing can be done, for example, either while the bottle is cold or warm. Because the bottle neck is stiff, one can push on the neck and cause the wider part of the container to move downwards (the upper portion, or beginning of the wider part of the container is a little bit stiff, as the container transitions from rigid to flexible) and one obtains an opening for the liquid as shown in the space 5425 between the third layer and the inner layer in the blown bottle after pushing down the third layer, as shown in FIG. 54.

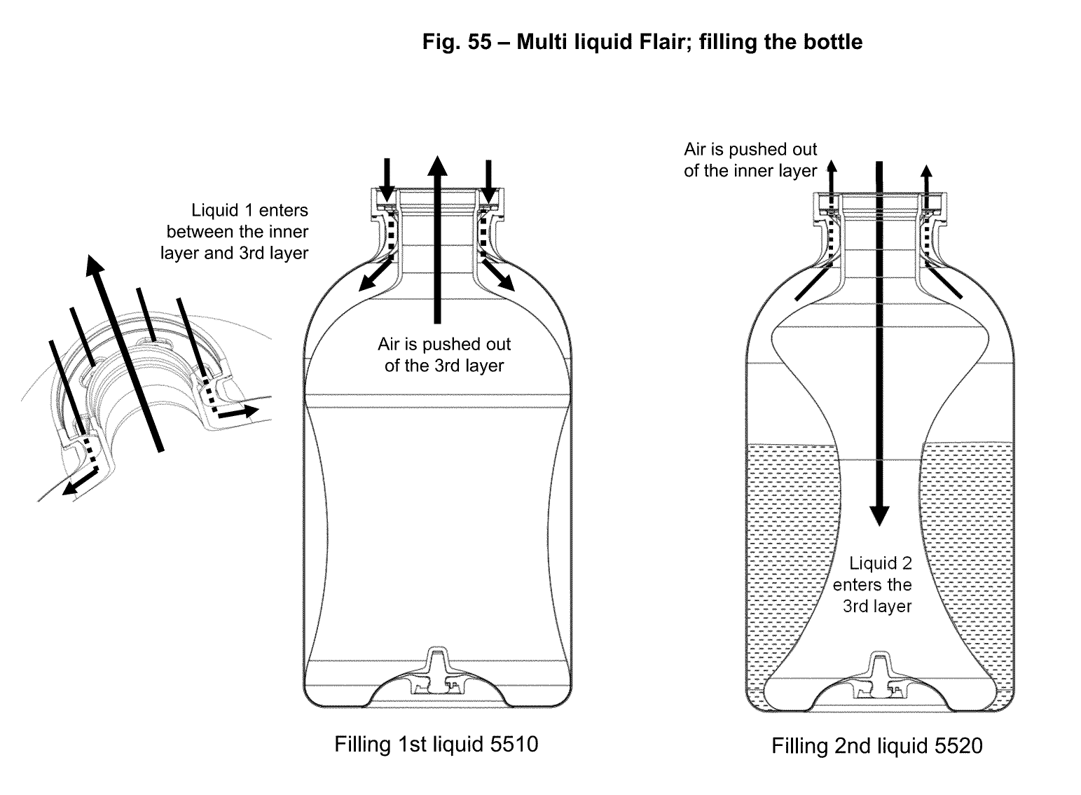

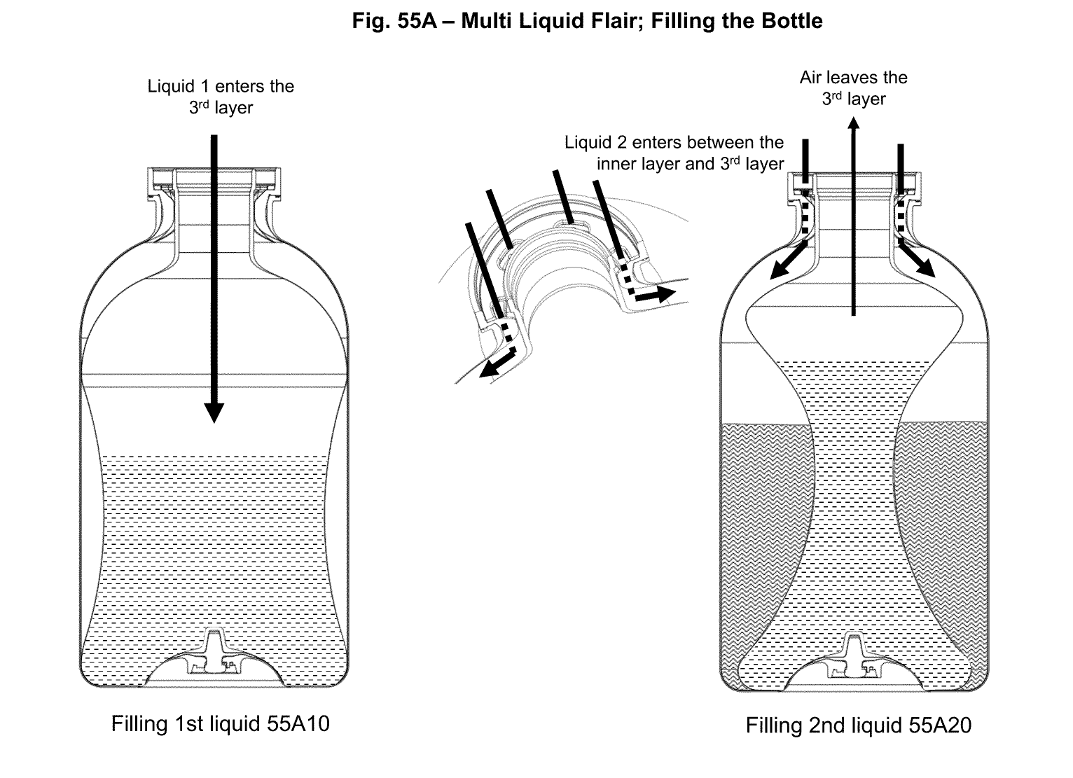

FIGS. 55 and 55A depict exemplary techniques for filling the exemplary Multi Layer Flair perform of FIG. 54 (after pushing in the third layer) according to exemplary embodiments of the present invention. With reference to FIG. 55, to fill the first (outer) liquid, Liquid 1, at 5510 Liquid 1 enters the space (created as shown in FIG. 54) between the inner layer and 3rd layer (shown by the pairs of downwards pointing arrows), and air is pushed out of the 3rd layer (shown by central upward pointing arrow). Then, to fill Liquid 2, as shown in 5520, Liquid 2 enters the 3rd layer, and air is pushed out of the inner layer, as shown. Alternatively, the inverse of the steps shown in FIG. 55 may be performed, and this is illustrated, for example, in FIG. 55A. With reference thereto, at 55A10 the first liquid, Liquid 1, enters the space within the interior of the 3rd layer, as shown by the central arrow. As in FIG. 55, this liquid is not filled all the way, leaving a headspace in the interior of the 3rd layer. Following this filling step, at 55A20 Liquid 2 is introduced between the inner layer and the third layer, as shown, and air (the headspace in the third container) leaves the third layer of the bottle.

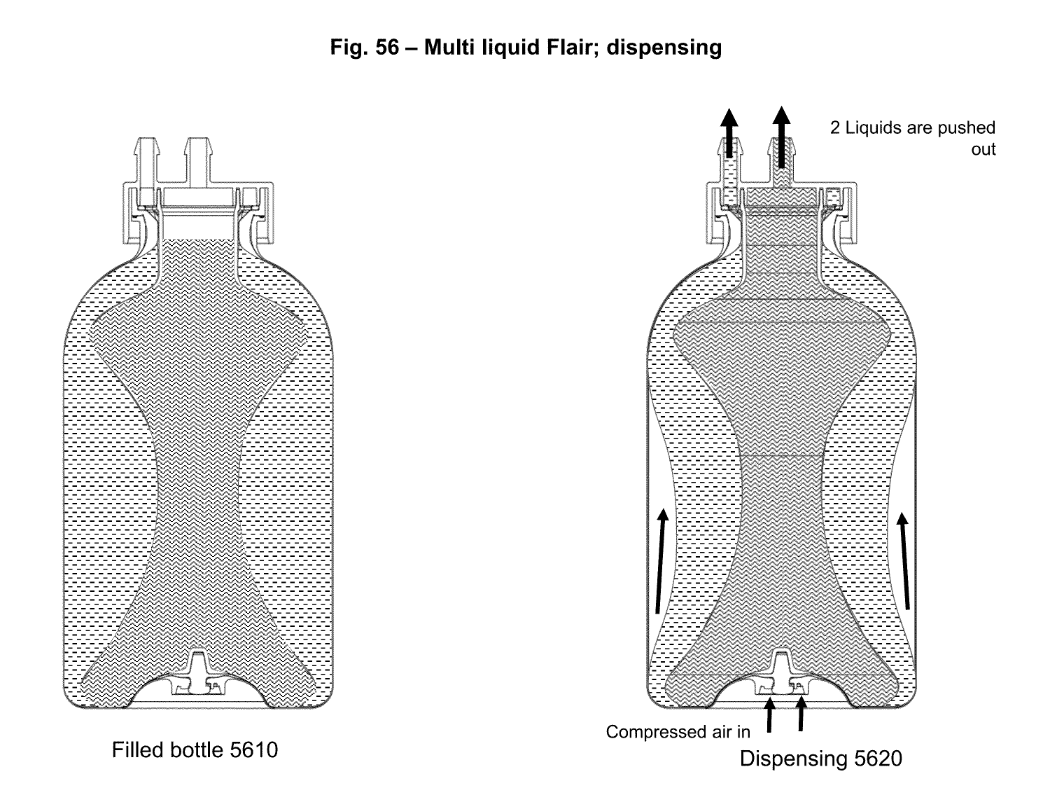

An exemplary finished and filled bottle is shown in FIG. 56. With reference thereto, 5610 depicts the exemplary Multi-Layer Flair perform of FIG. 55 as filled with two liquids, and 5620 illustrates how these two liquids may then be dispensed according to exemplary embodiments of the present invention. Such dispensing occurs as compressed air enters the bottom of the Multi-Layer Flair bottle and pressurizes the space between the outside layer and the inner layer, which then pushes, for example, Liquid 1 (outer portion of bottle) and Liquid 2 (central portion of bottle) out of the top of the bottle as shown. Alternatively, dispensing may occur using an underpressure, where the liquid is sucked out of the bottle. In such case, an underpressure generated within the container from the liquid being sucked out then causes atmospheric air to enter between the outside layer and inside layer. In other words, in such an alternate exemplary dispensing process, the space is then used for venting to the atmosphere as opposed to receiving a pressurized displacement medium form a pump, or the like.

It is noted regarding FIG. 55 that if the bottle of FIG. 55A were used, the positions of the two liquids, i.e., Liquid 1 and Liquid 2, would obviously be reversed.

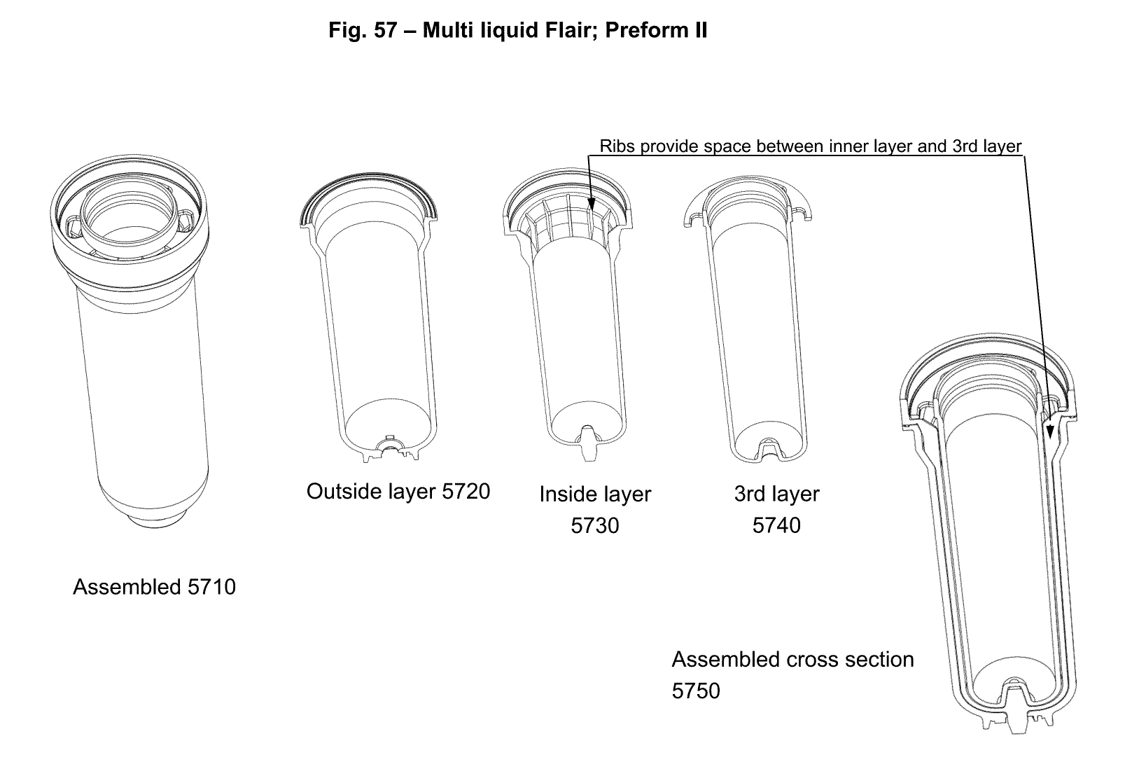

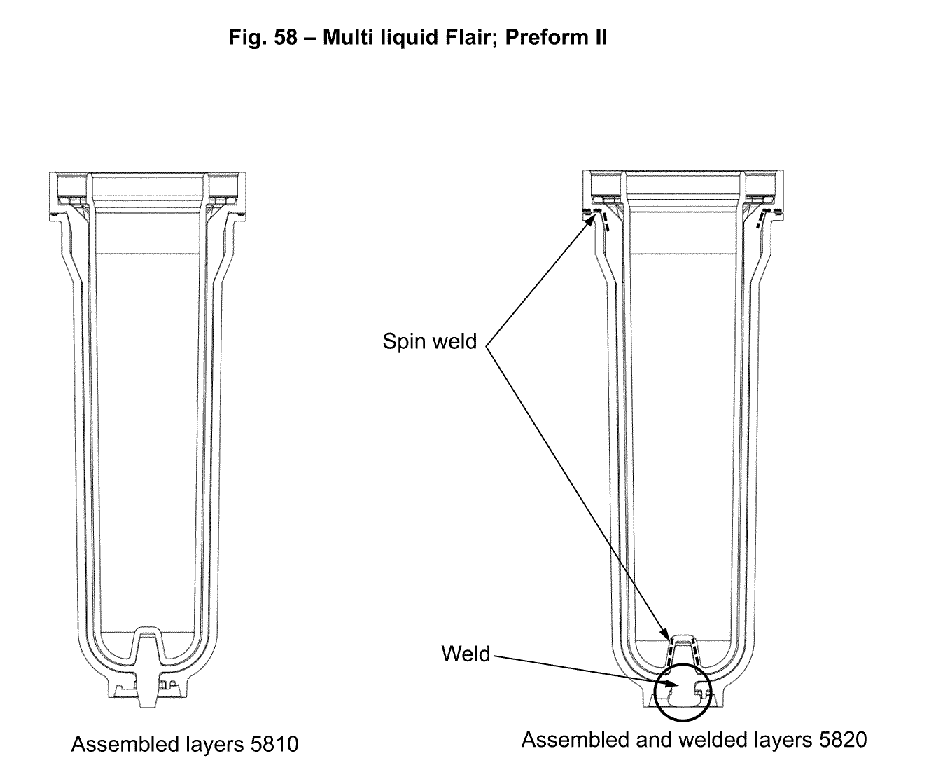

FIG. 57 depicts an alternate perform to that of FIG. 51 for an exemplary Multi Layer Flair bottle according to exemplary embodiments of the present invention, without the vertical protrusion of the third layer above the other two layers, and thus somewhat easier to manufacture. No slide is needed to maintain position of the third layer in such an exemplary embodiment. With reference thereto, FIG. 57 shows exemplary views of the component layers of such a preform, namely, as fully assembled 5710, outside layer 5720, inside layer 5730, and third layer 5740. Inside layer 5730 has, for example, a doubly protruding pin at the bottom, as in the case of the preforms of FIG. 51, for attachment to each of the outside layer and the inside layer, as noted above. Inside layer 5730 also has ribs which provide space between the inner layer 5730 and the third layer 5740. It is noted that in one exemplary two liquid multi-layer system, the second liquid may be provided within the third layer container, made from third layer 5740, and the first liquid may be provided between the outer surface of the third layer container and the inner surface of the inside container, made from inside layer 5730. Returning to FIG. 57, 5750 depicts a diametral cross section of assembled preform 5710. Finally, FIG. 58, analogous to FIG. 52, depicts cross sections of the exemplary Multi Layer Flair perform of FIG. 57, as assembled, according to exemplary embodiments of the present invention, and depicts essentially identical features as shown in FIG. 52.

### Using 2K Molding to Minimize Parts

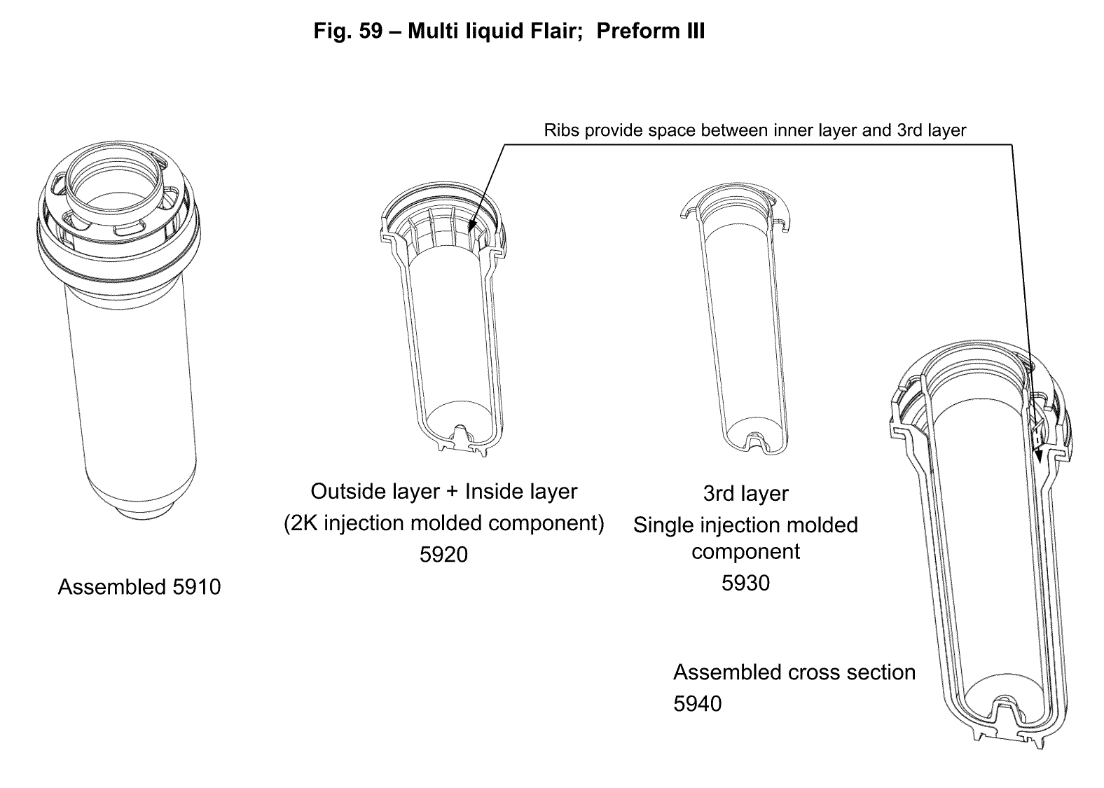

FIG. 59 depicts a third exemplary embodiment of a Multi-Layer Flair perform, comprising two parts instead of three—a 2K injection-molded preform comprising the outside layer and the inside layer, and a third single injection molded preform for the third layer. This is an improved version of the preform shown in FIG. 51, as here only two parts have to be assembled, as opposed to three. This allows for a reduction in cycle time, time of assembly, and also requires less assembly line machinery. As a result, it significantly reduces costs. It is noted that for a three liquid system, instead of a single injection molded third layer, as shown in 5930, there can be, for example, two 2K injection molded components, as shown at 5920. The first can comprise the outside layer and the inside layer, and the second 2K injection molded component can comprise a third layer and a fourth layer, for example. Thus, even a three liquid Multi-Layer Flair perform may be fashioned from only two parts.

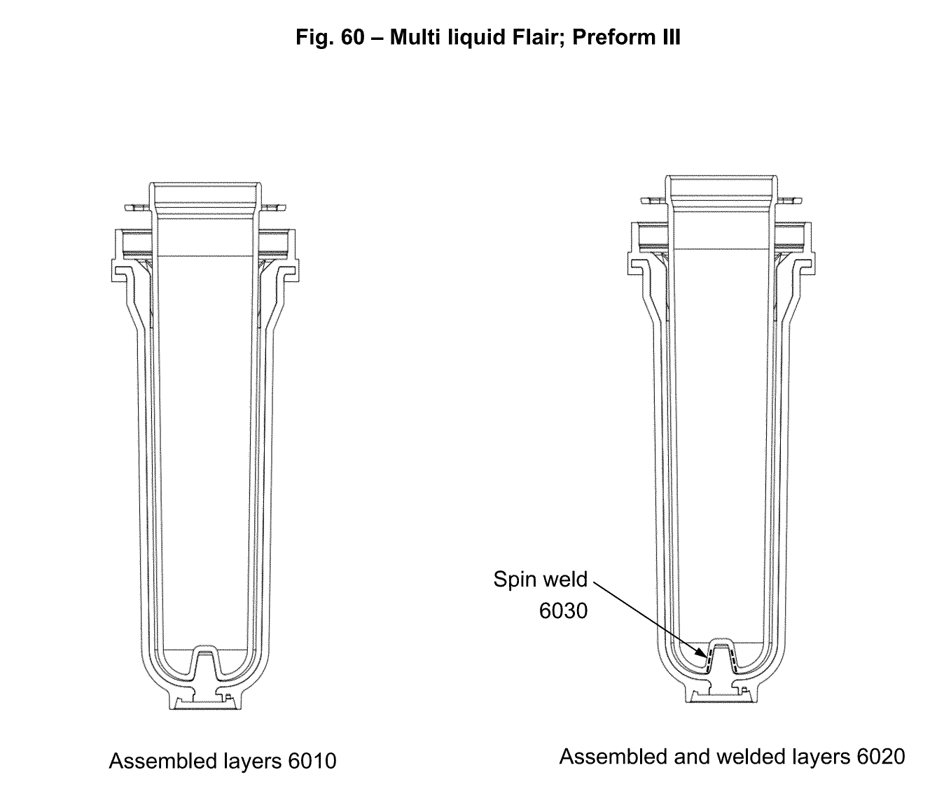

FIG. 60 shows the assembly of the 3^{rd} layer preform, 5930 of FIG. 59, into the 2K preform 5920, also as shown in FIG. 59. It is noted that due to the single piece 5920 comprising both the inner layer and the outer layer, one only has to weld the 3^{rd} layer preform to the 2K preform, in contrast to the preform assembly shown in FIG. 52 where three welds are needed to connect all layers. For spin welds, both parts that need to bond may be, for example, made from the same type of material (e.g. PP-PP or PET-PET).

### Barrier Layers in a Multi-Liquid Dispensing Device

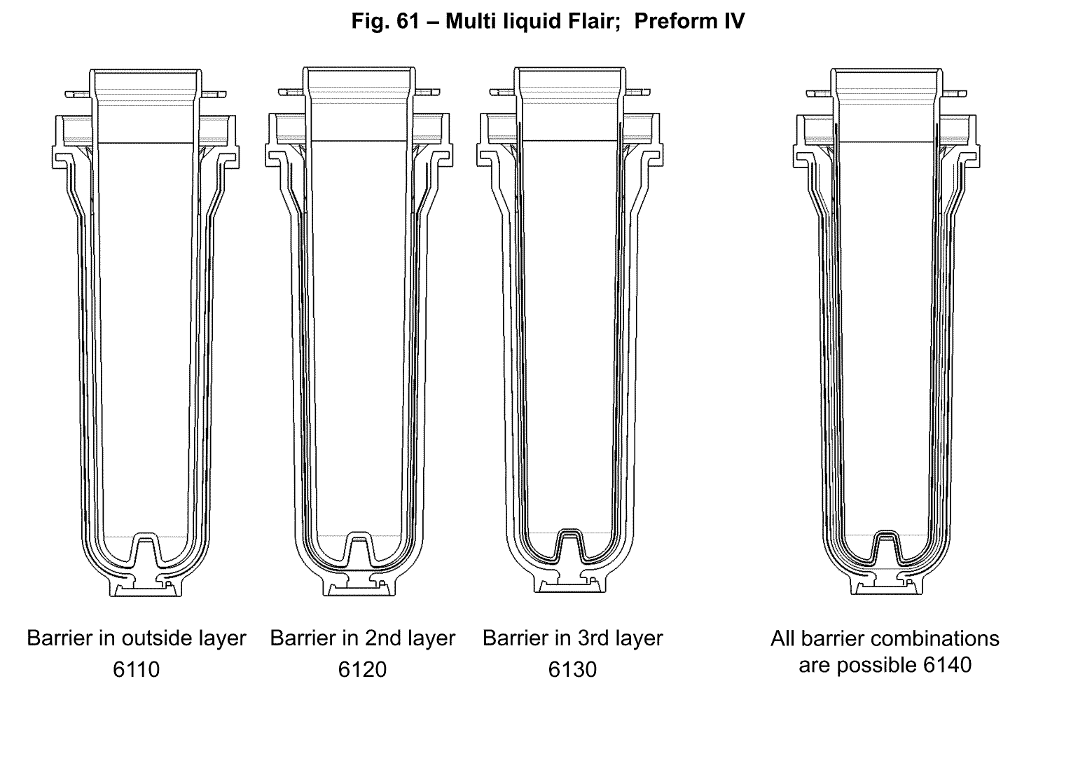

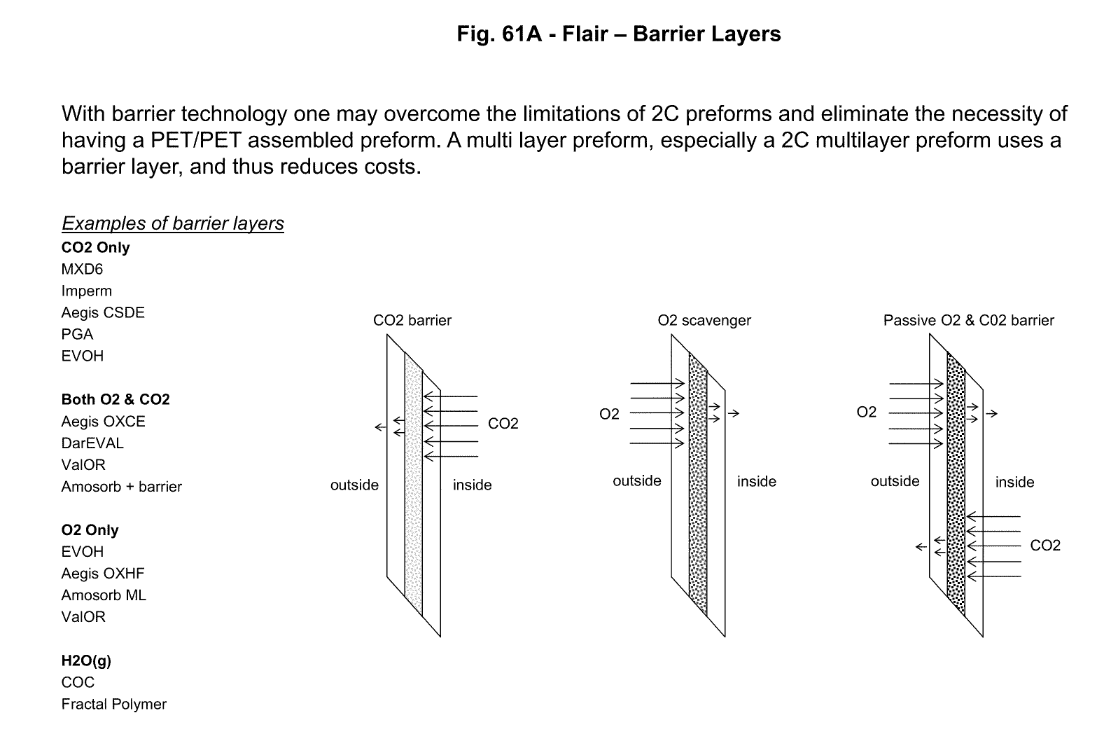

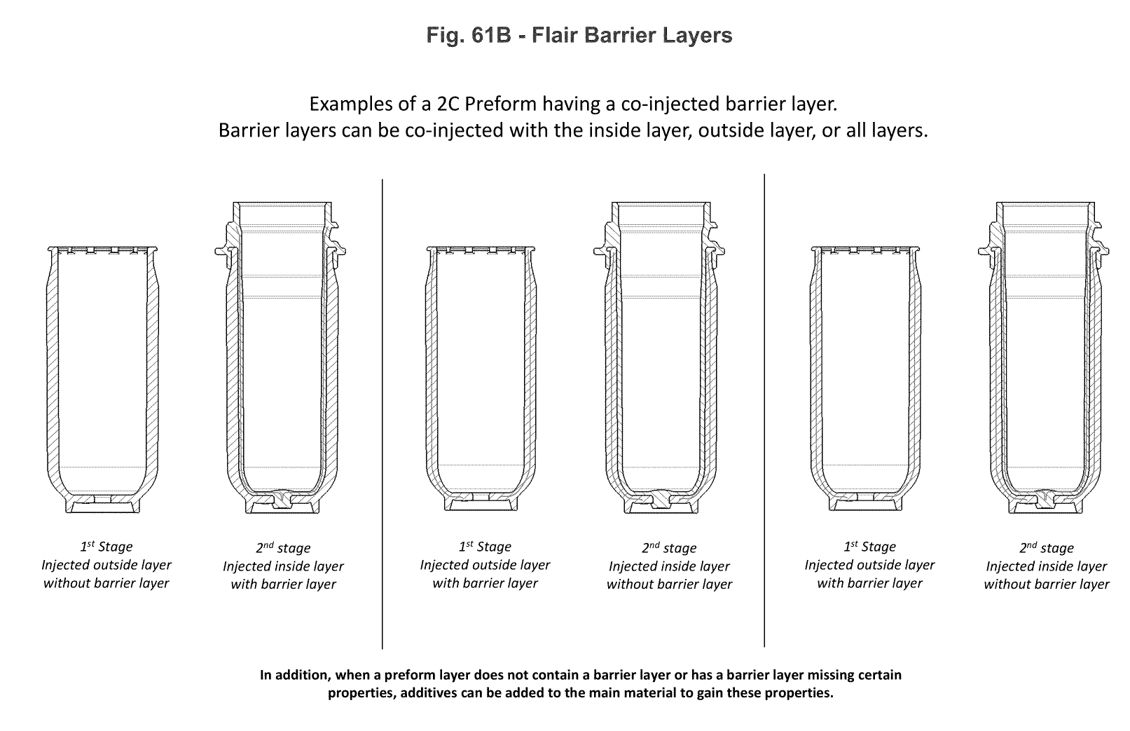

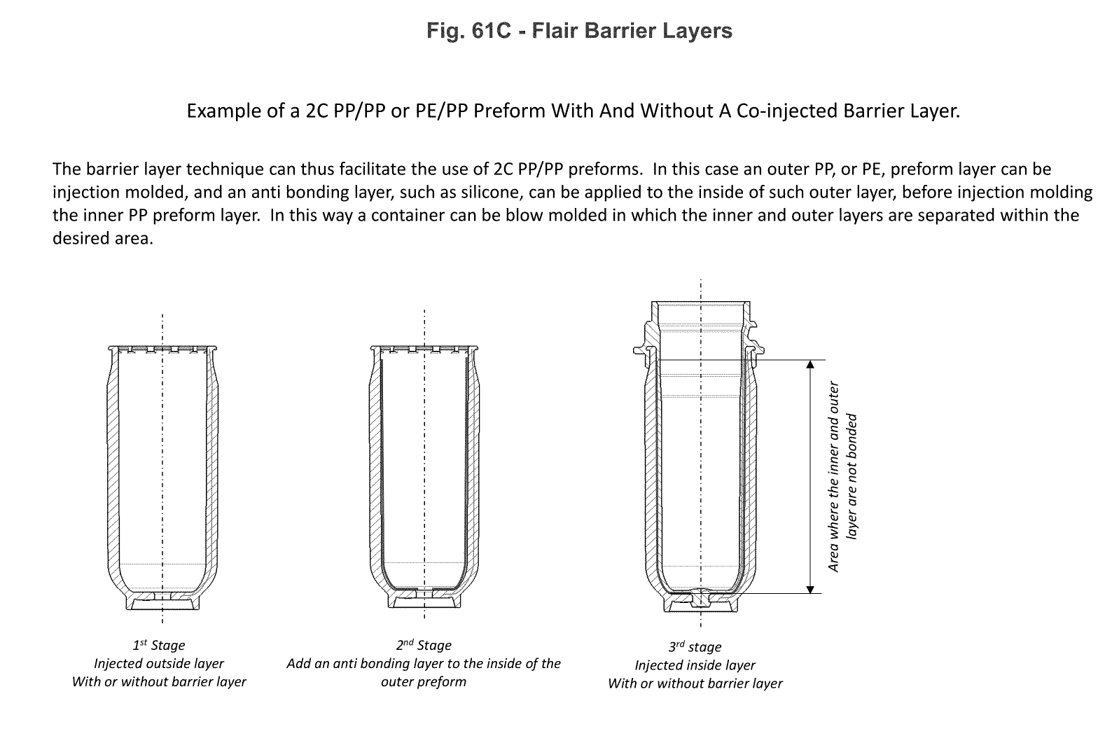

Given that multiple layers of preforms may be utilized, as described above, it is further noted that various barrier layers may be provided within a given preform layer for various purposes. This is illustrated, for example, in FIG. 61. As shown, a barrier may be provided in one or more of the outer layer 6110 of a preform, a second layer 6120, a third layer 6130, or in any combination of these three layers, including all of them, for example, as shown in 6140. As described in the Barrier Layers Provisional, which is incorporated fully herein by reference, barriers of this type may be used to enhance the properties of each layer, such as, for example, to provide oxygen scavengers to keep contents fresh and free of oxidation, to obviate exposure to light or UV radiation, for example.

As noted in the Barrier Layers Provisional, with barrier technology it is possible to overcome the limitations of conventional 2C preforms and thus eliminate the necessity of using a PET/PET assembled preform. This is because it is no longer necessary to rely on PET for its oxygen, moisture or carbon dioxide barrier properties. Instead, various barrier layers inside a given preform layer can be used, as shown in FIG. 61, and thus polyolefins, such as polypropylene or polyethylene for example, can be used for all three layers of the Multi-Layer Flair perform. As shown in FIG. 61A, examples of barrier layer materials for carbon dioxide barriers, both carbon dioxide and oxygen barriers, oxygen only barriers, and moisture barriers are shown, and can be used in exemplary embodiments of the present invention. Further illustrated in the three images of FIG. 61A, beginning with the left image, is a carbon dioxide barrier, where the barrier material prevents carbon dioxide from escaping from the inside of the preform and thus holds carbon dioxide in beverages such as beer, soda pop and other carbonated beverages, such as champagne or sparkling wines, for example. As shown in the middle panel of FIG. 61A, an oxygen scavenger prevents oxygen in the outside air from entering through the preform and thus contaminating or changing the taste, texture, mouth feel, and/or other properties of the liquid inside a bottle ultimately made from the preform. Finally, a passive oxygen and carbon dioxide barrier, as shown in the far right panel of FIG. 61A, prevents oxygen on the outside from entering or passing through the preform, and also prevents carbon dioxide from exiting from a liquid contained within the bottle made from the preform.

FIG. 61B illustrates exemplary combinations of a 2C preform with a co-injected barrier layer. The barrier layer can be co-injected with the inner preform layer, with the outer preform layer, or with both, for example. Therefore, with reference to FIG. 61B, moving from the leftmost image to the rightmost, there is a first stage which is an injection molded outer layer with no barrier layer and a second stage which is an injected layer containing a barrier layer. The middle image shows the first stage preform having a barrier layer and the second stage, or inner preform, not having a barrier layer. And finally, the rightmost image illustrates the first stage or outer preform having a barrier layer, as well as the second stage or inner preform also having a barrier layer. In this latter example of the rightmost image of FIG. 61B, there are two barrier layers. They can have identical, similar or complimentary properties. It is noted in each of the images of FIG. 61B that the barrier layer is shown as a thin blue line whereas a preform without a layer is shown in black and white with hash marks.

Finally, it is also noted in connection with FIG. 61B that when a preform layer does not contain a barrier layer, or has a barrier layer, but that barrier layer lacks certain properties, additives can be added to the main material to gain these properties. Therefore, between the properties of the main layer and the properties of the co-injected barrier layer, a wide variety of barrier properties can be obtained as may be needed or desired in various contexts.

Although FIG. 61B illustrates barrier layers for a two layer preform, the principles and implementation is directly extendible to a three layer preform, or a four layer preform, as in the case of a Multi-Layer Flair perform shown in FIGS. 51-61 above. It is understood that any of the three layers may be provided with an integrated barrier layer, as shown in FIG. 61, for example. Thus, a 2C preform and bottle may, for example, have a co-injected barrier layer. For example, with reference to the leftmost image of FIG. 61B, the first injection shot is an outside layer with simple material (no barrier layer) and the second injection shot is an inside layer with a co-injected barrier layer, as shown.

One may have, for example, a 2C PP/PP or PE/PP preform with and without co-injected barrier layers. Thus, barrier technology as integrated in a Flair preform allows the use of wholly polyolefin preforms. In this case, an outer preform layer made of either polypropylene or polyethylene, for example, can be injection molded, and following that an anti-bonding layer, such as silicone can be added to the inside of the first stage, or outer preform, prior to injection molding the second, or inner preform layer, made out of, for example, PP. In this way a container can be blow molded in which the inner and outer layers are separated within a desired area by virtue of the addition of the anti-bonding layer, or release agent layer. This is necessary in a PP/PP preform because due to the fact that both the inner layer and the outer layer are made of the same material, when the second stage injection molding occurs there can be chemical bonding at the interface between the two layers due to the fact that they have the same melting point. Additionally, with mixed polyolefins, or different types of polyolefins, this kind of bonding can even occur between a PE/PP interface in which the same anti-bonding process can be utilized, if necessary. It is noted that, in exemplary embodiments, one could make a 3C preform or a 4C preform (i.e., three stage (tri-injection), or four stage (quad-injection) molding process), all layers being made from the same material. The individual layers may be separated were needed by applying a anti bonding layer (e.g. silicone) and bonded were no anti binding agent is applied, as described in connection with FIG. 61C below. Welding would then be completely unnecessary, as not components are separately made, and thus do not need to be assembled after molding.

FIG. 61C illustrates examples of a 2C PP/PP, or 2C PE/PP preform with and without co-injected barrier layers. With reference to FIG. 61C, it is noted that the barrier technology as integrated in a Flair preform allows the use of wholly polyolefin preforms. In this case, an outer preform layer made of either polypropylene or polyethylene, for example, can be injection molded, and following that an anti-bonding layer, such as silicone can be added to the inside of the first stage, or outer preform, prior to injection molding the second, or inner preform layer, made out of, for example, PP. In this way a container can be blow molded in which the inner and outer layers are separated within a desired area by virtue of the addition of the anti-bonding layer, or release agent layer. This is necessary in a PP/PP preform because since both the inner layer and the outer layer are made of the same material, when the second stage injection molding occurs there can be chemical bonding at the interface between the two layers, because they have the same melting point. Additionally, with mixed polyolefins, or different types of polyolefins, this kind of bonding can even occur between a PE/PP interface, and thus the same anti-bonding process can be utilized, if necessary.

Thus, in exemplary embodiments of the present invention, by combining barrier layer injection molding techniques with conventional Multi-Layer Flair perform technology, an improved preform with various barrier properties can be created, of all polyolefin layers, thus, for example, avoiding use of the more expensive PET as the outer layer. Further, given the wide variety of barrier materials available, an almost “designer” preform perfectly adapted to a customer's or consumer's needs can be fashioned.

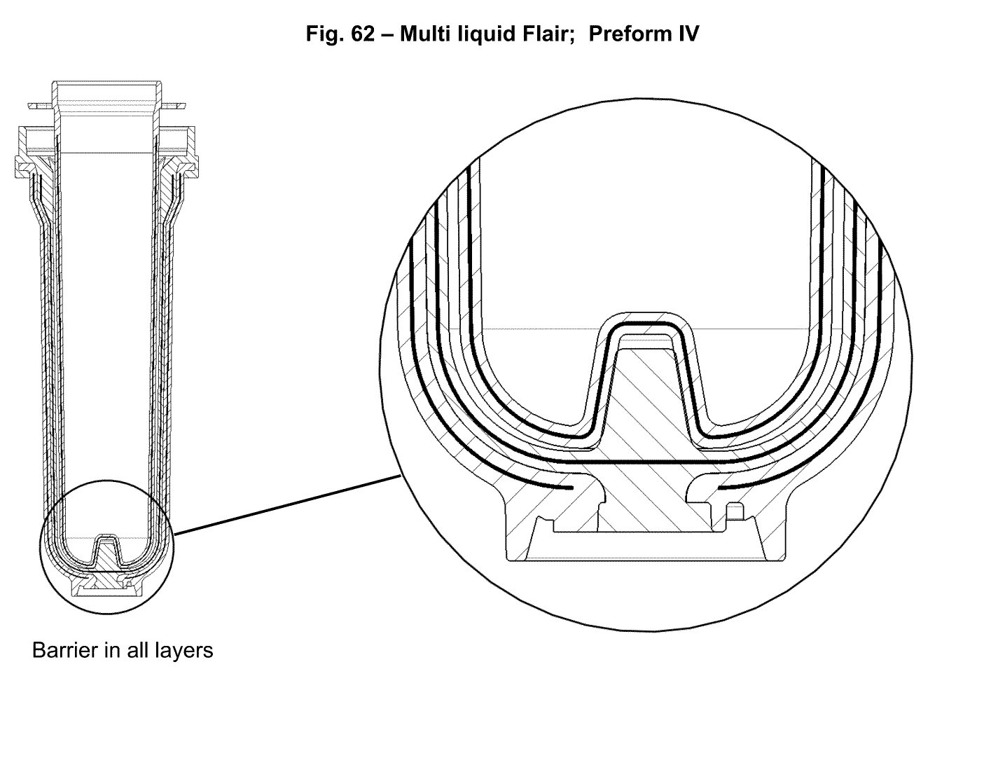

It is noted that although FIG. 61 shows exemplary barrier layers in the Multi Liquid Flair Preform, barrier layers may also be provided in all other embodiments and types of preforms and bottles as shown in any of the previous figures. Finally, FIG. 62 illustrates a cross section and a magnified version thereof, of an exemplary preform with built-in barriers in each layer.

### Additional Variations to Multi-Layer Preforms

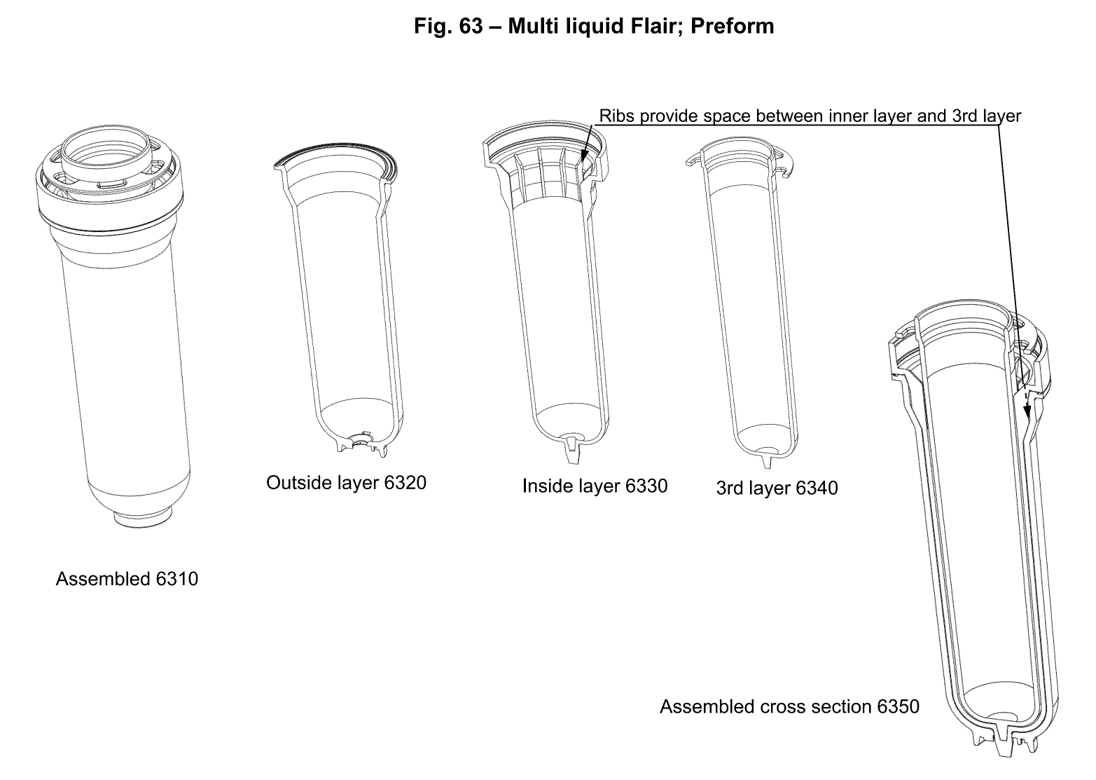

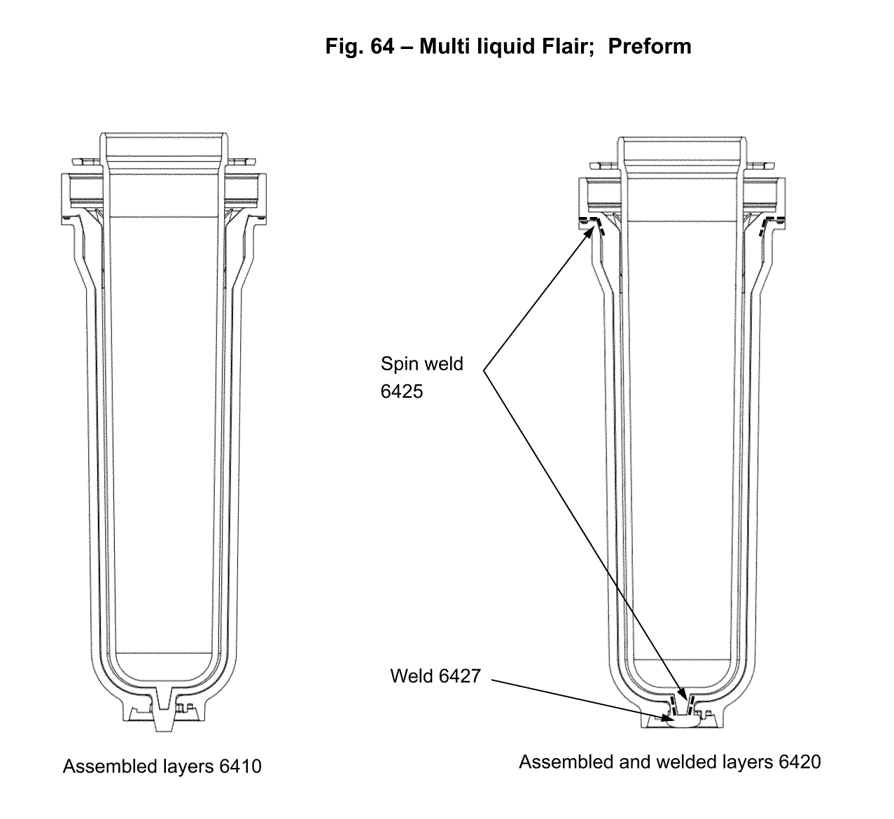

FIGS. 63-64 show an alternate exemplary preform assembled from three single injection molded components. With reference thereto, FIG. 63 shows exemplary views of the component layers of such a preform, namely, as fully assembled 6310, outside layer 6320, inside layer 6330, and third layer 6340. Inside layer 6330 has, for example, a hollow pin to receive the single protruding pin of third layer 6340 for welding. The assembled cross section is shown at 6350, where the third layer pin is shown as fitting within the insider layer pin in a fully assembled state. FIG. 64 depicts cross sections of the exemplary Multi-Layer Flair perform of FIG. 63 as fully assembled, but before being blown to its final bottle shape, according to exemplary embodiments of the present invention. 6410 shows such assembled layers, and 6420 depicts exemplary welding techniques, where a weld 6427, for example, a mechanical compression fit type, may be used at the junction of the outside and inside layers at the bottom, and where spin welds 6425 may be used to attach both the outside and inside layers at the top (top spin weld), as well as the third layer pin to the inside layer pin, as shown (bottom spin weld).

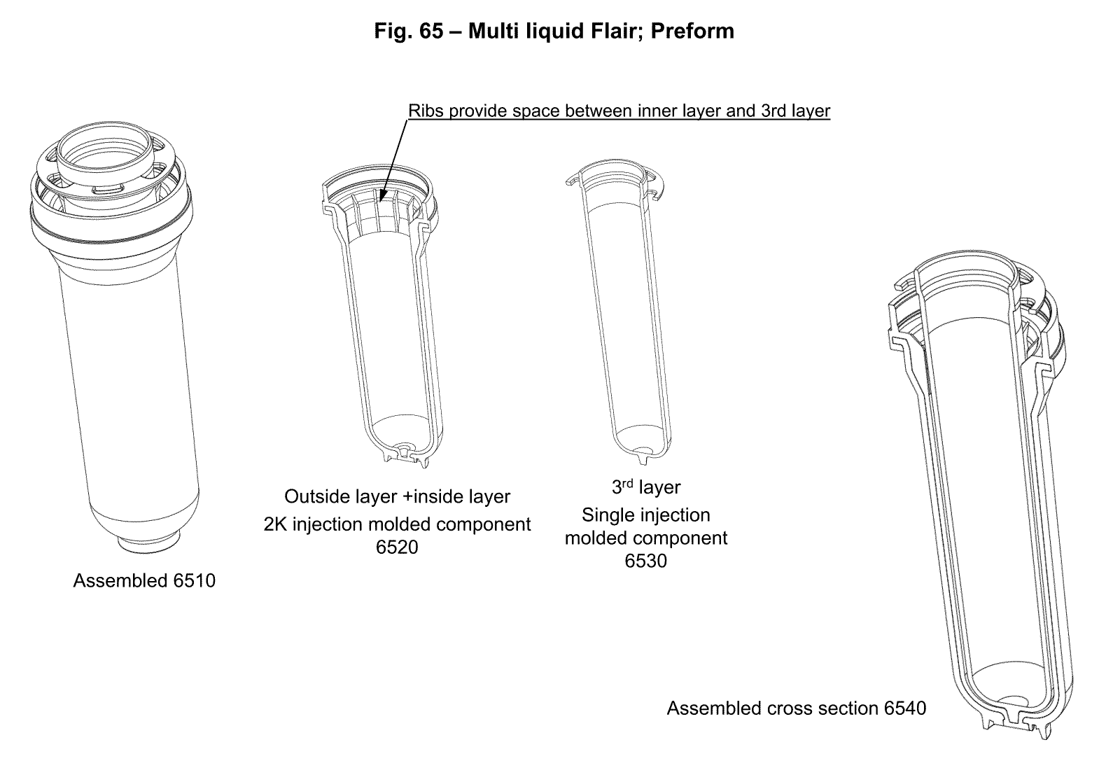

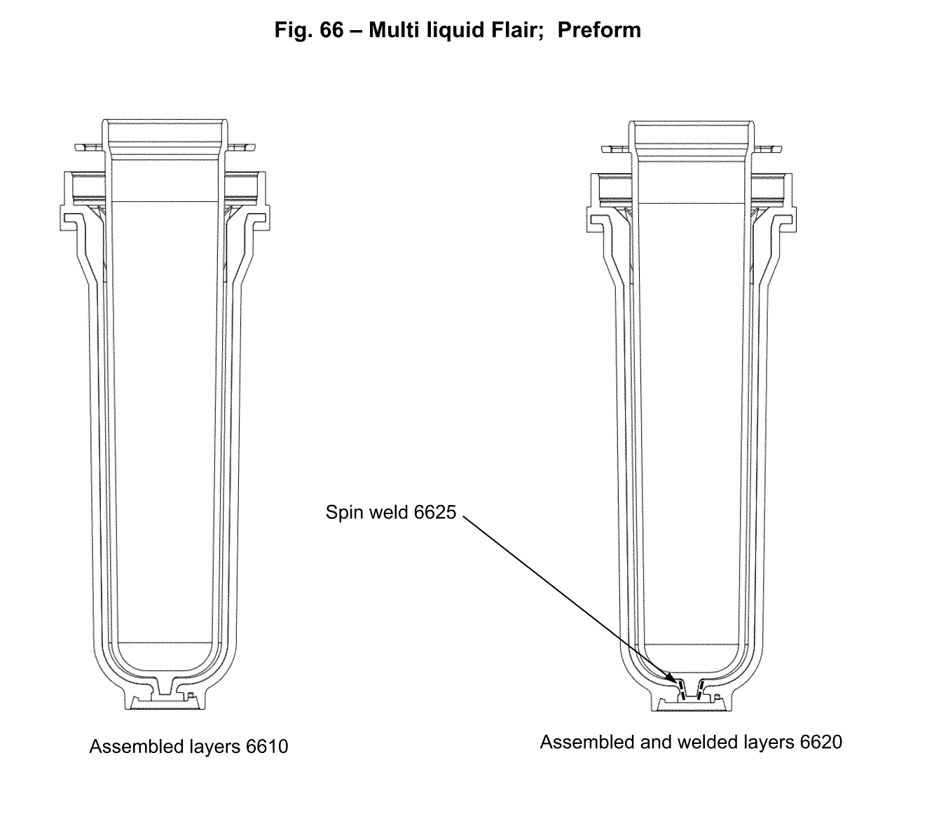

FIGS. 65-66 show a preform assembled from a 2K injection molded component and one single injection component part. The inside layer of the 2K preform has a cavity to receive the single protruding pin of the third layer for welding. This exemplary preform is essentially the same as that shown in FIGS. 59-60, however with a different manner of connecting the 2K injection molded component 6520 and the third layer component 6530. As in the case of FIGS. 59-60, this exemplary preform has only two parts that need to be assembled, as opposed to three. This allows for a reduction in cycle time, time of assembly, and also requires less assembly line machinery. As a result, it significantly reduces costs.

FIG. 66 shows the assembly of the 3^{rd} layer preform, 6530 of FIG. 65, into the 2K preform 6520, also as shown in FIG. 65. It is noted that due to the single piece 6520 comprising both the inner layer and the outer layer, one only has to weld the 3^{rd} layer preform to the 2K preform, as shown in 6620, with spin weld 6625.

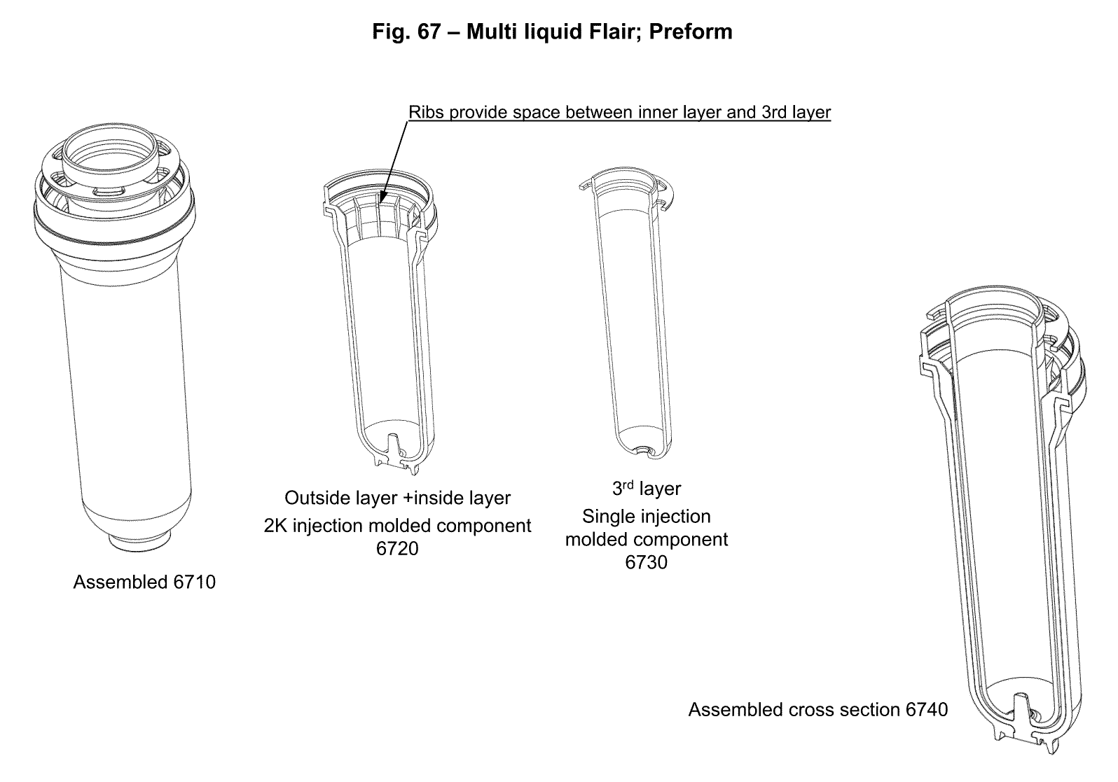

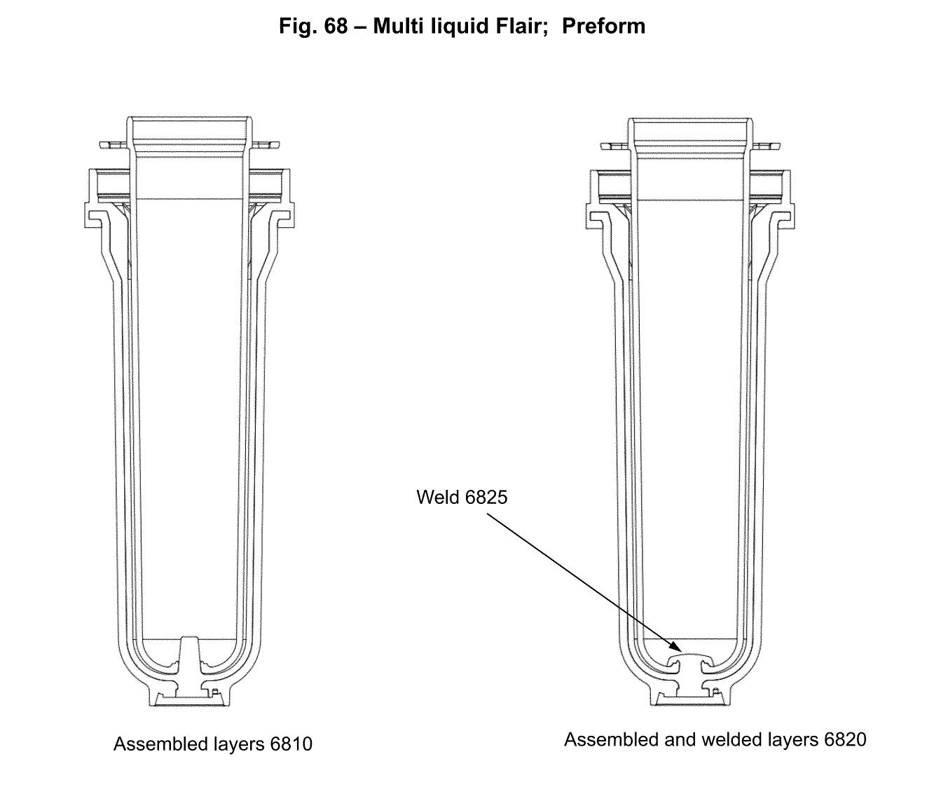

FIGS. 67-68 show an alternate exemplary preform assembled from a 2K injection molded component and one single injection molded component. The various views of FIGS. 67-68 correspond to the analogous views of FIGS. 65-66, respectively, and have identical index numbers in the last two digits. The attachment mechanism is the “inverse” of that of the preform of FIGS. 65-66, inasmuch as in FIGS. 67-68 the inside preform has an upwards protruding pin, and the third layer has a hole through which this pin can protrude, as shown in assembled cross section 6740, and in assembled and welded layers 6820 of FIG. 68. As shown at 6820, the pin may be flattened and welded down, via weld 6825, to bond the inside layer and the third layer.

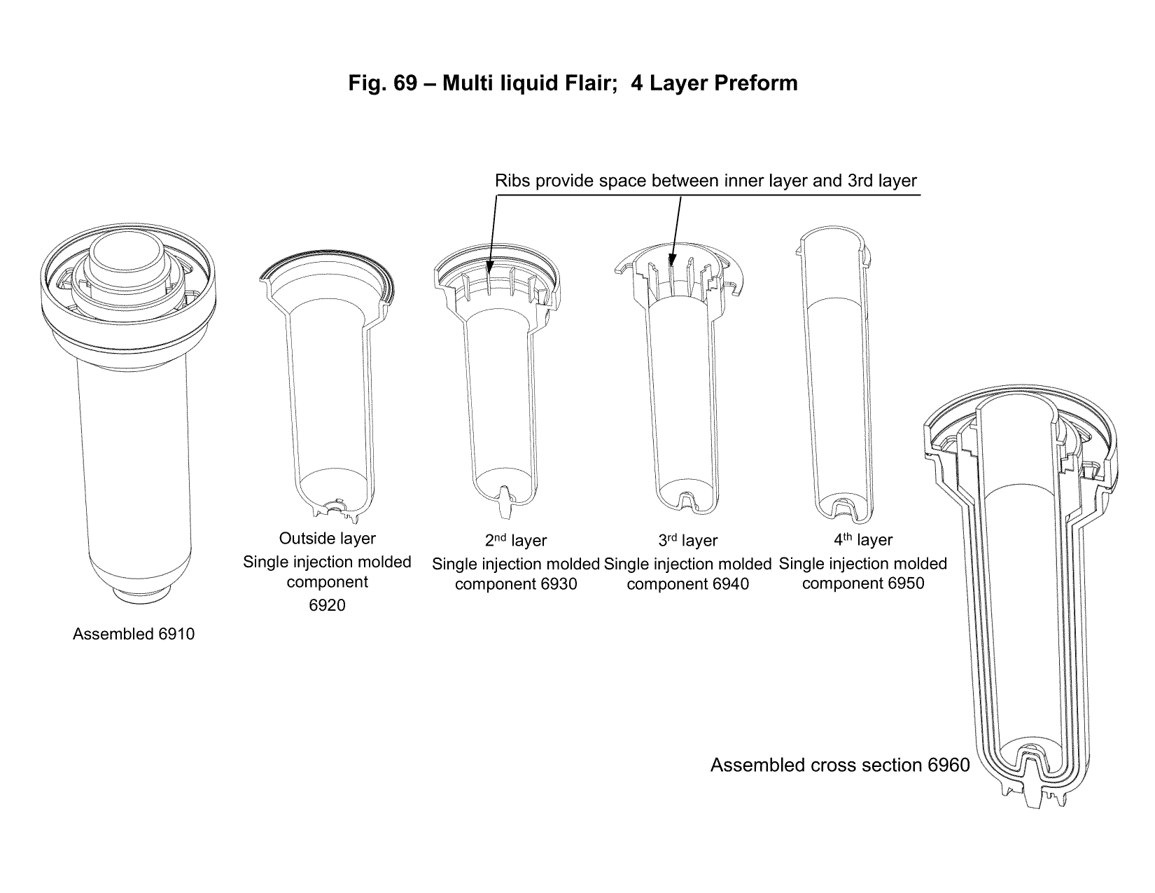

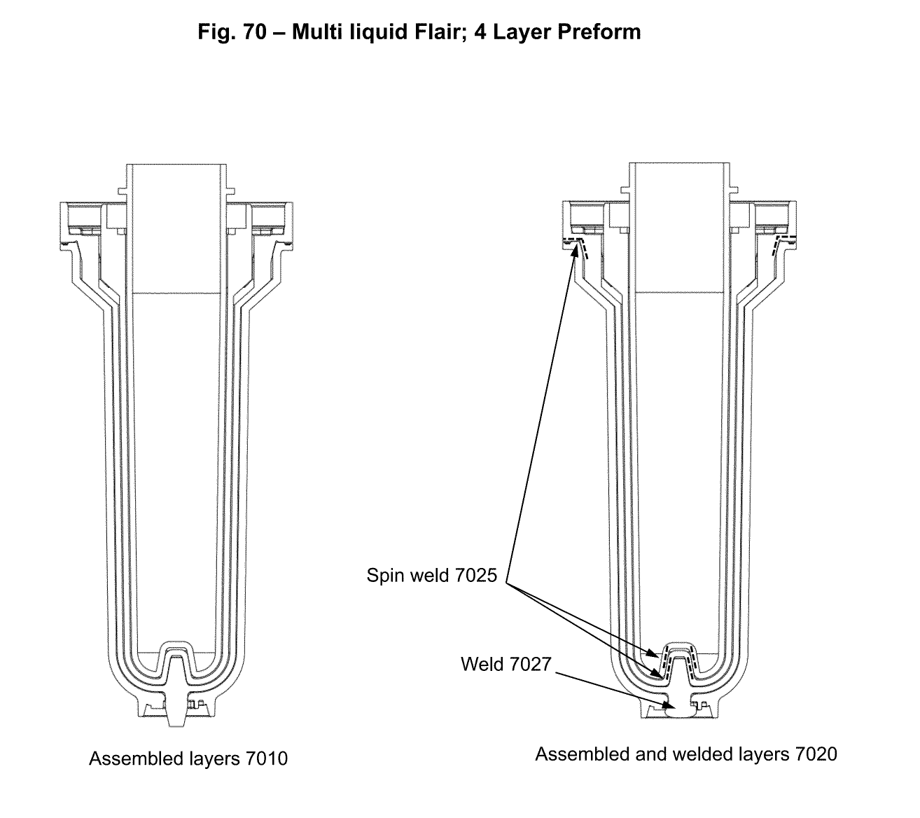

FIGS. 69-70 show an exemplary four layer preform assembled from four single injection molded components. Such an exemplary preform can thus hold three liquids for co-ordinated dispensing. With reference to FIG. 69, there are shown exemplary views of the component layers of such a preform, namely, as fully assembled 6910, outside layer 6920, second layer 6930, third layer 6940 and fourth layer 6950. All layers are single injection molded in this exemplary preform. Second layer 6930 has, for example, a doubly protruding pin at its bottom, the same structure as shown in FIG. 51, for attachment to each of the outside layer 6920 and the third layer 6940, as shown in the assembled cross section 6960. The fourth layer 6950 is also attached to the upper surface of the upwards invagination at the bottom of the third layer 6940. It is noted that in a three liquid multi-layer system, the third liquid is provided inside the fourth layer container, made from fourth layer 6950, the second liquid is provided inside the third layer container, made from third layer 6940, and the first liquid is provided between the outer surface of the third layer container 6940 and the inner surface of the second layer container, made from second layer 6930. The gap between outside layer 6920 and the outer surface of second layer 6930 is filled with a displacement medium, at either an over pressure arrangement, such as via a pump, or in an underpressure arrangement by venting to the atmosphere (although with liquids of appreciable viscosity such an underpressure arrangement may require significant hand squeezing by a user). Returning to FIG. 69, perform view 6960 depicts a diametral vertical cross section of assembled view 6910. It is noted that the third layer is initially molded so as to fit within the second layer 6130, and the fourth layer 6950 is initially molded so as to fit within the third layer 6940.

FIG. 70 depicts cross sections of the exemplary Multi-Layer Flair perform of FIG. 69 as fully assembled, but before being blown to its final bottle shape, according to exemplary embodiments of the present invention. 7010 shows such assembled layers, and 7020 depicts exemplary welding techniques, where a weld 7027, for example, a mechanical compression fit type, may be used at the junction of the outside and second layers at the bottom, and where three spin welds 7025 may be used to attach both the outside and second layers at the top (top spin weld), the second layer pin to the third layer cup (invagination), and the fourth layer cup to the third layer cup, as shown (bottom two spin welds). Of course, the connection of all layers can be done in any other manner described herein or other ways as may be known to one skilled in the art.

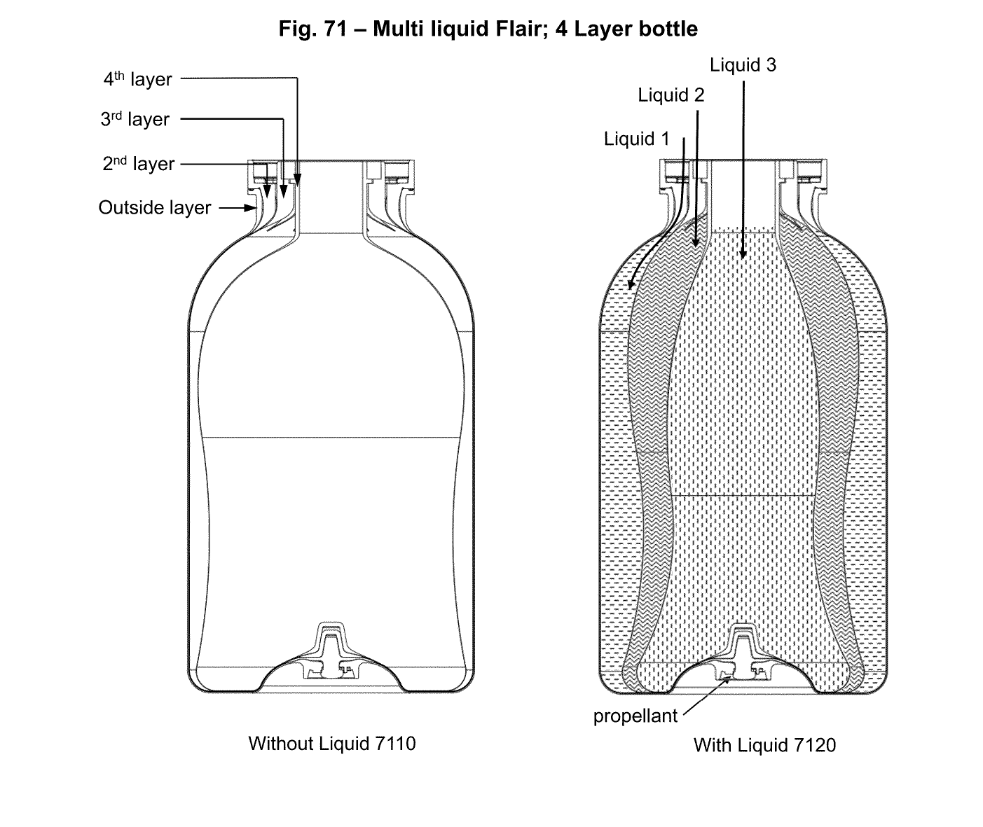

FIG. 71 shows an exemplary four layer bottle, such as may be blown from the exemplary four layer pre-form of FIGS. 69-70. The exemplary bottle has four compartments. Three to contain liquid or other substances to be dispensed. One, between the outside layer and the second layer, to receive the displacement medium/propellant. The bottle is shown without liquid in the left side view 7110, and this view also indicates the various four layers. The right side view 7120 depicts the exemplary bottle with the three liquids inside, which can be filled from, for example, outside to inside, i.e., first Liquid 1, then Liquid 2, and then Liquid 3, in an analogous fashion to the two-liquid case described above in connection with FIG. 55, or for example, from inside to outside, i.e., first Liquid 3, then Liquid 2, and then Liquid 1, in an analogous fashion to the two-liquid case as described above in connection with FIG. 55A. This, as each liquid is filled, first, a headspace is always left so that air can escape as other liquids are filled, and second, as the next liquid is filled, air escapes the first liquid's container (in whatever order filling is done—in to out, or out to in). Thus, it is necessary to calculate the ratio of liquids by volume in a particular exemplary multi-liquid system, and fill accordingly. While it is noted that in some cases there may be equal portions of each liquid, in many there will be disproportionate ones, such as, for example 1:3, 1:4, 1:2:5, 1:3:4, 1:2.5:2.8, etc., as may be the case. This affects how much headspace is to be left in each container as the liquids are filled.

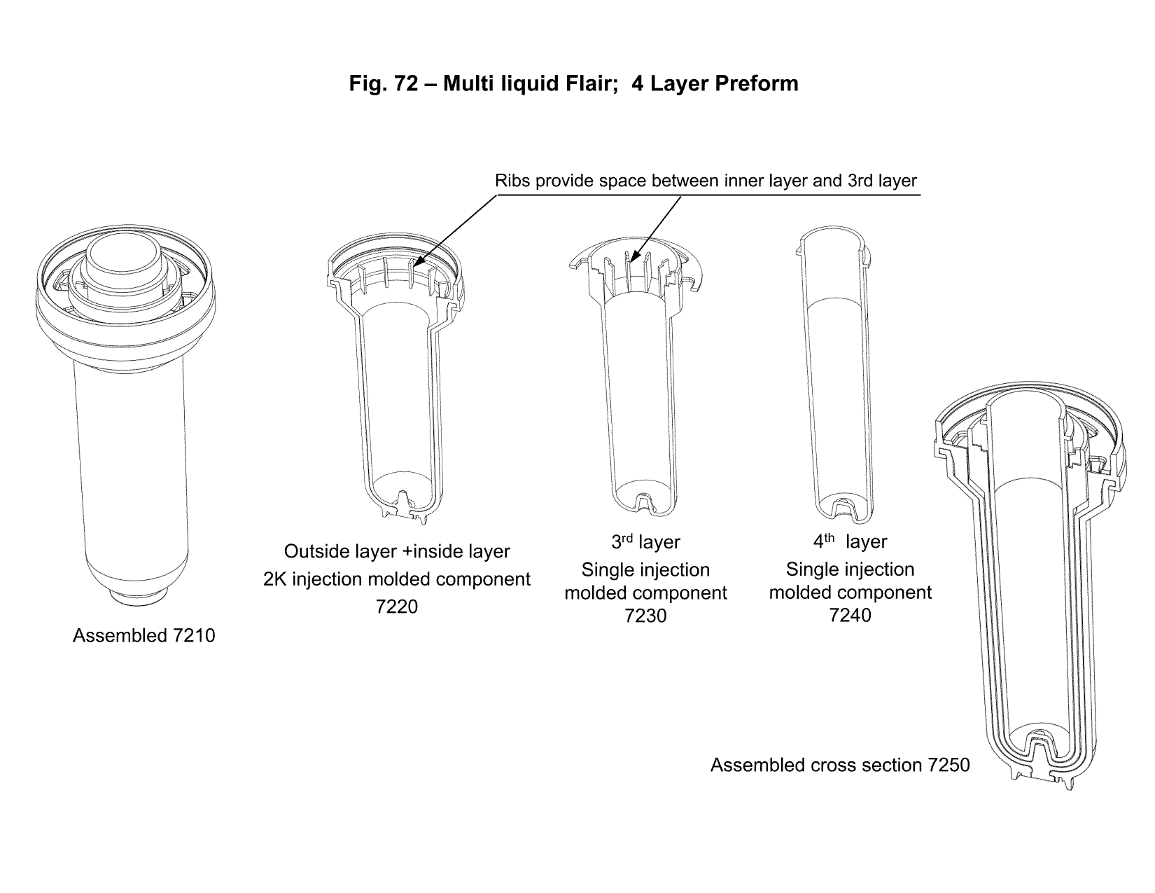

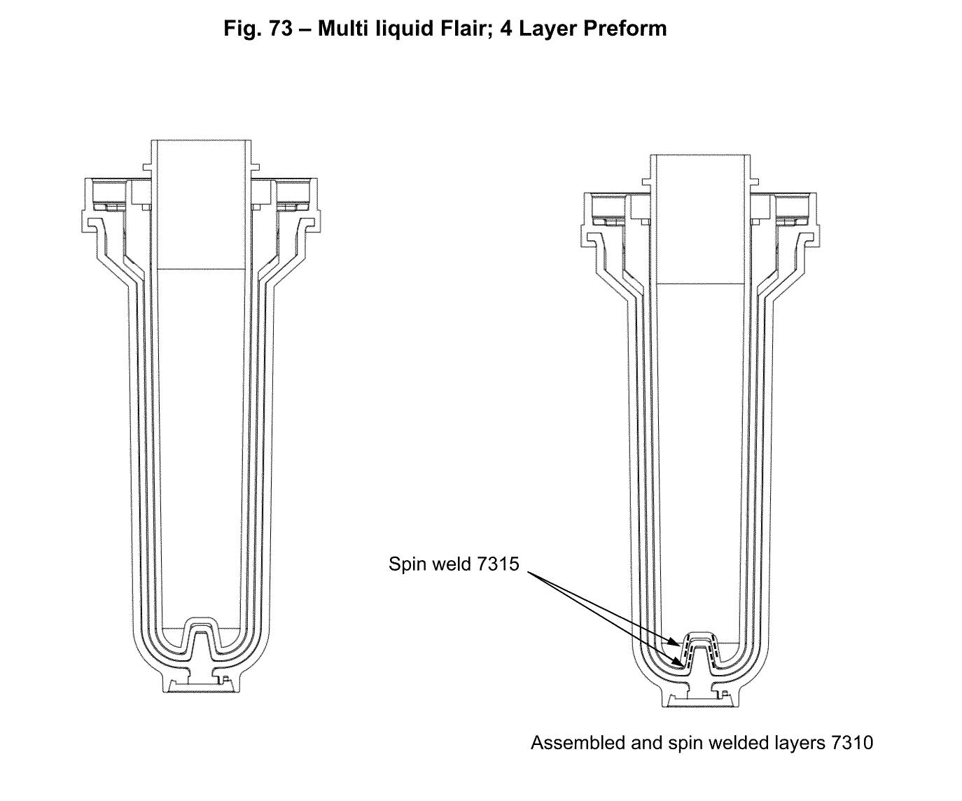

Finally, FIG. 72 depicts an exemplary preform assembled from one 2K injection molded component 7220, comprising an outside layer and a second layer, and two single injection molded components, 7230, 7240, comprising the third and fourth layers, respectively. The assembled preform is shown at 7210, and the assembled cross-section at 7250. As shown in FIG. 73, the welding of the layers may be done, for example, by spin welding 7315 a protruding pin from the second layer, and also spin welding 7315 the fourth layer's bottom “cup” (invagination) on top of the third layer's cup, as shown at 7310. Alternatively, of course, the connection of all layers can be done in any other manner described herein, or, for example, using other methods as may be known by one skilled in the art.

### Integrated System and Customized Brushes

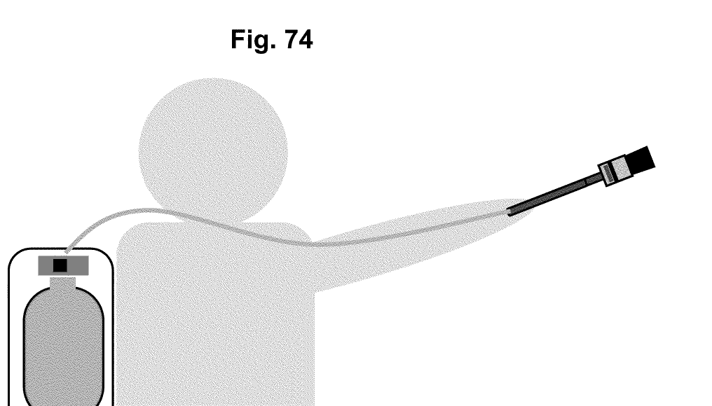

FIG. 74 depicts an alternate integrated bottle container and power pack, wearable on a user's back, according to exemplary embodiments of the present invention. Here the bottle holder 7410 includes an integrated Power pack 7420, which can be, for example, removable and rechargeable. There is also provided solenoid valve 7430, which has a safety feature to the effect that if there should be a stop of the electronics, or some other cause of system failure, the solenoid valve will go open automatically and depressurize the system.

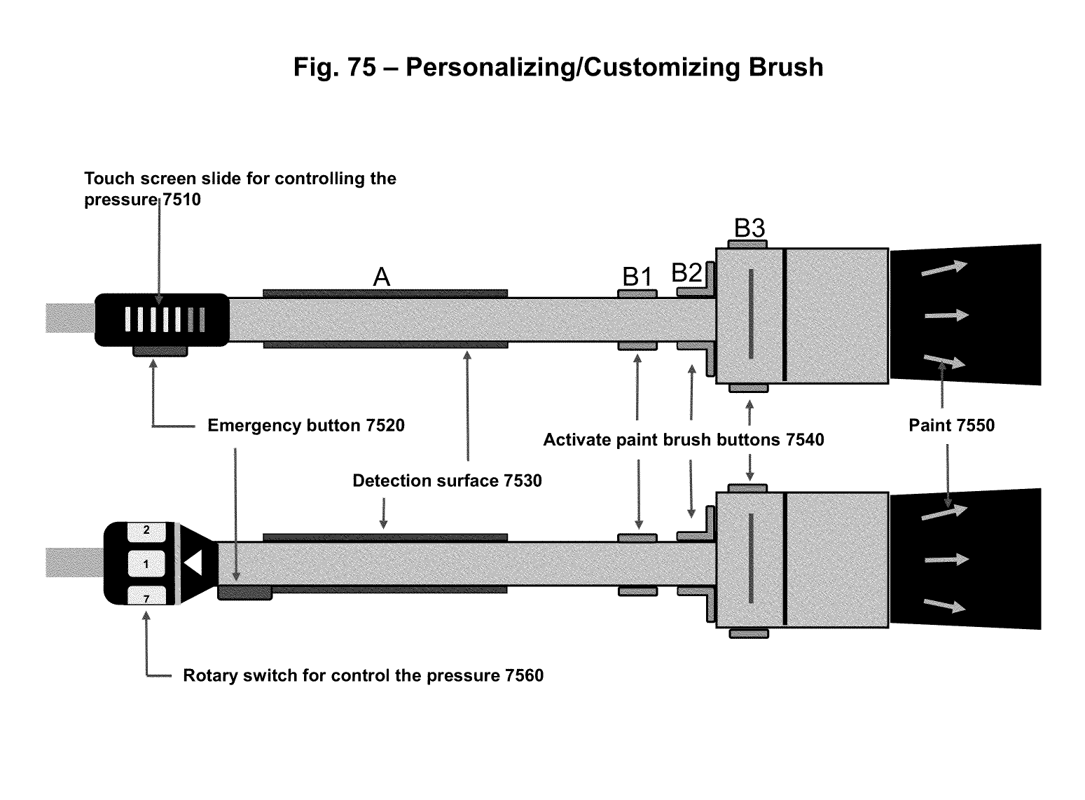

FIG. 75 depicts exemplary personalizations and customizations of an exemplary brush handle according to exemplary embodiments of the present invention. Thus, there can be, for example, a touch screen slide actuator 7510 for controlling the system pressure, or for example, a rotary switch 7560. Emergency button 7520 can be provided in various locales, as a use is most comfortable with. As noted above, there can be detection surfaces 7530, and then various locations of the activation buttons B1, B2 and B3 7540. This reflects the fact that painters and other tradesmen and craftsmen are used to, and have come to expect, controls in certain convenient (for them) places. Novel electronic paint brushes such as disclosed herein can easily be accommodated to their habits and expectations.

The above-presented description and figures are intended by way of example only and are not intended to limit the present invention in any way except as set forth in the following claims. It is particularly noted that the persons skilled in the art can readily combine the various technical aspects of the various exemplary embodiments described. Thus, although multi-layer preforms have been described for systems with three and four layers, the techniques and methods of the present invention include any realistic number of container layers, and thus liquids. Layers may contain barriers, as further described above, to achieve various results between some, or all layers. Users may thus mix and match any of the illustrated systems, and combine the various described elements in a plethora of possible ways.

What is claimed is:

1. A liquid dispensing device, comprising:
one or more bottles each comprising:
an inner container and an outer container, the inner container filled with a liquid,
a valve releasably closing flow from the inner container;
a hand-held dispenser having a detection zone and an activation zone; and
a conduit connected between each valve and the hand-held dispenser;
wherein, in operation, if both the detection zone and the activation zone are activated, a valve is released and the liquid is dispensed upon activation of the activation zone.

2. The device of claim 1, wherein a bottle is one of: a standard container within a container, a piston container within a container, and a multi-layer container within a container.

3. The device of claim 1, wherein the hand-held dispenser comprises one of a PCB, microprocessor and microcontroller, and wherein said one of a PCB, microprocessor and microcontroller receives signals from said detection zone and said activation zone and outputs a control signal to each valve.

4. The device of claim 3, wherein a valve is normally closed, and upon receipt of a control signal from said one of a PCB, microprocessor and microcontroller, opens, and wherein when said valve ceases to receive said control signal, said valve returns to the closed state.

5. The device of claim 4, wherein the various valves can each be held open for a different time so as to achieve a desired mix of liquids actually dispensed.

6. The device of claim 1, wherein there are two or more bottles, and at least one of:
each bottle has a different component color of paint or stain, and they are mixed together at dispensing time into a desired output color, and
each bottle has a component of an adhesive, epoxy or caulk, which cannot be mixed with any other component prior to the time of dispensing.

7. A multi-layer container within a container bottle, comprising:
an outer container;
two or more inner containers, said two or more inner containers nested one within the other; and
one of (i) an opening and (ii) a one-way inlet valve, to receive a displacement medium,
wherein, in operation, as a displacement medium is provided through the one of (i) an opening and (ii) a one-way inlet valve, pressure is passed from the gap between the outer container and the first inner container to a first liquid in the first inner container, and that pressure is passed, in turn, to the second inner container and any second liquid in said second inner container, and from said second liquid on to any additional inner containers nested within the second inner container.

8. The multi-layer container within a container bottle of claim 7, further comprising at least one of a power pack supplying a pressurized medium to the container, and a container holder in which the multi-Flair container can be provided.

9. The multi-layer container within a container bottle of claim 7, wherein there are two inner containers, each provided with a liquid, and as a result of the pressure applied to the container, both liquids are pushed out of the multi-layer container at the same time.

10. The multi-layer container within a container bottle or reservoir of claim 8, wherein the power pack maintains pressure in all of the inner containers at a preset level by supplying pressurized air to a one-way inlet valve fluidly connected to the outer container.

11. The multi-layer container within a container bottle of claim 7, wherein at least one of:
(i) the outer container and the two or more inner containers are separately injection molded;
(ii) the outer container and one of the inner containers is 2K molded;
(iii) there are three inner containers, and the outer container and one of the inner containers are 2K molded, and the other two inner containers are also 2K molded; and
(iv) the outer container and the two or more inner containers are all multi-K molded.

12. The multi-layer container within a container bottle of claim 7, wherein one or more of the outer container and the two or more inner containers are provided with an internal barrier layer.

13. A liquid dispensing system, comprising:
a multi-layer container within a container bottle comprising an outer layer and multiple inner layers, each inner layer containing a liquid;
a nozzle;
an inlet valve;
a multi-tubular conduit tube connecting said multi-layer container and said nozzle; and
a pressure source,
wherein flow of the liquids out of the nozzle is activated by a user.

14. The liquid dispensing system of claim 13, wherein at least one of:
(i) the nozzle is configured to dispense the multiple liquids in a defined ratio, and
(ii) the nozzle is configured to dispense the multiple liquids in a defined ratio, and to mix them with air in a defined ratio.

15. A method of assembling a multi-layer container, comprising:
providing a preform outside layer;
providing a preform inside layer;
providing a preform third layer; and
placing the second inside layer within the inside layer, and placing the inside layer within the outside layer,
wherein said inside layer has a doubly protruding pin, for attachment to each of the outside layer and the inside layer, and said inside layer is provided with ribs in the inner portion of its top portion, to provide space between said inside layer and said second inside layer.

16. The method of claim 15, further comprising attaching said inside layer to each of said outside layer and said second inside layer by one of welding and spin welding.

17. The method of claim 16, wherein a weld is used at the junction of the outside and inside layers at the bottom, and wherein spin welds are used to attach the outside and inside layers at the top, and the second inside layer to the top pin of the inside layer at the bottom.

18. The method of claim 15, wherein said outside layer and said inside layer are 2K molded in one step, and said third layer is injection molded in a second step, and then the third layer is welded to the inside of the inside layer.

19. The method of claim 15, further comprising at least one of:
(i) blowing the preform to final shape,
(ii) blowing the preform and using slides during blow molding to keep the second inside layer in position, and
(iii) blowing the preform and using slides during blow molding to keep the second inside layer in position, and after blowing pushing the second inside layer down to obtain an unblocked opening.

20. The method of claim 19, further comprising:
filling a first liquid between the inside layer and the third layer, thereby pushing air out of the interior of the second inside layer; and
filling the interior of the third layer with a second liquid, thereby pushing air out of the interior of the inside layer.
